(19) United States
(12) Patent Application Publication
(10) Pub. No.: US 2007/0291776 A1
(43) Pub. Date: Dec. 20, 2007

(54) METHOD AND APPARATUS FOR BILLING FOR MEDIA DURING COMMUNICATIONS IN CHANNEL-BASED MEDIA TELECOMMUNICATION PROTOCOLS

(75) Inventors: Brody Kenrick, San Francisco, CA (US); Marwan A. Jabri, Tiburon, CA (US); David Jack, Reading (GB); Nathan Taylor, Petaluma, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dilithium Networks, Inc., Petaluma, CA (US)

(21) Appl. No.: 11/690,733

(22) Filed: Mar. 23, 2007

Related U.S. Application Data
(63) Continuation-in-part of application No. 11/496,058, filed on Jul. 28, 2006.
(60) Provisional application No. 60/785,503, filed on Mar. 23, 2006.
(60) Provisional application No. 60/704,191, filed on Jul. 28, 2005.

(51) Int. Cl. H04L 12/28

(52) U.S. Cl. 370/401; 370/351

(57) ABSTRACT

A method of providing video ringback services includes receiving, at a VRBT server, a setup message from a terminal originating a call and providing providing a first message from the VRBT server to an MSC. The method also includes establishing a communication session between the terminal originating the call and the VRBT server through the bidirectional bearer, thereafter, providing a video ringback stream from the VRBT server to the terminal originating the call, and receiving a first message from a terminal terminating the call indicating that the terminal terminating the call has answered. The method further includes providing a second message from the VRBT server to the MSC, wherein the second message is interpreted at the MSC as an indication to begin charging for a session and providing a communication path between the terminal originating the call and the terminal terminating the call.

### CROSS-REFERENCES TO RELATED APPLICATIONS

This application claims priority to U.S. Provisional Application No. 60/785,503, filed on Mar. 23, 2006, which is hereby incorporated by reference in its entirety for all purposes. This application is also a continuation-in-part of U.S. patent application Ser. No. 11/496,058, filed on Jul. 28, 2006, which claims priority to U.S. Provisional Application No. 60/704,191, filed Jul. 28, 2005, the disclosures of which are incorporated herein by reference in their entirety.

The following two regular U.S. patent applications (including this one) are being filed concurrently, and the entire disclosure of the other application is incorporated by reference into this application for all purposes.
U.S. patent application Ser. No. ______; filed Mar. 23, 2007, entitled “Method and Apparatus for Providing Interactive Media During Communication in Channel-Based Media Telecommunication Protocols” (Attorney Docket No. 021318-005210US); and
U.S. patent application Ser. No. ______; filed Mar. 23, 2007, entitled “Method and Apparatus for Billing for Media During Communications in Channel-Based Media Telecommunication Protocols” (Attorney Docket No. 021318-005220US).

### COPYRIGHT NOTICE

A portion of this application contains computer codes, which are owned by Dilithium Networks, Inc. All rights have been preserved under the copyright protection, Dilithium Networks, Inc., ©2007.

### BACKGROUND OF THE INVENTION

The present invention relates generally to methods of providing video ringback media during multimedia telecommunications (a multimedia “call”) between equipment (“terminals”) and also methods of providing media during an initial period of a call prior to a session answer from a second device. More particularly, the invention provides methods for introducing arbitrary media during a call to or from a terminal that implements channel-based telecommunications protocols such as the Internet Engineering Task Force (IETF) Session Initiation Protocol (SIP), the International Telecommunication Union (ITU) Telecommunication Standardization Sector (ITU-T) H.323 Recommendation, the ITU-T H.324 Recommendation, and other Standards and Recommendations derived from or related to these. More specifically, it relates to a method and apparatus of providing configurable and possibly interactive media at various stages of a communication session in channel-based media telecommunication protocols with media supplied into channels of one or more terminals based on preferences of an operator, originator, and/or receiver. Merely by way of example, the invention has been applied to the establishment of multimedia telecommunication between the 3GPP 3G-324M (protocol adapted from the ITU-T H.324 protocol) and SIP multimedia handsets on a mobile telecommunications network, but it would be recognized that the invention may also include other applications.

H.324 is an International Telecommunication Union (ITU) protocol standard for multimedia communication over general switched telephone networks (GSTN). H.324M is the name commonly used for the H.324 with Annex C (mobile extensions) and is an extension of H.324 for operations over mobile networks, and 3G-324M is a recommendation by the third generation partnership program (3GPP) defining adaptation of H.324M for use within 3GPP networks and also adopted by 3GPP2. 3GPP has also adapted IETF SIP for use in packet switched networks, this adaptation is called SIP/IMS.

Without any loss of generality we use the term “equipment” to indicate either a user end equipment such as a handset, or network end equipment such as a switch or gateway. The term “equipment” covers the meaning of “entity.” We also use the terms “equipment” and “terminal” interchangeably, and they both indicate the same meaning in the present document.

The key steps involved in setting up and connecting a typical 3G-324M call are as follows:
1. Call signaling (bearer establishment)—outside the scope of H.324. Normally a modem connection if GSTN, through ISDN, or signaling through mobile switching centers in the mobile case.
2. Mobile level detection (MLD)—Where a common Mobile Level is agreed on between equipments. This step is performed by H.324 equipment that supports mobile extensions such as H.324M and 3G-324M equipment.
3. Terminal Capability Exchange (TCS)—H.245 Messaging
4. Master Slave determination (MSD)—H.245 Messaging
5. Open/Close Logical Channels (OLC)—H.245 Messaging
6. Multiplexer Table Entries Exchange (MTE)—H.245 Messaging

In Step (1) an end-to-end bearer between equipments is established. This stage is called Call Signaling. In a third Generation (3G) network, where 3G-324M is employed, a user terminal connects to another user terminal via network elements; network element to user terminal interactions make use of ITU-T Recommendation Q.931, network element to network element connections make use of Signaling System 7 (SS7) Integrated Systems Digital Network User Part (ISUP).

FIG. 1 illustrates a conventional connection architecture for MS-to-MS H.324 calls. As merely an example, in FIG. 1, a simplified depiction of network elements involved in a typical 3G-324M call between two terminals is shown. A terminal originating a call (TOC) 110, a terminal terminating a call (TTC) 190, a mobile switching centre (MSC) associated with a TOC (OMSC) 120 and an MSC associated with TTC (TMSC) 180. OMSC and TMSC may be collocated. A charging function is marked as CHARGING 150.

FIG. 2 illustrates conventional session establishment of a terminal originating call and a setup request to a terminal terminating call. A TOC 210 initiates call set-up procedure by sending a Q.931 SETUP message to OMSC 220. OMSC 220 sends an ISUP Initial Address Message (IAM) to TMSC 224. TMSC 224 sends a SETUP message to TTC 230 associated with the number dialed. The SETUP message informs TTC 230 of the incoming call. TTC 230 sends an ALERTING message to TMSC 224 indicating that ringing has started. TMSC 224 sends an ISUP Address Completed Message (ACM) to OMSC 220. OMSC 220 connects a ringing (ringback or alerting) tone to TOC 210 by sending an ALERTING message.

TTC 230 is ringing and may answer the call. The duration of the ringing period is variable and unknown to TOC 210 at time of call origination. Although a 3G-324M terminal has the ability to display audio and video, TOC 210 is receiving and playing back a conventional, audio only, ringback tone for the duration of the ringing period.

If TTC 230 answers, a CONNECT message is sent from TTC 230 to TMSC 224. TMSC 224 sends an ISUP Answer Message (ANM) to OMSC 220. OMSC 220 sends a CONNECT to TOC 210.

In a typical call, a charging event is sent from OMSC 220 to the charging entity (CHARGING 222) indicating the start of the session. Charging events can be operator defined and are likely to occur elsewhere in a session to provide accurate billing of network usage, in the network and from other elements to provide accurate billing of network usage.

The call signaling is now complete and a communication link, the bearer, now exists between TOC 210 and TTC 230. Once call signaling completes, further steps are used to establish the H.324 session, to provide a means of transporting video, audio and data between the equipment in a format that is known to and supported by the equipment. In order to do this, H.324M makes use of two further ITU-T Recommendations.

The first of these Recommendations is H.223 “Multiplexing protocol for low bit rate multimedia communication.” H.223 specifies a frame-oriented multiplexing protocol which allows the transfer of any combination of digital voice, video and data (e.g., command and control) information over a single communication link. The H.223 may have a number of modes of operation, specified in Annexes A, B and C of the H.223 Recommendation, that are intended to provide increased resilience in the presence of errors. These are also known as Mobile Levels 1, 2 and 3. H.223 without the application of any of these Annexes is also sometimes referred to as operating at Mobile Level 0 (base-line). H.324 has the concept of Logical Channels which is a way of providing virtual channels over the circuit switched link. The role of the multiplexer is to combine (multiplex) parts of the data chunks written on the logical channels into frames known as a Multiplexer Protocol Data Unit (MUX-PDU). Logical Channel 0 is always available and is used for Command and Control. Data (voice, video, command and control and other general data) is passed to/from the H.223 multiplexer through bitstream chunks called service data units (SDUs). Before being multiplexed, these different SDUs go through Adaptation Layers where extra information may be added for purposes such as error detection, sequence numbering and retransmission requests.

The second of these Recommendations is H.245 “Control protocol for multimedia communication,” which specifies the syntax and semantics of terminal information messages as well as procedures to use messaging for in-band negotiation at the start of or during communication. The messages cover receiving and transmitting capabilities and preferences, logical channel signaling and control and indication. The messages that are specified in H.245 are expressed in the ITU-T Abstract Syntax Notation (ASN.1) and can be classified as of Request, Response, Command or Indication type. H.245 messages are encoded according to the ASN.1 standard before being transmitted. When a terminal sends an H.245 message of type Request it requires that an appropriate message of type Response is sent by the remote terminal. If the Response (sometimes referred to as an Ack for Acknowledgement) is not received within a certain time, the sending terminal will re-transmit the Request or take another appropriate action if no response has been received for repeated Requests. Re-transmission of requests may occur a number of times. Many of the H.245 messages associated with call setup are of the Request type.

H.245 also requires a reliable link layer for proper operation. The principal means of providing this, specified in Annex A of H.324, is to use the Simple Retransmission Protocol (SRP) or the Numbered Simple Retransmission Protocol (NSRP), in which one or more H.245 messages, known collectively as a MultimediaSystemControl PDU and in the present document as an H.245 PDU, are formed into SRP Command Frames prior to sending, and the receiving terminal must send an SRP Response Frame (Sometimes referred to as an SRP Ack) to acknowledge correct receipt of an SRP Command Frame. No further H.245 messages may be sent by a terminal until the SRP Ack for the last message has been received.

Step (2) is H.223 mobile level detection/multiplexer synchronization phase. This consists of each terminal transmitting a repeating pattern of bits (flags) that indicate the highest Mobile Level that it operates at. Each terminal examines the flags that it is receiving. If these flags represent a lower Mobile Level then the terminal drops down to the same lower level. When both terminals are transmitting the same flag sequence this step completes.

Steps (3) to (6) are performed using a sequence of H.245 Request and Response messages as described above. Note the order of steps (5) and (6) above can be interchanged. It should be noted that Steps (3) to (6) relate to procedures that are defined by underlying state machines that are also known as Signaling Entities. The relevant signaling entities are:

1. Capability Exchange Signaling Entity (CESE)

2. Master Slave Determination Signaling Entity (MSDSE)

3. Logical Channel Signaling Entity (LCSE)

4. Multiplex Table Signaling Entity (MTSE)

However, in order to establish an H.324 session with logical channels in each direction, the key steps above are often handled sequentially.

The ITU Recommendation H.323 uses H.245 in a similar manner to H.324 for signaling command, control and indication messages related to a call. IETF Session Initiation Protocol (SIP) uses a different method, Session Description Protocol (SDP), for establishment of terminal capabilities and logical channels.

For H.324M, Step (3), Terminal Capabilities Set request (TCS) step requires the terminal capabilities are exchanged via independent Terminal Capability Set (TCS) requests. These allow the signaling of the terminals supported capabilities including multiplexer capability, supported codecs, and parameters associated with the codecs. TCS requests also specify other terminal limitations on simultaneity of reception of specific codec types, or interdependence between codec types for simultaneous transmit and receive.

For H.324M, Step (4), the master slave relationship (MS) is determined by dependent Master Slave Determination (MSD) requests. After a master is decided it then takes responsibility for resolving incompatible requests between the terminals.

For H.324M, Step (5), Open Logical Channel (OLCs) are used to create logical channels (LC) as a path for the transmission of information. A logical channel is opened by a terminal wishing to send media by the Open Logical Channel (OLC) request. Each logical channel has characteristics that are specified in the OLC request. These characteristics ensure a terminal is capable of receiving and decoding data that will be received on the channel. Logical channels may be opened as bidirectional channels, where a forward and a reverse channel are created simultaneously. OLCs are acknowledged by the receiving terminal.

For H.324M, Step (6), the Multiplexer Table Entries (MTEs) indicate to the remote terminal how the transmitting terminal intends to format the media payload. MTEs are acknowledged by the receiving terminal.

Once these steps have completed, media (video, audio and data) can flow between the terminals. Session media flowing in logical channels is indicated by “SessMedia” in the figures utilized herein. Note that the H.245 messages flow on the Logical Channel 0, which, as previously described, is predefined and carried by the means of the multiplexer predefined Multiplex Table Entry 0. Once other Multiplex Table Entries have been exchanged, these can also be used in conjunction with H.245 messages.

Session characteristics pertaining to logical channel characteristics for 3G-324M are shown in Table 1. The modification of some session characteristics is allowed during a session in 3G-324M, allowed modifications and methods are indicated in Table 2.

TABLE 1

| Characteristic | Relevant information |
|---|---|
| Logical channel number (LCN) | — |
| Type of channel | — |
| Adaptation layer | — |
| Segmentable | — |

TABLE 2

| | Decision at session | Modification during |
|---|---|---|
| Characteristic | setup | session |
| Mobile level (ML) | Mobile level | H.245 negotiation |
| | detection | and ML detection |
| Terminal capabilities | H.245 negotiation | H.245 negotiation |
| (TCS) | | |
| Master-Slave relation- | H.245 negotiation | Not allowed |
| ship (MS) | | |
| Multiplexer table | H.245 negotiation | H.245 negotiation |
| entries (MTE) | | |
| Logical Channels (LC) | H.245 negotiation | H.245 negotiation |

Fast setup technologies, for example H.323 FastConnect/FastStart, H.324 AnswerFast and related techniques (described more fully in U.S. Pat. Nos. 7,139,279 and 7,161,949 and U.S. Patent Application Publication Nos. 2006/0029041, 2006/0250992, and 2006/0250991, and 2006/0159037, which are commonly assigned, and incorporated herein by reference for all purposes), such as H.324/Annex K Media Oriented Negotiation Acceleration, SIP answer/offer, and SIP “early media” (RFC 3960 and early session disposition RFC 3959 or various in work early media drafts such as http://www.ietf.org/internet-drafts-draft-stucker-sipping-early-media-indirection-00.txt or http://tools.ietf.org/wg/sipping/draft-stucker-sipping-early-media-coping-03.txt and http://quimby.gnus.org/internet-drafts/draft-barnes-sip-em-ps-req-sol-00.txt), and the like, may alter the negotiation process, but do not alter the resultant characteristics of a session. In some cases, the resultant session characteristics may be limited to a reduced set of characteristics when compared to regular negotiation.

The closing of logical channels and the re-opening of logical channels, by H.245 Close Logical Channel (CLC) messages and (Open Logical Channel) OLC messages respectively, is allowed during the session.

The key steps involved in tearing down a typical 3G-324M call are as follows:

H1. Close Logical Channels (CLC)—H.245 Messaging.

H2. End of Session Command (EndSession)—H.245 Messaging.

H3. Call signaling (bearer release)—outside the scope of H.324.

Call teardown may happen in an orderly way, involving Steps (H1), (H2) and (H3), may just involve Step (H2) and (H3), may just involve just Step (H3), or may be caused by loss of communication. By way of example, TOC 210 decides to terminate the session by terminating the bearer, i.e., Step (H3): Call signaling for call teardown, without sending H.245 messages. Step (H3) begins with TOC 210 sending a DISCONNECT message to OMSC 220. OMSC 220 signals an ISUP RELEASE to TOC 210. A charging event may be sent from OMSC 220 to CHARGING 222 indicating the end of the session for billing purposes.

OMSC 220 sends an ISUP RELEASE message to TMSC 224. TOC 210 sends a reply ISUP RELEASE_COMPLETE message to OMSC 220. TMSC 224 sends a return ISUP RELEASE_COMPLETE (RLC) message to OMSC 220, and a DISCONNECT message to TTC 230. TTC 230 sends a reply RELEASE message to TMSC 224. TMSC 224 replies to TTC 230 with a RELEASE_COMPLETE message. The call is now finished and all parties are returned to initial states ready to make new calls.

From the above, it is seen that in a 3G network, in spite of inherent terminal and network capabilities for multimedia display, when TOC 210 performs the steps described above, the media sent to TOC 210 from the network, as TTC 230 rings awaiting answer, is conventional audio (voice). Thus, there is a need in the art for methods and techniques for supplying multimedia ringback content to terminals communicating through telecommunication protocols. For example, there exists a need in the art for a way to establish a media session in 3G-324M communications prior to a charging event associated with answering a call in order to deliver various media streams that are intended to be offered to the party receiving these various media streams in an uncharged manner.

### SUMMARY OF THE INVENTION

According to the present invention, a technique for supplying configurable content to parties involved in a telecommunication session is provided. More particularly, the invention provides a method and apparatus for providing interactive and arbitrary media stream(s) during communications to and from terminals that implement channel-based media telecommunication protocols.

According to an embodiment of the present invention, a method of offering video ringback services is provided. The method includes providing a multimedia ringback media stream in a first system component, receiving a call at an MSC from an originating terminal, wherein the call is directed to a VRBT server, and establishing a session between the VRBT server and the originating terminal. The method also includes providing the multimedia ringback media stream to the originating terminal and thereafter, receiving a message from a terminating terminal indicating that the terminating terminal has answered. The method further includes transmitting a message from the VRBT server to a second system component that indicates an initiation of a chargeable session and providing a communication path between the originating terminal and the terminating terminal with reduced involvement of the VRBT server.

According to another embodiment of the present invention, a method of delivering a media stream to a 3G handset is provided. The method includes transmitting a first call setup message from the 3G handset to a switch, receiving a response message from the switch, and initiating a session setup process with a gateway in response to the response message. The method also includes completing the session setup process with the gateway and receiving the media stream transmitted from the gateway to the 3G handset. The method further includes receiving a second call setup message transmitted from the switch to the 3G handset and receiving session media transmitted from the gateway to the 3G handset.

According to yet another embodiment of the present invention, a method of delivering a video ringback media stream and session media from a video ringback server to a SIP device is provided. The method includes receiving a call setup message transmitted from the SIP device, initiating a call setup process with a 3G-324M handset, and transmitting a RINGING message to the SIP device. The method also includes transmitting a video ringback media stream to the SIP device and receiving a SIP message from a media gateway. The SIP message is transmitted in response to an H.245 negotiation process between the gateway and the 3G-324M handset. The method further includes determining that logical channels are open between the gateway and the 3G-324M handset and thereafter, transmitting session media from the video ringback server to the SIP device.

According to an alternative embodiment of the present invention, a method of performing transcoding for a session in a call between a terminal originating a call and a terminal terminating the call is provided. The session is conducted using at least a first media gateway and a second media gateway. The method includes conducting a first negotiation process between the terminal originating the call and the first media gateway. The first negotiation process results in a first codec selection. The method also includes determining a first preferred codec associated with the first codec selection, thereafter, establishing a first media session using the first preferred codec or another codec, and informing the second media gateway of the first preferred codec. The method further includes conducting a second negotiation process between a terminal terminating the call and the second media gateway. The second negotiation process includes determining a second codec set. The second codec set includes a second preferred codec determined based on at least the first preferred codec. The second negotiation process also includes selecting a second codec from the second codec set. Additionally, the method includes thereafter, establishing a second media session using the second codec and transmitting media from the terminal terminating the call using the second codec. Moreover, the method includes thereafter, transmitting media from the second gateway using the first preferred codec and thereafter, transmitting media from the first gateway in the first codec.

According to another alternative embodiment of the present invention, a method of providing multimedia content to a receiving terminal is provided. The method includes receiving a first media stream in a first media type transmitted from a transmitting terminal and determining that the receiving terminal is to receive two or more media types. The method also includes generating a second media stream in a second media type different from the first media type as a function of the first media stream and producing a third media stream in the first media type, based in part, on the first media stream. The method further includes multiplexing the third media stream and the second media stream to provide a multiplexed media stream and transmitting the multiplexed media stream to the receiving terminal.

According to a specific embodiment of the present invention, a method of establishing an early session and a late session in an H.324-like terminal is provided. The method includes transmitting a first call signaling message from the H.324-like terminal. The first call signaling message contains a first set of session establishment parameters and a second set of session establishment parameters. The method also includes receiving a second call signaling message at the H.324-like terminal. The second call signaling message contains a third set of session setup parameters. The method further includes thereafter, establishing the early session based on the first set of session establishment parameters and the third set of session establishment parameters, receiving a third call signaling message at the H.324-like terminal, and thereafter, establishing the late session based on the third set of session establishment parameters and a fourth set of session establishment parameters.

According to another specific embodiment of the present invention, a method of establishing a session between a service node and an H.324-like terminal prior to receiving an indication of an alerting status of a second device is provided. The method includes receiving, at the service node, a first call signaling message from the H.324-like terminal and thereafter, transmitting a second call signaling message from the service node to the second device. The method also includes transmitting a third call signaling message to the H.324-like terminal from the service node. The third call signaling message is associated with establishing a bearer between the service node and the H.324-like terminal. The method further includes thereafter, receiving a fourth call signaling message at the service node from the second device, establishing a session between the H.324-like terminal and the service node, and delivering media from the service node to the H.324-like terminal.

According to yet another specific embodiment of the present invention, a method of providing video ringback services is provided. The method includes receiving, at a VRBT server, a setup message from a terminal originating a call and providing a first message from the VRBT server to an MSC. The first message is a message interpreted at the MSC as an indication to establish a bidirectional bearer. The method also includes establishing a communication session between the terminal originating the call and the VRBT server through the bidirectional bearer and thereafter, providing a video ringback stream from the VRBT server to the terminal originating the call. The method further includes receiving a first message from a terminal terminating the call indicating that the terminal terminating the call has answered and providing a second message from the VRBT server to the MSC. The second message is interpreted at the MSC as an indication to begin charging for a session. Additionally, the method includes providing a communication path between the terminal originating the call and the terminal terminating the call.

According to a particular embodiment of the present invention, a method of providing an interactive content to a communications terminal is provided. The method includes receiving, at a media gateway, a setup message associated with the communications terminal, transmitting a session request message from the media gateway to a server, and transmitting a message from the media gateway to a mobile switching center. The mobile switching center transmits a CONNECT message to the mobile handset in response to at least the message. The method also includes receiving, at the media gateway, one or more session negotiation messages transmitted from the communications terminal. The one or more session negotiation messages are associated with a communications session. The method further includes receiving, at the media gateway, the interactive content transmitted from the server and transmitting the interactive content to the communications terminal. Moreover, the method includes determining that communications session was accepted by the server and transmitting a message associated with a billing process from the media gateway to the mobile switching center.

According to another particular embodiment of the present invention, a method for processing a video call from a 3G-324M-like device at a mobile switching center and allowing for a 3G-324M-like video session establishment prior to receiving an ISUP ANM message is provided. The method includes receiving an ISUP IAM at the mobile switching center and receiving an ISUP ACM or an ISUP CPG at the mobile switching center. The method also includes interpreting the ISUP ACM or the ISUP CPG as an indication to connect the bidirectional bearer and providing a bidirectional bearer between the 3G-324M-like device and a second 3G-324M-like device. The method further includes providing a CONNECT message to the 3G-324M-like device and thereafter, receiving the ISUP ANM at the mobile switching center.

According to yet another particular embodiment of the present invention, a method of preparing a service node for establishment of a video session is provided. The method includes receiving a first call signaling message at the service node. The first message is associated with a terminal originating a call and related to initiating the call between the terminal originating the call and a device. The method also includes transferring a second call signaling message from the service node. The second call signaling message is related to progressing a call. The method further includes thereafter, preparing the service node to establish the video session between the terminal originating the call and the service node. Preparing includes readying the service node to send and receive session establishment messages on a bidirectional bearer. Moreover, the method includes thereafter, transferring a third call signaling message from the service node associated with a charging event for the call. The third call signaling message is related to answering the call.

Embodiments of the present invention may be used to supply media at any time during a session while a terminal is connected. The media offered could take one of many forms, with non-limiting examples being: personalized or customized ringback tones, interactive media (e.g., entertainment or advertisements) at any stage of a call, and comfort media in place of media not supplied from a remote session. It will be recognized that the embodiments of the invention may also include other applications.

According to the present invention, techniques for supplying configurable media to terminals involved in channel-based media telecommunication call are provided. An agent serving as a termination point for session parties and content providers allows for configurable media to be supplied on any or all media channels of session parties, either in concert or independently, at various stages of a call. The agent could be described as a Media Personalization Server (MPS) of content and decision on content to supply can be made using the agent's knowledge of a call (i.e., called and calling party numbers, phase of call) and network information (i.e., subscriber information). It should be noted that although an embodiment the invention is referred to as a Media Personalization Server, it need not be limited to that particular embodiment. Where MPS is used it should be interpreted as one embodiment of the present invention.

In a specific embodiment, a configurable media stream is supplied to a TOC as it awaits answering at a TTC. This media supply is referred to herein as a personalized video ringback (PVRB). In alternative specific embodiments, a configurable media stream is supplied to a non-originating party at call setup or call tear down. In another alternative specific embodiment, a configurable media stream is supplied to a terminal allowing interaction between a user and content. In particular embodiments, a configurable media stream is supplied periodically (or aperiodically), interrupting a session with media or a configurable media stream is created by mixing personalized content with session content. In another embodiment, the invention provides a method to intercept communications between two parties and divert to a capturing entity. In further refinements of these examples, embodiments of the present invention have been applied to PVRB in telecommunications between 3G-324M (an H.324M based protocol) multimedia handsets on a mobile telecommunications network.

The system has one or more memories, which may be in a single device or multiple devices. The memory or memories include various computer codes that carry out the functionality described herein. The codes can be in software, hardware, or a combination of these, depending upon the embodiment. Depending upon the embodiment, other computer code can exist to carry out the functionality described herein.

Many benefits are achieved by way of the present invention over conventional techniques. For example, embodiments of the present invention provide a charging model for providing announcements and ringback media to unmodified/deployed terminals allowing for the provision of advanced video services to many millions of already deployed devices. The charging model also providing interworking with other networks that are not capable of offering the service nor supporting the modified charging model. Additionally, a reduction in involvement of one or more gateways and servers involved in personalized media delivery after a media delivery is provided by embodiments of the present invention. This functionality allows for a reduction in the number of deployed devices for a given service level, hence reducing system cost. The reductions in involvement provided here are applicable to the case of unmodified terminals and also to various modified terminals and infrastructure. Moreover, interworked delivery of ringback media and announcements across a variety of circuit and packet switched networks and devices is provided. Interworking provides an ability to offer a service to customers on varied access technologies and/or legacy networks. Furthermore, an enhanced user experience is provided by embodiments by generating media when communicating between devices that do not transmit all the media types in the sessions established at each device to each other. This augmented media is provided by stimulus of another media type to further enhance the user experience. In addition, embodiments of the present invention provide for fast ringback/announcement setup, thereby providing for a greater amount of time available for delivering an announcement in a same period of network utilization and user time, affording more revenue opportunities and/or greater customer satisfaction for an operator. Additionally, media transitions maintain quality when changing media from an announcement/ringback media to a session media are provided by various embodiments. Depending upon the embodiment, one or more of these benefits, as well as other benefits, may be achieved.

The objects, features, and advantages of the present invention, which to the best of our knowledge are novel, are set forth with particularity in the appended claims. Embodiments of the present invention, both as to their organization and manner of operation, together with further objects and advantages, may best be understood by reference to the following description, taken in connection with the accompanying drawings.

### BRIEF DESCRIPTION OF THE DRAWINGS

FIG. 1 illustrates a conventional connection architecture for MS-to-MS H.324 calls;

FIG. 2 illustrates conventional session establishment of a terminal originating call and a setup request to a terminal terminating call;

FIG. 3A illustrates a connection architecture for MS-to-MS H.324 calls according to an embodiment of the present invention;

FIG. 3B is a simplified flowchart illustrating a sequence of session operations according to an embodiment of the present invention;

FIG. 4 illustrates session establishment for a terminal originating call and a setup request to a terminal terminating call according to an embodiment of the present invention;

FIG. 5 illustrates the display of configurable media to a terminal originating call according to an embodiment of the present invention;

FIG. 6 illustrates session establishment for a terminal terminating call according to an embodiment of the present invention;

FIG. 7 illustrates a media teardown process in a non-interactive embodiment according to the present invention;

FIG. 8 illustrates session cutover according to an embodiment of the present invention;

FIG. 9 illustrates session teardown from a terminal originating call according to an embodiment of the present invention;

FIG. 10 illustrates session teardown propagated to a terminal terminating call according to an embodiment of the present invention;

FIG. 11 illustrates a single direction media (or signaling) path according to an embodiment of the present invention;

FIG. 12 illustrates a single direction media (or signaling) path with reduced involvement according to an embodiment of the present invention;

FIG. 13 illustrates a single direction media (or signaling) path with no involvement according to an embodiment of the present invention;

FIG. 14 illustrates a single direction media path with content mixing according to an embodiment of the present invention;

FIG. 15 illustrates a single direction media (or signaling) path being intercepted according to an embodiment of the present invention;

FIG. 16A illustrates another connection architecture for MS-to-MS H.324 calls using IP content according to an alternative embodiment of the present invention;

FIG. 16B illustrates an alternative connection architecture for MS H.324-to-SIP calls using IP content according to another embodiment of the present invention.

FIG. 17 illustrates session establishment and content delivery for a terminal originating call followed by session media delivery according to an embodiment of the present invention;

FIGS. 18A-D illustrate methods of performing media cutover according to embodiments of the present invention;

FIG. 19 illustrates session establishment, content delivery, and charging for a terminal originating call according to an embodiment of the present invention;

FIG. 20 illustrates Video ringback to terminal originating call (ISUP VRBT) without a VRBT release according to an embodiment of the present invention;

FIG. 21 illustrates Video ringback to terminal originating call (SIP VRBT) without a VRBT release according to an embodiment of the present invention;

FIG. 22 illustrates Video ringback to terminal originating call (SIP VRBT) with a SIP refer according to an embodiment of the present invention;

FIG. 23 illustrates Video ringback to terminal originating call (ISUP VRBT) with Restart-able clients according to an embodiment of the present invention;

FIG. 24 illustrates Video ringback to terminal originating call (SIP VRBT) with Restart-able clients according to an embodiment of the present invention;

FIG. 25 illustrates Video ringback to terminal originating call (ISUP VRBT) with NSRP re-synchronizing clients according to an embodiment of the present invention;

FIG. 26 illustrates Video ringback to terminal originating call (SIP VRBT) with NSRP re-synchronizing clients according to an embodiment of the present invention;

FIG. 27 illustrates Video ringback to terminal originating call (ISUP VRBT) with Q.931 session setup clients according to an embodiment of the present invention;

FIG. 28 illustrates Video ringback to terminal originating call (SIP VRBT) with Q.931 session setup clients according to an embodiment of the present invention;

FIG. 29 illustrates 3G-324M Ringback via SIP Call setup according to an embodiment of the present invention;

FIG. 30 illustrates 3G-324M Ringback via SIP Charging according to an embodiment of the present invention;

FIG. 31 illustrates 3G-324M Ringback via SIP Charging with ReINVITE according to an embodiment of the present invention;

FIG. 32 illustrates 3G-324M Ringback via SIP Charging with REFER according to an embodiment of the present invention;

FIG. 33 illustrates 3G-324M Ringback via SIP Normal call clearing according to an embodiment of the present invention;

FIG. 34 illustrates 3G-324M Ringback not being delivered when communicating with a non-supporting MSC according to an embodiment of the present invention;

FIG. 35 illustrates 3G-324M Ringback via SIP with Faster connect for ringback media delivery according to an embodiment of the present invention;

FIG. 36 illustrates 3G-324M Ringback via SIP with Early ACM at TMSC according to an embodiment of the present invention;

FIG. 37 illustrates 3G-324M Ringback via SIP with Forward Unconditional Early ACM according to an embodiment of the present invention;

FIG. 38 illustrates 3G-324M Ringback via SIP with Forward Unconditional according to an embodiment of the present invention;

FIG. 39 illustrates 3G-324M Ringback via SIP with Busy at TTC according to an embodiment of the present invention;

FIG. 40 illustrates 3G-324M Ringback via SIP with Release on no answer according to an embodiment of the present invention;

FIG. 41 illustrates 3G-324M Ringback via SIP with Call Forward No Response according to an embodiment of the present invention;

FIG. 42 illustrates delayed charging for an announcement delivered to a 3G-324M device according to an embodiment of the present invention;

FIG. 43A illustrates delayed charging for an announcement delivered to a 3G-324M device from a SIP server according to an embodiment of the present invention;

FIG. 43B illustrates delayed charging for an announcement delivered to a 3G-324M device from an ISDN server according to an embodiment of the present invention;

FIG. 44A illustrates delayed charging for an announcement delivered to a 3G-324M device from an H.323 server according to an embodiment of the present invention;

FIG. 44B illustrates delayed charging for an announcement delivered to a 3G-324M device from an H.323 server according to an alternative embodiment of the present invention;

FIG. 45 illustrates delayed charging for an announcement delivered to a 3G-324M device from a SIP server according to an embodiment of the present invention;

FIG. 46 illustrates pre-CONNECT media delivered to an appropriately modified 3G-324M device according to an embodiment of the present invention;

FIG. 47 illustrates an alternative 3G-324M Ringback via a SIP server and call setup according to an embodiment of the present invention;

FIG. 48 illustrates video ringback delivered to a 3G-324M device when calling a packet switched device according to an embodiment of the present invention;

FIG. 49 illustrates video ringback delivered to a 3G-324M device when calling a packet switched device capable of SIP early media according to an embodiment of the present invention;

FIG. 50 illustrates SIP Ringback when calling a 3G-324M device via a SIP server and call setup according to an embodiment of the present invention;

FIG. 51 illustrates 3G-324M Ringback via a SIP server with minimized transcoding according to an embodiment of the present invention;

FIG. 52 illustrates providing multimedia to a terminal with a media type generated stimulated by a received media according to an embodiment of the present invention;

FIG. 53 illustrates a connection architecture for H.324 MS-to-server calls according to an embodiment of the present invention;

FIG. 54 illustrates a connection architecture for H.324 MS-to-IP based server calls according to an embodiment of the present invention;

FIG. 55 illustrates a connection architecture for H.324 MS-to-gateway with an RTSP interface calls according to an embodiment of the present invention;

FIG. 56 illustrates a connection architecture for H.324 MS-to-a different network calls according to an embodiment of the present invention;

FIG. 57 illustrates a connection architecture for H.324 MS-to-a different less able network calls according to an embodiment of the present invention;

FIG. 58 illustrates a connection architecture for H.324 MS-to-H.324 MS calls in differing networks connected via a SIP interconnect according to an embodiment of the present invention; and

FIG. 59 illustrates SRP adaptation according to an embodiment of the present invention.

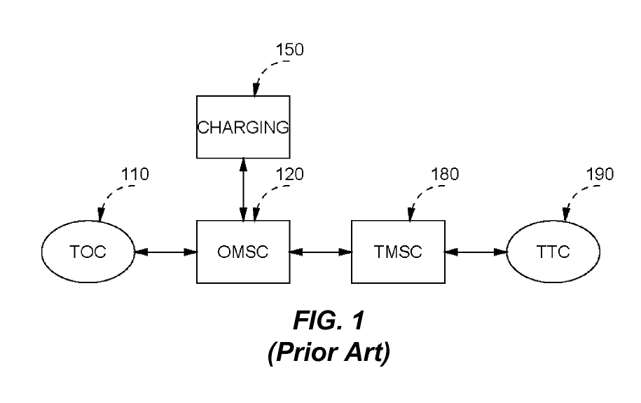

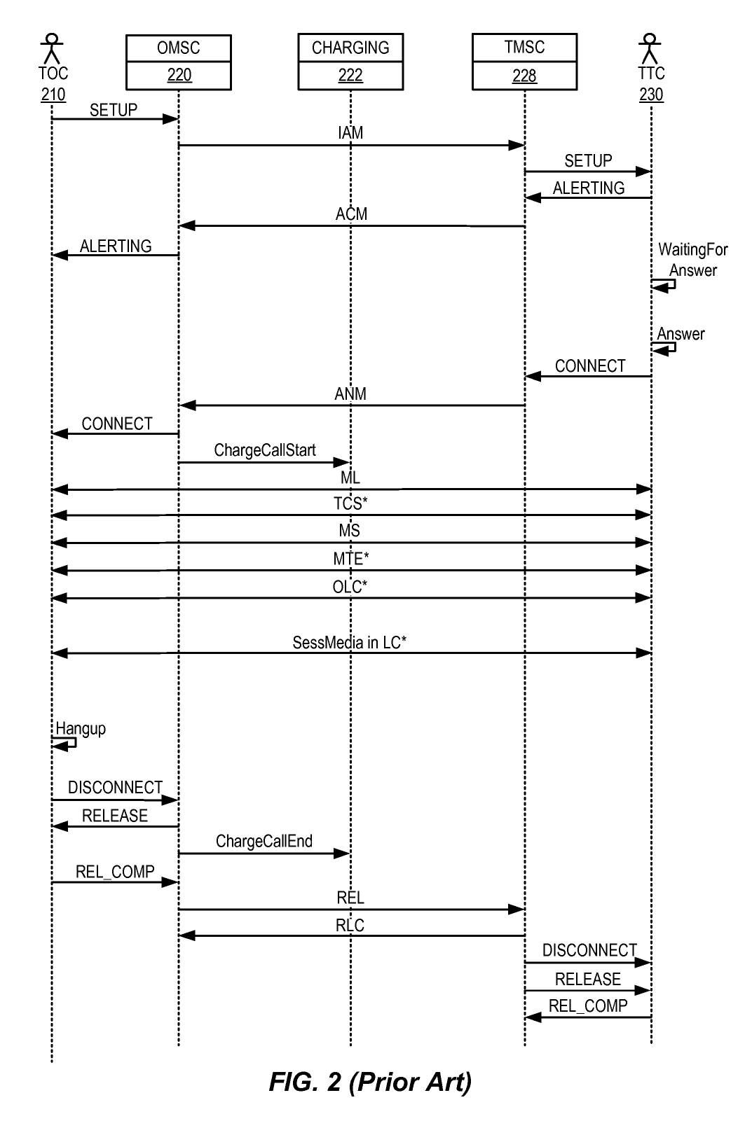

### DETAILED DESCRIPTION OF THE INVENTION

According to the present invention, a technique for supplying configurable content to parties involved in a telecommunication session is provided. More particularly, the invention provides a method and apparatus for providing interactive and arbitrary media stream(s) during communications to/from terminals that implement channel-based media telecommunication protocols.

Embodiments of the present invention include methods and systems that provide non-ordinary media content to a terminal originating a call that is highly desirable at various stages of the session. Content could be personalized media, either selected by the subscribers involved or the network operator.

Based on the discussion of conventional call procedures above, a way of providing configurable media other than conventional audio and supplying such media to either party during the session is also desirable. Content could be personalized media, either selected by the subscribers involved or the network operator, and with the additional content source of session media. The richness of media supplied to a party during the session is also desirable, and further enhancements such as interactivity and/or mixed media sessions could be delivered. It is also important to accommodate the already vast pool of deployed handsets by creating a service that does not require handset modifications but can also be reconciled with presently deployed infrastructure and also charging and billing methods employed in present networks.

According to embodiments of the present invention, techniques for supplying configurable media to terminals involved in channel-based media telecommunication call are provided. An agent serving as a termination point for session parties and content providers allows for configurable media to be supplied on any or all media channels of session parties, either in concert or independently, at various stages of a call. This interposing agent could be described as Personalized Media Server (PMS) Back to Back User Agent (B2BUA) as it may be seen as user agents connected to session parties, including non-terminal participants like content or capture devices, and participates in all call activities (complete session of itself) to each party. It would also be recognized that the PMS may be geographical dispersed and/or logically dispersed, with the separation of the call termination and the signaling and handling of session and/or media provided in some applications. For example, if the service was provided on a SIP-I (Q.1912.5) server, it may have its sessions tunneled through another server to reach an endpoint. Personalization of media content and decision on content to supply can be made using PMS's knowledge of a call (i.e., called and calling party numbers, phase of call) and a network (i.e., subscriber information).

The method described above is generic and can be implemented in many different ways by a person skilled with the field. We describe below example embodiments to illustrate the methods which can be adapted easily to suit specific equipment needs.

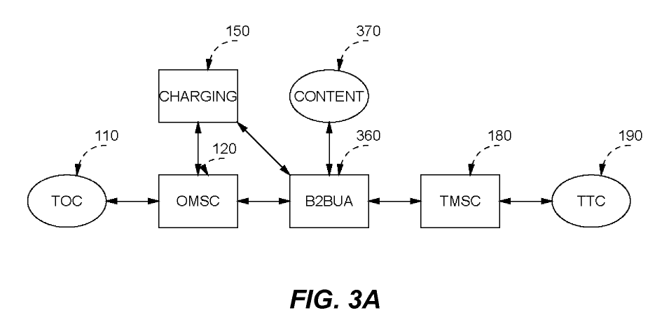

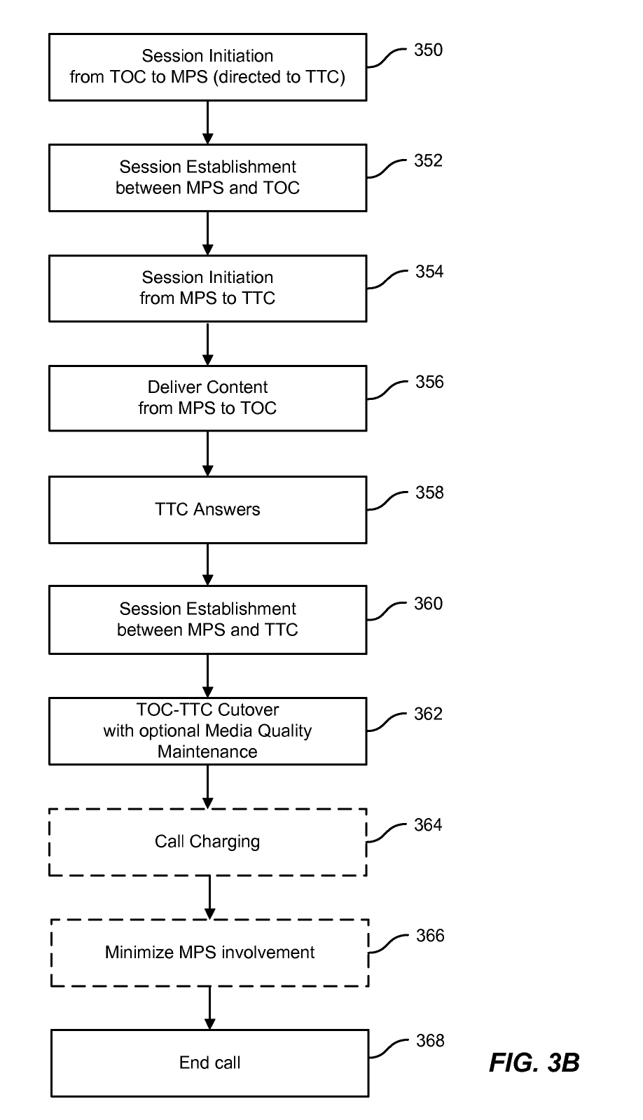

Embodiments of the present invention include methods and systems for providing Personalized Video Ringback services. Merely by way of example, embodiments of the present invention are described with reference to FIGS. 3-10. A configurable media stream is supplied to TOC as it awaits answering at TTC. This media supply will henceforth be known as a personalized video ringback (PVRB). In a further refinement of this example the invention has been applied to PVRB in telecommunication between 3G-324M (an H.324 based protocol) multimedia handsets on a mobile telecommunications network.

The 3G-324M protocol is used here for illustrative purposes only. The methods described here are generic and apply to the processing of sessions between virtually any pair of channel-based terminals over virtually any connection protocol. A person skilled in the relevant art will recognize that other steps, configurations and arrangements can be used without departing from the spirit and scope of the present invention.

The description makes reference to a call involving two terminals, a TOC and a TTC. The terminology “terminal” as used herein is not limited to terminal devices but can also represent other entities in a network behaving as a terminal's proxy or otherwise. Examples of other devices included within the scope of the term “terminal” include servers, handsets, gateways, computers, mobile telephones, PDAs, smart phones, PSTN phones, and the like.

FIG. 3A illustrates a connection architecture for MS-to-MS H.324 calls according to an embodiment of the present invention. Referring to FIG. 3A, a Personalized Media Server Back-to-Back User Agent (B2BUA) 360 is added into a network. According to embodiments of the present invention, the B2BUA 360 is positioned at a number of points of the network between the TOC 110 and the TTC 190. In the embodiment illustrated in FIG. 3A, B2BUA 360 is positioned on the network side of an MSC (i.e., OMSC 120), although B2BUA in embodiments may contain an MSC, and may be contained in an MSC, or collocated with other elements. Thus, the connection architecture illustrated in FIG. 3A is provided merely by way of example since a B2BUA can be placed at any point in a network, with interfaces compatible to its connections. The entity can also be placed in the empty network, if two terminals were directly connected prior to introduction of the B2BUA 360.

As well as being non-limiting of protocol, a B2BUA 360 need not have limits on terminal capabilities. If a B2BUA 360 encompasses a transcoding gateway (e.g., as described in U.S. Patent Application Publication No. 2003/0028643, commonly assigned, and incorporated herein by reference for all purposes) then protocol and terminal capabilities might be able to be terminated independently and the transcoding gateway could still ensure compatibility between the differently capable endpoints.

Referring to FIG. 3A, an entity adapted to serve content (CONTENT 370) is added into a network, with a compatible connection to B2BUA 360. The type and method of operation of the content server need not be specified by a particular protocol, but by way of example, the content server CONTENT 370 could use an interactive session based protocol. In a particular embodiment, an RTSP (Real Time Streaming Protocol) server could be a subpart of CONTENT 370. The interface between B2BUA 360 and CONTENT 370 is demonstrated as a simplified ISUP/H.324 connection. The interface between B2BUA 360 and CONTENT 370 can be a proprietary interface or any choice of standard interface. When B2BUA encompasses a transcoding gateway, then the content delivered by CONTENT to B2BUA might possibly be stored in a reduced number of formats and then transcoded on the fly by the transcoding gateway. An example might be store a single high quality media sample (e.g. broadcast quality or high quality H.264 and AMR-WB or eAAC audio) and transcode/transrate/trans-size the content to the format as negotiated to each endpoint. This has advantages not only on storage but also on management of content and also subscription to the content.

The interfaces offered by a B2BUA 360 to terminals need not be identical. As a non-limiting example, a media gateway could also be incorporated in a B2BUA 360, with ISUP offered to a first interface and ISDN to another. H.323, H.324 and SIP are other variant protocols that can benefit from this method.

As would be evident by the protocol flexibility of the B2BUA 360, there are many places in a network where it could reside. The location illustrated in FIG. 3A is merely provided by way of example. The content server 370 includes one or more memories (not shown) according to an embodiment of the present invention. The one or more memories are adapted to store multimedia content in a variety of formats. Merely by way of example, the multimedia content may include audio, video, still images, data, combinations thereof, and the like. Content is stored in a variety of formats as appropriate to the particular application. As an example, formats supported and/or utilized by embodiments of the present invention include 3GPP file format, MPEG-4, Real-format, WMV, AVI, Quicktime, and the like.

Referring to FIG. 3A, CHARGING 150 may be logically or physically separated from other entities, but may also be collocated. CHARGING incorporated into an MSC is one possible collocation. Other possibilities would be employed depending on the billing scheme or model employed.

FIG. 3B is a simplified flowchart illustrating a sequence of session operations according to an embodiment of the present invention. Referring to FIG. 3B, session initiation (350) is performed to initiate a session between the TOC and the MPS. The call originates at TOC and is directed to TTC through the MPS. Session establishment (352) is accomplished between the MPS and the TOC. In an embodiment, session establishment (352) comprises session signaling such as Q.931.

Session initiation (354) is begun to initiate a session between the MPS and the TOC. The session initiated in step 354 will include the establishment of logical channels and other characteristics for the transmission of media between the MPS and TOC. Merely by way of example, H.324 and H.245 are utilized during session initiation. Content is delivered from the MPS to the TOC (356). As described more fully throughout the present specification, content delivered from the MPS to the TOC includes video ringback content, multi-media content, music content including music clips, personal messages, network announcements, advertising content, menus for video mail servers and portals, video rendered voice menus, combinations thereof, and the like. The media rendered to TOC can also come from a variety of sources and over a variety of methods. For example, sending an image over the SIP channel, not over RTP, for caller ID (e.g., a JPEG (.JPG) file). This image could then be presented picture in picture (PiP). Alternatively the mixing of other media is also possible, for example, if the other side is transmitting early media and it is desirable to override with another media, then the other media could also be presented as PiP (or vice versa).

The TTC answers (358) and session establishment is accomplished between the MPS and the TTC (360). At this point in the call flow, sessions are established between the TOC and the MPS as well as between the MPS and the TTC. Content is being delivered from the MPS to the TOC, for example, video ringback content, and the call is ready to proceed to the delivery of session media from the TTC to the TOC.

TOC-TTC cutover with optional media quality maintenance (362) is accomplished to switch the content being delivered to the TOC from the content initially delivered in step 356 to the content provided by the TTC. As described more fully throughout the present specification, during the cutover process, the media quality to both terminals can be maintained at a predetermined level as appropriate to the particular applications.

Call charging is optionally initiated (364) and the involvement of the MPS may be minimized (366) in some embodiments. Merely by way of example, in a particular embodiment, call charging is delayed until an event occurs. In some embodiments, charging in step 364 is similar to the charging process associated with establishment of a conventional call between TOC and TTC. For example, in a video mail application, call charging is delayed until a user enters a predetermined menu selection. Thus, call charging is not initiated in this embodiment until a user takes an affirmative action agreeing to the charge. Utilizing methods and systems provided by embodiments of the present invention, it is possible to minimize the MPS involvement as described more fully throughout the present specification. The call ends after a certain period (368).

It should be appreciated that the specific steps illustrated in FIG. 3B provide a particular method of providing video ringback services according to an embodiment of the present invention. Other sequences of steps may also be performed according to alternative embodiments. For example, alternative embodiments of the present invention may perform the steps outlined above in a different order or make some of the steps optional. Moreover, the individual steps illustrated in FIG. 3B may include multiple sub-steps that may be performed in various sequences as appropriate to the individual step. Furthermore, additional steps may be added or removed depending on the particular applications. One of ordinary skill in the art would recognize many variations, modifications, and alternatives.

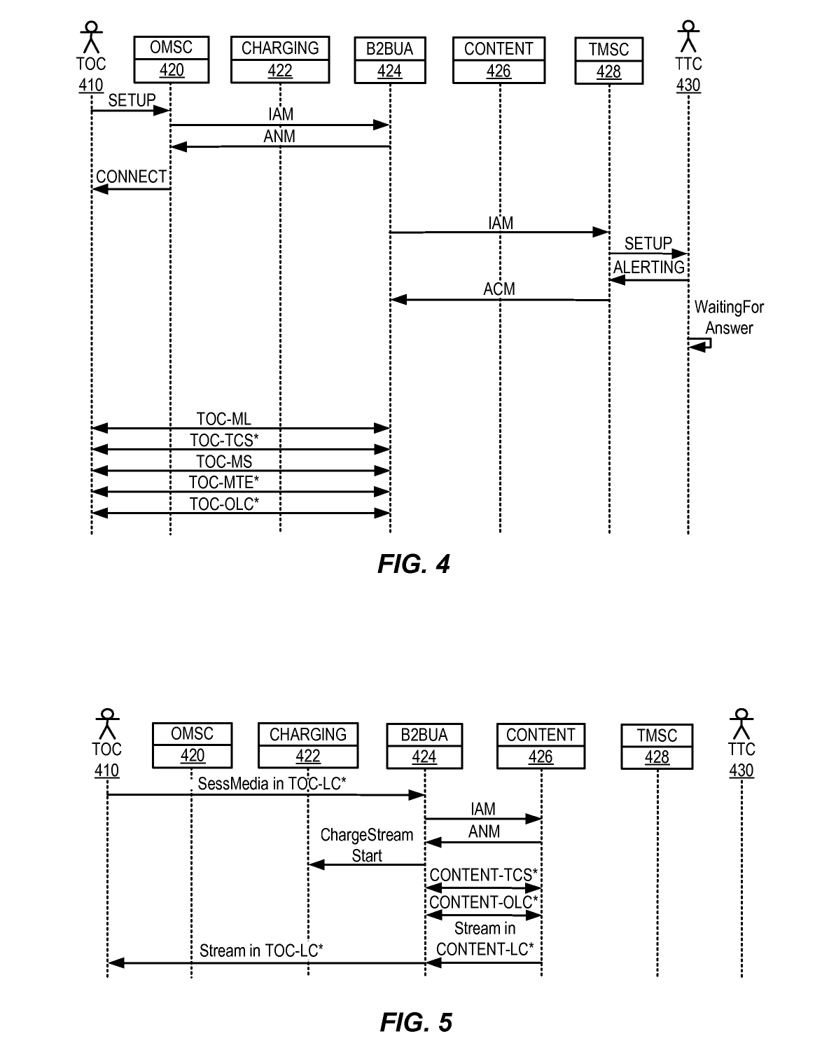

FIG. 4 illustrates session establishment for a TOC and a setup request to a TTC according to an embodiment of the present invention. In an embodiment, TOC 410 is a 3G-324M terminal initiating a call set-up procedure by sending a SETUP message to OMSC 420. After receiving the SETUP message, OMSC 420 sends an ISUP Initial Address Message (IAM) to B2BUA 424. It should be noted that B2BUA 424 could be provisioned to determine if an involved subscriber has subscribed to any aspect of a configurable media offering (e.g., ringback tones). This determination could be performed by an OMSC querying the Home Location Register (HLR), not shown, and modifying the B2BUA 424 operation to become a pass through proxy. OMSC 420 could also be configured to make this subscription check, and bypass involvement of B2BUA 424 completely. Since it is possible to utilize a default subscription offering personalized content operator advertising, a bypass sequence is not shown. Thus, according to embodiments of the present invention, bypass sequences are provided as appropriate to the particular application.

B2BUA 424, returns an ISUP message ANM back to OMSC 420. OMSC 420 returns a CONNECT message to TOC 410. It should be noted that the use of the CONNECT transmitted to TOC means that TOC can be a normal 3G-324M terminal, without additional changes to offer this service. A communication link now exists between TOC 410 and B2BUA 424. Session characteristics for TOC-B2BUA can now be determined.

After receiving an ISUP IAM from TOC 410, which contains called party information, B2BUA 424 attempts to connect to TTC 430. An ISUP IAM is sent to TMSC 428. TMSC 428 sends a SETUP message to TTC 430 associated with the number dialed. A SETUP message informs TTC 430 of an incoming call. If TTC 430 is available, TTC 430 sends an ALERTING message to TMSC 428 informing it that ringing has started. TMSC 428 sends an ISUP Address Completed Message (ACM) to B2BUA 424, indicating to B2BUA 424 that TTC 430 is now ringing and awaiting answer.

Further possibilities exist to elicit the ringing response such as a modified ACM, like an early ACM, followed by another message such as a CPG with alerting enabled. Ringing may be connected in other message flows such as when after an ISUP “early ACM” from TMSC (an ACM with no alerting indication) is followed by an ISUP CPG with an alerting indication. The gateway could also initiate the call to TOC and upon answering offer an announcement of ringback media while a second terminal, TTC, is still alerting.

As a session established between TOC 410 and B2BUA 424 may be cross-connected to a session established between B2BUA 424 and TTC 430. Session characteristics and logical channel characteristics for a session between TOC 410 and B2BUA 424 (henceforth this interface and session shall be referred to as “B2BUA-TOC,” similar interfaces are addressed in a similar fashion) can be used to limit session characteristics offered from B2BUA 424 to TTC 430 and control the session characteristics for B2BUA-TTC. It is also possible that a softer preferential modification of the capabilities could be performed, i.e. modifying the preferences through ordering in SIP offer or H.245 TCS, so that a desired session is created that either minimizes transcoding or maximizes quality. In some cases, in order to maximize quality, transcoding may be unavoidable. As an example, if both sides support different advanced codecs above the mandatory and one is selected on one side, then transcoding is unavoidable. It may be preferable to select the advanced codec to achieve a desired high quality.

The restrictions applied may include, but not be limited to, any session characteristics or logical channel characteristics, examples being: reducing maximum ML, limiting media types available, limiting codecs available (to avoid transcoding), and the like.

The session characteristic limitations for B2BUA 424 need not be limited to B2BUA-TTC. Rather, B2BUA-TOC could be limited, or modified, before any further connections to reduce the use of transcoding, and/or eliminate transcoding altogether in some cases. As an example of eliminating transcoding in 3G-324M, B2BUA 424 may limit its advertised terminal capability set (TCS) to the minimum set of mandatory capabilities in 3G-324M to TOC 410. This reduces the session to a set of minimal known characteristics, and TTC 430 will be known to be able to match these capabilities, and not require transcoding.

Logical channels are opened between TOC 410 and B2BUA 424 via OLC requests. After OLCs and MTEs are acknowledged by TOC 410 and B2BUA 424, media is free to flow in logical channels. As illustrated in FIG. 5 discussed below, TOC 410 may begin sending media (SessMedia in TOC-LC), after completion of sequences illustrated in FIG. 4. In PVRBT mode, B2BUA 424 may disregard TOC 410 media and in session signaling (for example video fast update) until required by cross-connect, configurable and customizable media is shown in FIG. 5 (Stream in TOC-LC*). B2BUA 424 may conceivably put disregarded media and signaling to some other use, or even provide session mixed PVRB. A returned session media mixed PVRB could be interactive, an example of which could be a simple interactive game.

FIG. 5 illustrates the display of configurable media to a terminal originating call according to an embodiment of the present invention. Referring to FIG. 5, in order to access content for PVRB to be supplied to TOC 410, B2BUA 424 may create a session connection to CONTENT 426 any time after ACM in FIG. 4. Content requests may be customized using session information, session related information, or information derived from either of these, called party information, calling party information, operator information for subscribers involved in the call, combinations of these, and the like. In the example illustrated in FIG. 5, B2BUA 424 and CONTENT 426 are shown connecting using a simplified ISUP channel-based protocol. B2BUA 424 sends an ISUP IAM to CONTENT 426. CONTENT 426 returns an ISUP Answer Message (ANM) to B2BUA 424. A charging event might be sent by B2BUA 424 to CHARGING 422 indicating a start of a streaming session for billing purposes.

A communication link now exists between CONTENT 426 and B2BUA 424. Session characteristics for CONTENT-B2BUA can now be determined. The session established between CONTENT 426 and B2BUA 424 may be cross-connected to TOC and any information regarding TOC's session or LC characteristics may be used to limit terminal session characteristics by B2BUA 424 to CONTENT 426 or as a means of selecting content that will be delivered.

The restrictions applied may include, but not be limited to, any session characteristics or logical channel characteristics, examples being: reducing maximum ML, limiting media types available, limiting codecs available (to avoid transcoding), and the like.

Logical channels are opened between CONTENT 426 and B2BUA 424 via OLC requests. After OLCs and MTEs are acknowledged by CONTENT 426 and B2BUA 424, media is free to flow in logical channels (e.g., illustrated by Stream in CONTENT-LC* in FIG. 5).

B2BUA 424 has a session to TOC 410 and a session to CONTENT 426 that it may interconnect in a variety of ways. In embodiments of the present invention providing PVRBT, B2BUA 424 connects media logical channels of CONTENT 426 and TOC 410, to allow transmission of media from CONTENT 426 through B2BUA 424 to TOC 410 (e.g., illustrated by Stream in CONTENT-LC* flowing to Stream in TOC-LC* in FIG. 5). Accordingly, PVRBT is now being displayed at TOC 410.

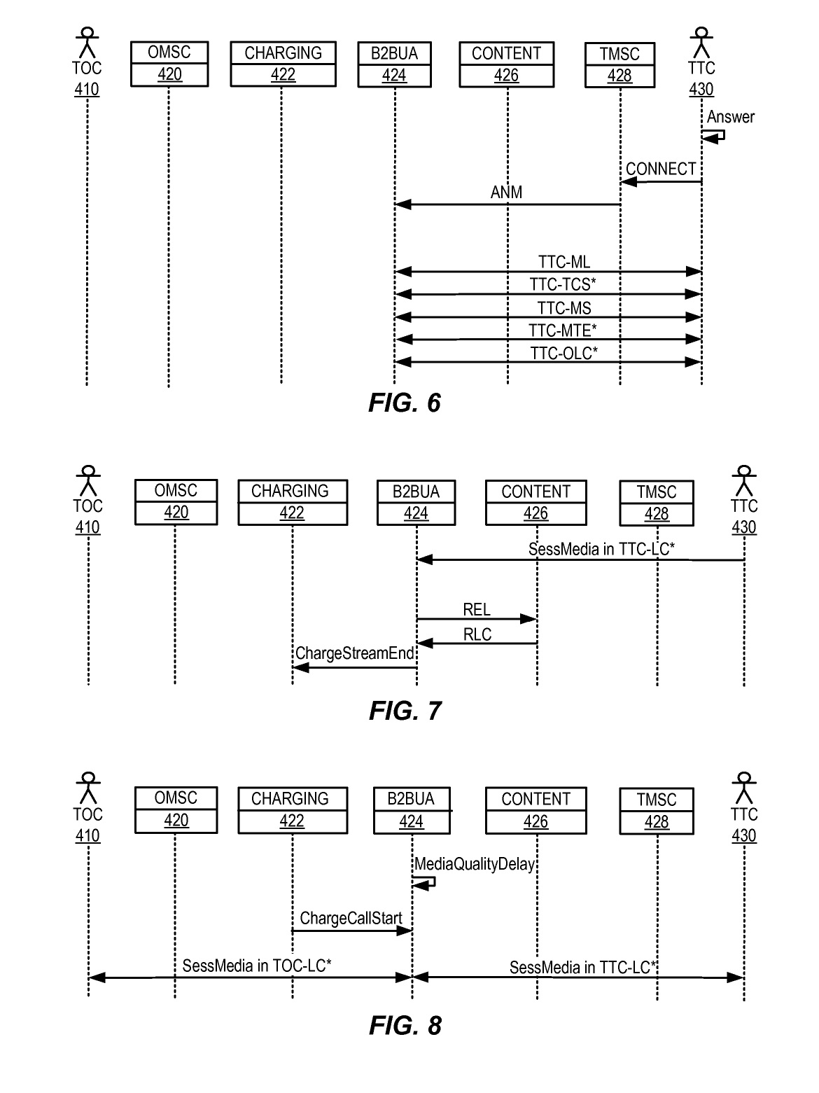

FIG. 6 illustrates session establishment for a terminal terminating call according to an embodiment of the present invention. Referring to FIG. 6, TTC 430 answers and a CONNECT message is sent from TTC 430 to TMSC 428. TMSC 428 then sends an ISUP Answer Message (ANM) to B2BUA 424. A communication link now exists between TTC 430 and B2BUA 424. Session characteristics TTC-B2BUA can now be determined.

The session established between TTC 430 and B2BUA 424 may be cross-connected to TTC 430, information regarding TOC's session or LC characteristics can be used to limit session characteristics between B2BUA 424 and TTC 430.

The restrictions applied may include, but not be limited to, any session characteristics or logical channel characteristics, examples being: reducing maximum ML, limiting media types available, limiting codecs available (to avoid transcoding), and the like.

Logical channels are opened between TTC 430 and B2BUA 424 via Open Logical Channel (OLC) requests. After OLCs and Multiplex Table Entry Requests (MTEs) are acknowledged by TTC 430 and B2BUA 424, media is free to flow in the logical channels (e.g., SessMedia in TTC-LC* as illustrated in FIG. 7).

Referring to FIG. 7, initially B2BUA 424 has a session to TOC 410, a session to CONTENT 426, and a session to TTC 430 that it may interconnect in a variety of ways. In embodiments of the present invention providing PVRBT, B2BUA 424 disconnects the signaling path and media logical channels between B2BUA 424 and CONTENT 426. CONTENT 426 is disconnected by means of an ISUP Release (REL). CONTENT 426 responds with an ISUP Release Complete (RLC). A charging event might be sent by B2BUA 424 to CHARGING 422 indicating the end of TOC's streaming session for billing purposes.

FIG. 8 illustrates session cutover according to an embodiment of the present invention. In embodiments of the present invention providing PVRBT, following personalized ringback, B2BUA 424 connects sessions between TOC 410 and TTC 430 as illustrated in FIG. 8. A TOC-TTC cutover decision may be delayed in order to enhance media quality.

If certain features in a bitstream are desired to be received initially after cutover, then B2BUA 424 may delay connecting TOC 410 and TTC 430 (in both the TOC to TTC and the TTC to TOC directions) until these features present themselves. During any cutover delay period, the MPS may still send media to TOC in order to maximize the period of active content to the TOC user. One example of this would be not disconnecting CONTENT 426, by executing the commands in FIG. 7, until after the media cutover shown in FIG. 8. This will maintain content transmission through session setup to TTC also and provide a TOC user with longer access to the content (which may attract a premium). Temporal media quality issues will generally be present in media types with temporal compression (i.e., some form of prediction based coding such as H.263, MPEG-4 Visual, H.264 or GSM-AMR). If no action is taken, the media quality will generally be impacted detrimentally. For video, this may result in significant corruption as inter coded frames arrive at TOC or TTC when an intra coded frame is required for proper presentation of the video.

Action may also be taken to initiate terminals to send these desired features. All these actions may be performed independently for each media channel in a system, or in concert across channels, adapting for media relationship quality such as audio/video skew. A media stream may be delayed waiting upon a complementary media stream to be present or present a desired feature. For example, audio might not be transmitted until video was ready with desired features.

An exemplary use of media quality enhancement delay is to wait for a video intra-coded (or key) frame (I-frame) before transmitting video through B2BUA 424. An arrival of an I-frame can be expedited by issuing of a request (e.g., an H.245 VideoFastUpdate or similar).

According to an embodiment of the present invention, the media delay function includes an ability to detect a desired feature. For a video I-frame in some codecs (e.g., H.263) a picture start code (PSC) and frame type inside a video media bitstream are detected. Demultiplexing of data (including RTP de-packetization), followed by some media bitstream analysis, allows this detection process. Since some features may be detectable in the multiplexed form, demultiplexing is not provided in some embodiments.

According to an embodiment of the present invention, if a media gateway with local generation of desired features (e.g., a transcoding media gateway as described in US Patent Application Publication No. 2004/0252761, commonly assigned, and incorporated herein by reference for all purposes) is being used, media quality issues could be resolved without delay, or the need to wait for their arrival in the incoming bitstream. An example of this local generation is if the media gateway is transcoding, and/or decoding, an incoming video bitstream prior to a decided cutover point and maintaining a state that would allow an I-frame to be generated on command into an outgoing bitstream. The output need not be used, nor generated, prior to the cutover time, but upon cutover time, an I-frame is generated without delay.

It should also be noted that if a transcoding media gateway is involved, and will remain involved, fewer characteristics of a session need to be matched (i.e., media codecs and configurations do not need to match). Additionally, a subset of signaling may be cross connected rather than the entire set.

Referring to FIG. 8, B2BUA 424 has two sessions attached that it may interconnect in a variety of ways. In embodiments of the present invention providing PVRBT, a session between TOC 410 and TTC 430 is utilized and B2BUA 424 connects signaling path and media logical channels of TTC 430 and TOC 410 via re-transmission. A charging event might be sent by B2BUA 424 to CHARGING 422 indicating the start of a TOC 410 to TTC 430 session for billing purposes. This charging happens at an equivalent time as for a normal TOC-TTC call, even though compared to the session establishment and services delivered to TOC it is delayed. As illustrated in FIG. 8, a session is now established between TOC 410 and TTC 430 and they may communicate as in a normal call between themselves.

B2BUA 424 need only remain in a session as far as its responsibilities require. As described more fully throughout the present specification, reducing the involvement of the B2BUA in the call provides a reduction in the amount of resources used during the call.

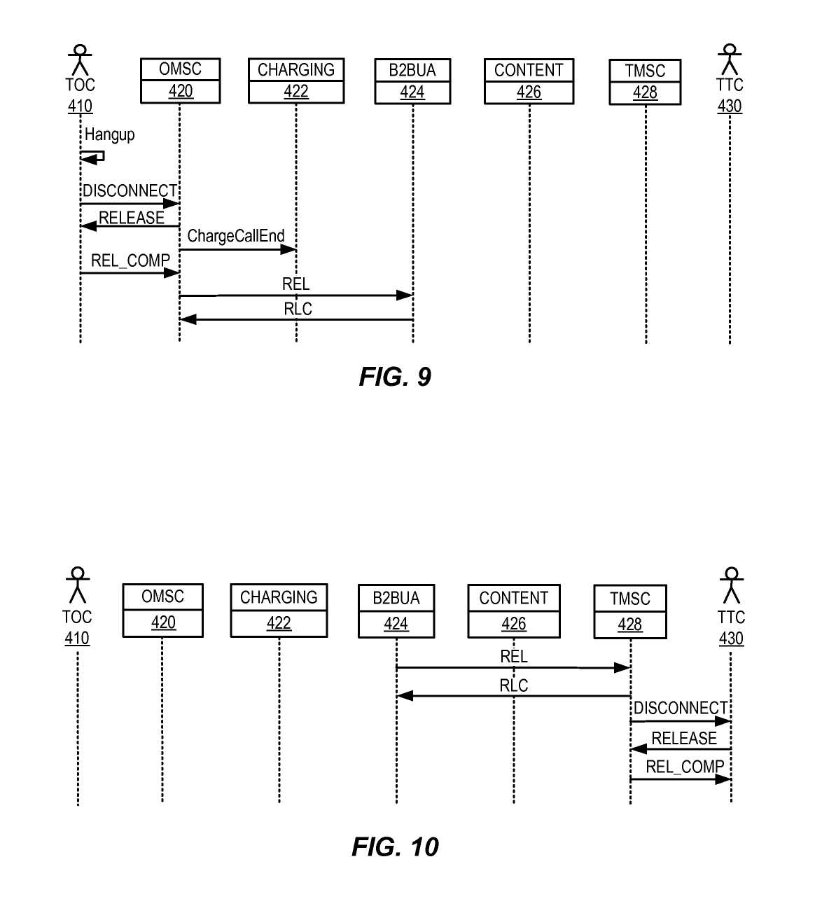

FIG. 9 illustrates session teardown from a terminal originating call according to an embodiment of the present invention. When either terminal (e.g., TOC 410 in the sequence illustrated in FIG. 9) decides to end a session, similar steps to Steps (H1) and (H3) take place. Following Step (H3), a Call signaling DISCONNECT is sent to an MSC to which a terminal is attached (OMSC 420 in the sequence illustrated in FIG. 9). After receiving a DISCONNECT from TOC 410, OMSC 420 signals a RELEASE to TOC 410. OMSC 420 sends an ISUP RELEASE message to B2BUA 424.

A charging event might be sent by B2BUA 424 to CHARGING 422 indicating the end of TOC 410 to TTC 430 session for billing purposes. TOC 410 sends a reply RELEASE_COMPLETE message to OMSC 420 and is no longer involved in the call. On receipt of an ISUP RELEASE message from OMSC 420, B2BUA 424 sends a return ISUP RELEASE_COMPLETE message to OMSC 420. A similar treatment should be obvious to those skilled in the arts for TTC 430 disconnection cases.

FIG. 10 illustrates session teardown propagated to a terminal terminating call according to an embodiment of the present invention. Referring to FIG. 10, disconnection message propagation is illustrated. B2BUA 424, on receipt of an ISUP RELEASE message from OMSC 420, sends an ISUP RELEASE message to TMSC 428. TMSC 428, on receipt of an ISUP RELEASE message from B2BUA 424, sends a return ISUP RELEASE_COMPLETE message to B2BUA 424, and a DISCONNECT message to TTC 430. TTC 430 sends a reply RELEASE message to TMSC 428, which replies with a RELEASE_COMPLETE message. The call is now finished and all parties are returned to states ready to make new calls.

Content

In embodiments of the present invention providing PVRBT, such as the embodiment illustrated in FIG. 4, if TTC 430 is not available, a message with a non-availability cause code (e.g., DISCONNECT or RELEASE), will be sent to B2BUA 424. This input can serve as an input to determine content served to TOC 410. The content displayed may be a busy indication or user not available indication. Other network announcements or indication content can be displayed in a similar fashion.

Other inputs to content selection and type of personalization supplied to a terminal may be decided as a function of one or more characteristics listed in Table 3. It will be apparent that the list of characteristics provided in Table 3 is not intended to limit embodiments of the present invention and other characteristics are included within the scope of the present invention. One of ordinary skill in the art would recognize many variations, modifications, alternatives, and additions to the personalization decisions.

TABLE 3

| Characteristic | Notes |
|---|---|
| Identity of receiving | |
| entity | |
| Identity of originating | |
| entity | |
| Phase of call | |
| Availability of TTC | Case of busy, network and user (call |
| | waiting) allow a different content |
| | to be displayed. |
| Status of TTC | Other terminal presently in a streaming |
| | session, or interacting in an interactive |
| | streaming session. |
| The capabilities of | Some content may not be available due to |
| terminals and of the | system/terminal capabilities, i.e. MPEG4- |
| CONTENT provider | Video content where a terminal only |
| | supports H.263, in a case where no |
| | transcoding functionality is provided |
| | in MPS. |
| | If bitrate of a content and bitrate of a |
| | terminal do not match (and no transrating |
| | is supported in B2BUA). |
| Pre-provisioned subscriber | |
| preferences | |
| Network personalization | The operator may provide content based |
| factors, e.g. demographic | on its own criteria. This may comprise, |
| information for | but not be limited to, individually |
| selection of content | targeted advertisements for a specific |
| | subscriber based on demographic and/or |
| | usage information. |
| Default | In the absence of other selection criteria, |
| | default content could be selected. |

Hunting

Referring once again to FIG. 4, following an incoming call from TTC 410, B2BUA 424 initiates a call to TTC 430. The B2BUA 424 can initiate several calls to several called party numbers. This is useful in an attempt to find a targeted user at several terminals or a group of users (for example, in a call center) and only cross connect the session to a TTC that answers.

Minimizing B2BUA Involvement

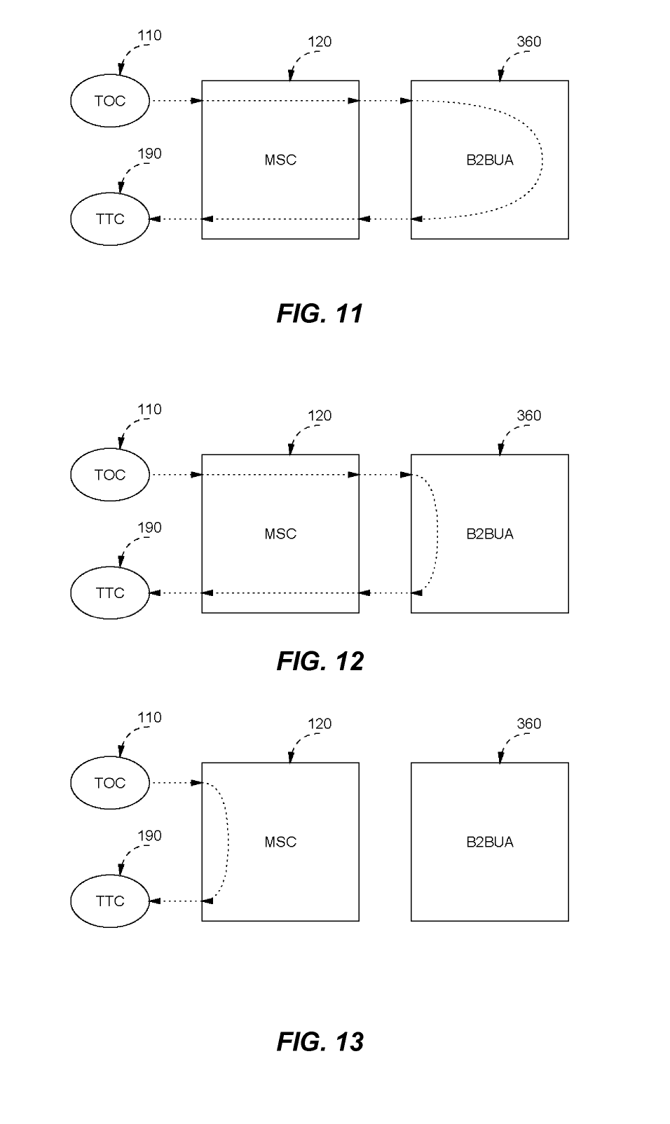

FIG. 11 illustrates a single direction media (or signaling) path according to an embodiment of the present invention. Referring to FIG. 11, following session connection between TOC 110 and TTC 190, B2BUA 360 performs tasks including receiving and retransmitting signals and data from TOC 110 to TTC 190 and TTC 190 to TOC 110. B2BUA 360 may be involved only passively (i.e., not performing session and/or media conversions) in some aspects of transfer of session media and signaling, involvement in this exchange is a consumption of resources (memory, cycles, ports or other) in B2BUA 360 and it may be desirable to reduce consumption of these resources.

If session characteristics and logical channel characteristics are created at session start-up, or modified in session, in a fashion that TTC 190 and TOC 110 characteristics are matched, then B2BUA 360 may reduce its role to being a conduit for bearer data and no longer have interaction in signaling or media. By way of example, FIG. 13 shows B2BUA 360 with reduced involvement.

According to an embodiment of the present invention involving 3G-324M devices, reduced involvement includes settings such as:
1. Mobile levels (ML) of operation are the same.
2. Multiplex Table Entries (MTEs) are the same.
3. Terminal Capabilities (TCS) are the same (at least for selected features), i.e., multiplexer capabilities, and only need be non-conflicting for other features.
4. Master-slave determination (MSD) procedure outcome for TOC and TTC are different, thus allowing for handsets to resolve conflicts.
5. Logical Channels (LCs) that are open are matched so the transmitting LC for one terminal matches the receiving LC for the other terminal.

According to an embodiment of the present invention, a method to give greater control to B2BUA in negotiations with TTC is to ensure that B2BUA becomes slaved to TOC. B2BUA may then become the master to TTC, allowing B2BUA to resolve conflicts in B2BUA-TOC session characteristics with desired characteristics to allow better session characteristic matching to B2BUA-TOC.

Session characteristics could be designed to explicitly match capabilities negotiated by TOC and TTC. If matched correctly, this allows freeing of B2BUA from the call (i.e., removing B2BUA from the loop), after it has provided its service (i.e., after providing a personalized video ringback tone to TOC).

It will be appreciated that the ability to modify some session characteristics during a session is possible. Characteristics that are session-modifiable allow for non-compatible characteristics at session establishment between TOC and TTC. Prior to session cutover, these characteristics may be modified in each established session to make them match a desired set of characteristics. For example, this could be done with H.245 messages in H.324 and H.323 or ReINVITE messages in SIP.

FIG. 12 illustrates a single direction media (or signaling) path with reduced involvement according to an embodiment of the present invention. Referring to FIG. 12, a technique known as hair-pinning is illustrated. In this technique, the involvement of B2BUA 360 is reduced to a direct transfer of session (bearer) data.

When involvement of B2BUA 360 is minimized to a transfer of bearer data a Release Link Trunk (RLT) can be performed to remove B2BUA 360 entirely from a call. From the personalized video ringback tone scenario an RLT would be performed during session connection (after FIG. 8). After an RLT, the session is no longer associated with B2BUA 360 (FIG. 13). Call teardown will occur as for a conventional call where B2BUA 360 is not a network element. In SIP/IMS networks RLT may be replaced with ReINVITEs or REFERs to implement release functionality.

All possibilities between remaining completely in media and signaling paths (FIG. 11), to a complete release of channel (FIG. 13) are recognized as having utility with a trade-off between passive involvement and access to session information. The network utilization benefit for removing the B2BUA element from a session is obvious. If at a minimum, B2BUA retains minimal access to bearer data and signaling, it also retains an ability to offer several other services outlined in further example embodiments.

Non-Terminating Party Media Supply Example

Embodiments of the present invention provide methods and systems in which media is supplied to a non-terminating party. After a terminal disconnects, in any fashion, B2BUA may stream media content to terminal that did not disconnect as B2BUA has an ability to independently terminate TOC-B2BUA and TTC-B2BUA. An example use for this would be to send advertisement or announcements from an operator.

Referring once again to FIG. 9, an illustration is provided that shows TOC 410 terminating a session and being released by B2BUA 424. B2BUA 424 has options for disconnection of TTC 430. These options include immediately propagating a termination to TTC 430 and ending the call. This option is illustrated in FIG. 10. Another option is to not propagate a termination to TTC 430 and instead set up a streaming session to the non-terminated party. This option is similar to FIG. 5 for TTC 430. The duration of a streaming session may be a fixed period, based on an interactive event, or indefinite.

If a fixed period is employed, a termination will be sent after a content is displayed. This example is illustrated by the sequence illustrated in FIG. 7 followed by FIG. 10. If indefinite streaming, a streaming session is allowed to continue indefinitely and only when a terminal performs its hang-up is this termination released. This example is illustrated by the sequence shown in FIG. 9 with TTC 430 terminating followed by B2BUA 424 as shown in FIG. 7. By way of example, an indefinite period would most likely only be used when a terminal being held in session is an interactive agent capable of terminating a call. Of course, other options are included in the scope of embodiments of the present invention.

Non-Originating Party Media Supply Example

Other embodiments of the present invention provide methods and systems in which media is supplied to a non-originating party. For example, after the sequence illustrated in FIG. 6, it is possible to add a modification to the sequence shown in FIG. 5 that supplies media to TTC 430 instead, or in addition to, TOC 410. Content could be self personalized content, advertising or interactive content, and the like. Of course, the content is not limited to these examples.

Streaming to TTC 430 may create a situation where both users have personalized content being streamed to them. An example usage of this approach might be a free call system, where advertisement is supplied to users for a predefined time at call start-up. Referring to FIG. 7, after a cutover decision is made, B2BUA 424 executes a REL command. Further, a process based on one or modifications to the sequence shown in FIG. 7 for terminating TTC 430 stream is inserted after FIG. 5. FIG. 8 is then entered and continued as per normal PVRBT call flow.

Interactive Media Supply Example

As B2BUA 424 sets up sessions to TOC 410, TTC 430, and CONTENT 426, it is not restricted to connect CONTENT 426 unidirectionally to the terminals. An ability to create interactive streams arises by opening both ends of a session, such that terminals can interact with CONTENT entity 426 via B2BUA 424, B2BUA 424 may interact with CONTENT 426 based on script, or B2BUA 424 may act as a proxy for user commands issued in media streams such as voice recognition, or video action recognition.

B2BUA 424 could act as an intermediary, offering translational services, or CONTENT server 426 could be an interactive entity itself, capable of responding directly to terminal requests proxied through B2BUA 424. Several non-limiting examples are provided: (A) CONTENT 426 as an H.324-like terminal that is capable of receiving inputs as user input indications (H.245 UII) to modify its behavior; and (B) CONTENT 426 as an RTSP-like terminal that is capable of receiving inputs as RTSP-like controls. B2BUA 424 may then provide a mapping of user input indications UII to RTSP controls.

User interactions could be used to select content, modify content playback behavior, interact with advertising, and/or play interactive games. For both cases, the input meanings for an interaction could either be pre-shared or shared as part of a session. If an interaction has taken place with a terminal, B2BUA 424 may decide to delay any session cutovers. If a client has interacted with a stream, they could be given time to finish their interaction and not be interrupted. Personalization to the other entity could be introduced at this point, to cover an interaction period.

Other embodiments of the present invention provide for periodic interruption of the media supply. If B2BUA retains involvement in a call, B2BUA may be used to interrupt media sessions of any of users involved, and replace content of a session with a configurable media stream. An example use of this embodiment is for a free call session, where users are not directly paying for service, but instead pay indirectly for service by viewing advertisements according to a predefined contract.

By way of example, interruptions could be preceded by indications using mixed content indicators, to allow a terminal's user to prepare for the interruption and enhance a user's experience.

Session Media Mixed Media Supply Example

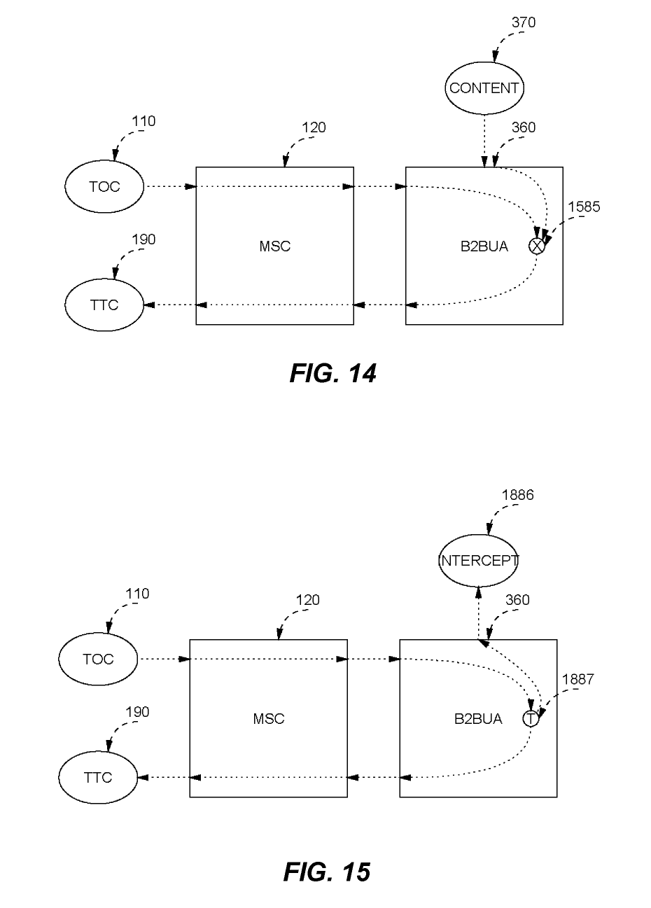

FIG. 14 illustrates a single direction media path with content mixing according to an embodiment of the present invention. In addition to the previously described examples, embodiments of the present invention supply session media in the form of mixed media. For example, if B2BUA 360 retains involvement in a call, B2BUA 360 may be used to provide a mixed content (themed) session. Content is provided by content server 370. As shown in FIG. 14, a media and/or signaling flow is illustration in which, during interaction, some part of, or all, session media could form a part of streamed and interactive content. The mixing element is illustrated by element X (1585) in FIG. 14.

In its simplest form, replacement or adjunct channels could be supplied by B2BUA 360 inside a more capable network for people dialing in from, or roaming into, single media only networks (or otherwise capable networks). As an example, VOIP, 2G (including 3G subscribers in 2G coverage) or PSTN clients may negotiate through a gateway with a 3G network and establish a voice only call. B2BUA 360 could offer a range of solutions to a user's lack of visual presence.

A replacement stream may be a non-descript silhouette, static image, any kind of video, and may or may not be related to the calling party. The called party and operator information can also be used to determine content type. A stream may also be an avatar, a computer generated representation, possibly personalized (e.g., as discussed in U.S. Pat. No. 6,559,845), representing a calling party that is designed to move its mouth in time with an audio only signal.

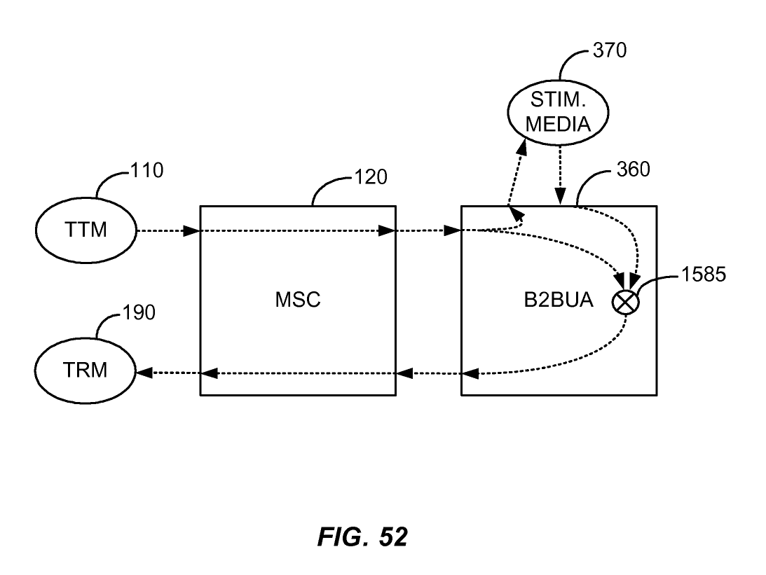

FIG. 52 is an example of providing multimedia to a terminal with a media type generated in accordance to stimulation by a received media according to an embodiment of the present invention. An example application of this is video call completion to a voice call (possible with either end originating). A media signal is used to generate an augmented or alternate stream for use according to an embodiment of the present invention. Video ringback may be played to TOC, but only an audio connection is provided to the other end (the terminating side). The voice signal from the terminating side can then be used to provide a stimulus to the animated avatar. This allows a video ring back, or even a simple announcement, to be played to a video subscriber when they are contacting someone with a less capable device such as a voice only enabled device and then to continue the session in a video format. It is also possible to minimize network load that after the playback of a video ringback instead of providing an avatar or the like instead a fallback to a voice only call occurs (SCUDIF-Service Change and UDI Fallback).

The video session completion to voice also allows completion to 2G mobile terminals mobile networks, fixed-line phones in PSTN networks, or IP terminals with voice only capabilities, such as video camera not available or bandwidth limited. It would also be applicable to a pair of devices that could not negotiate a video, or other media, channel, even with some transcoding capabilities interposed.

In FIG. 52, a terminal transmitting media (TTM), e.g. a 2G voice terminal, is trying to transmit to a terminal receiving media (TRM), e.g. a 3G video terminal. In this example, the incoming bitstream from the TTM is only a voice bitstream. The voice bitstream is sent to a media generator (Stim Media 370) through a voice gateway and media server. The media generator generates video signals which can synchronize with incoming voice signals, by, for example, recognizing features in the speech. The generated video signals combined with voice signals are output via a mixer (multiplexer 1585) and finally transmitted to the 3G terminal. The video signal may also detect other aspects of the voice signal, such as gender or a level of excitation of the person speaking, in order to provide a more realistic/active animation.

As will be evident to one of skill in the art, adjunct channels are not limited to augmenting video only, but include replacement of any missing media, or logical channel, or other features as available.

A significant enhancement to user experiences is produced by the use of mixing technologies, where a media signal between the terminals is no longer simply proxied or generated. Instead, media from a session would be mixed according to some pre-configured rule set with configurable content. An example would be picture in picture during an advertisement, where either session media or an advertisement media takes on reduced scope (for example down-sampling by 2 in both directions) and may superimposed on the other media. Another example is the use of mixed media in conjunction with periodic interruption, whereby an alerting indicator alerts the user that a periodic advertisement is about to appear. Examples include a beeping tone in audio and/or fading video. Both of these examples could be used to provide a less expensive service to a subscriber by advertising or providing another benefit to the operator, for example, branding or advertising revenue.

Other possibilities in this mixing domain include supplying complete media of a user but augmented with configurable media. One non-limiting possibility is a theme for a user environment, whereby a frame could be added to picture media and other ambient noises could be added as well. Further to this example, framed media could be a motion rendition of a rainforest; with low level ambient noises from a rainforest scene. Further, a frame need not be limited to displaying session media directly in windowed fashion, but instead could be interacted whereby occasionally an element of a theme could interpose itself on session media, such as a bird flying across, or a lizard walking across the screen. This could be designed such that both terminals receive the same mixed-in events, and might be useful in a walk-through of a scene, i.e., a real estate agent walking a client through a pre-recorded filming session of a house.

Embodiments of the present invention provide methods and systems that include session media intercept. FIG. 15 illustrates a single direction media (or signaling) path being intercepted according to an embodiment of the present invention. If B2BUA 360 remains entirely in media and signaling paths, media-based analysis and capturing (e.g., lawful intercept) is possible. FIG. 15 introduces an INTERCEPT entity 1886 and a tap point, T 1887. INTERCEPT 1886 could be an entity supporting a standard video telephony protocol, e.g., SIP, H.323 or RTSP (with record). A session could be opened from B2BUA 360 to INTERCEPT 1886 when a session of interest is present. The session will be intercepted as allowed by legal authority according to an embodiment. Determining that a session of interest is present uses such information as calling party and called party. In an embodiment, all streaming media and session signals are sent to INTERCEPT device 1886, either for saving and later retrieval, or for real time analysis.

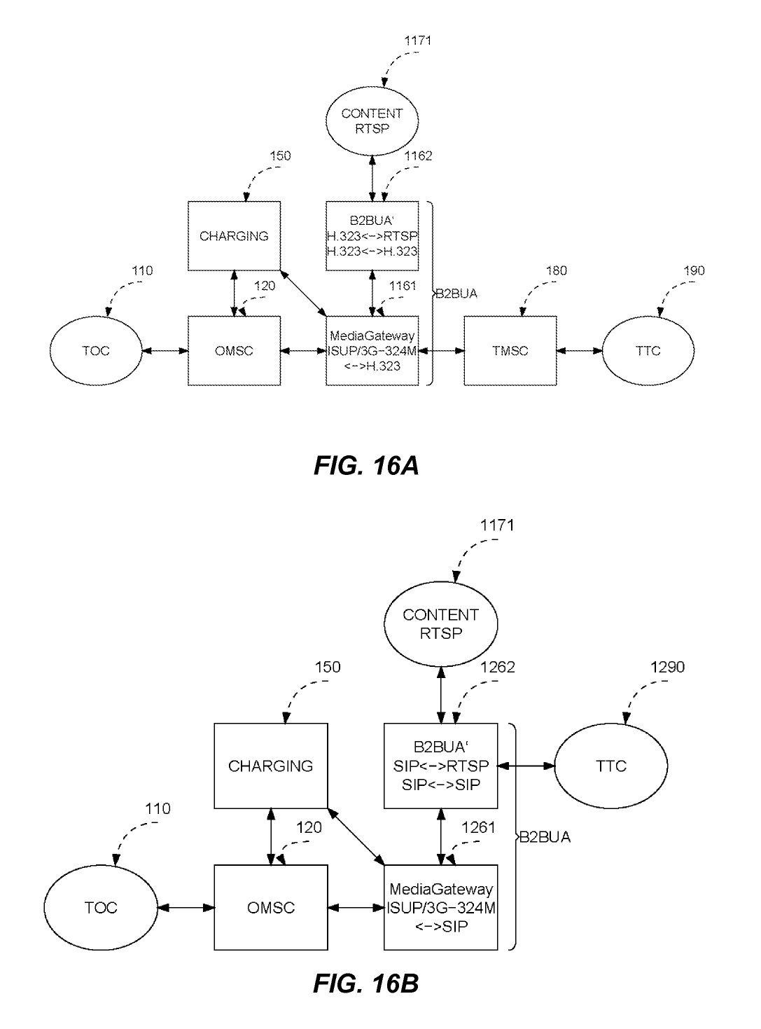

FIG. 16A illustrates another connection architecture for MS-to-MS H.324 calls using IP content according to an alternative embodiment of the present invention. In the example illustrated in FIG. 16A, an alternate network placement is shown. FIG. 16A shows an exemplary embodiment with an entity offering services similar to MSP created from an ISUP to H.323 transcoding media gateway and externally coupled with a H.323 to H.323 or RTSP switching gateway. It should be noted that the H.323 to H.323 or RTSP switching gateway is a further embodiment of the invention (B2BUA′) that operates with H.225.0-Q.931 signaling and RTP media in conjunction with the H.323 protocol. Similar embodiments couple with a media gateway to offer MSP features across protocol boundaries without recreating all components in a given protocol domain.

FIG. 16B illustrates an alternative connection architecture for MS H.324-to-SIP calls using IP content according to another embodiment of the present invention. The implementation illustrated in FIG. 16B shares some commonalities with the implementation illustrated in FIG. 16A. In FIG. 16B, a session connection is established between B2BUA′ 1262 and TTC 1290. A benefit provided by the implementation illustrated in FIG. 16B is that content, for example, video ringback content, may be delivered to a H.324 device, for example, a 3G-324M terminal or device in communication with a SIP device.

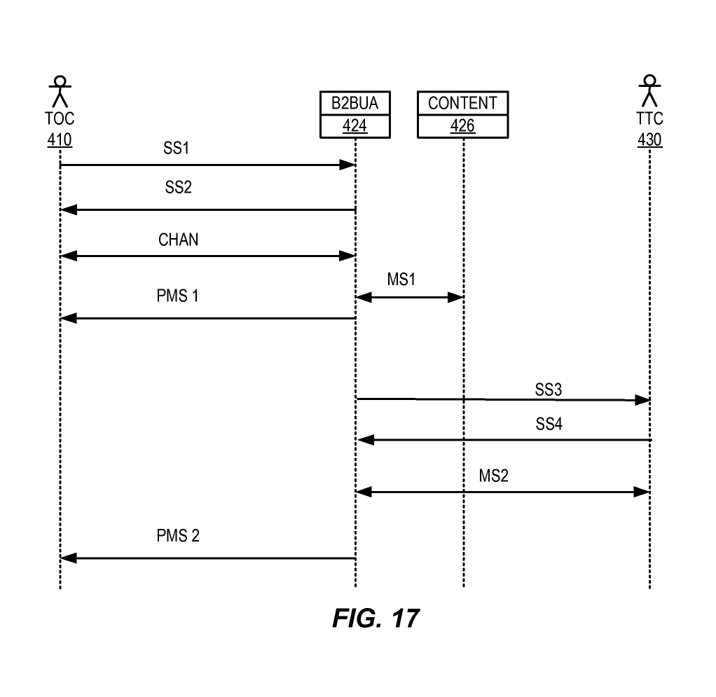

FIG. 17 illustrates session establishment and content delivery for a terminal originating call followed by session media delivery according to an embodiment of the present invention. TOC 410 transmits a first session signaling message SS1 to B2BUA 424. In an embodiment, the TOC 410 is an H.324-like terminal such as a 3G-324M handset. The B2BUA 424 provides the functionality of a media server in the embodiment illustrated in FIG. 17. A second session signaling message SS2 is transmitted from B2BUA 424 to TOC 410. Following the first signaling message and the second signaling message, one or more channels are established between TOC 410 and B2BUA 424.

A first media stream MS1 is established between a content device (CONTENT 426) and B2BUA 424. In an embodiment, CONTENT 426 is a media streaming server, such as an RTSP server, having one or more memories. Utilizing media stored in the content server 426 and the first media stream, B2BUA functions as a media server, processing the first media stream to form a first processed media stream PMS1. The first processed media stream PMS1 comprises a ringback media stream according to an embodiment. The first processed media stream PMS1, for example, a ringback media stream, is transmitted from B2BUA 424 to TOC 410 using the one or more channels previously established.

As illustrated in FIG. 17, a third session signaling message SS3 is transmitted from B2BUA 424 to TTC 430, which is a second terminal in some embodiments, for example, an H.324 device, a 3G-324M device, or a SIP device. A fourth session signaling message SS4 is transmitted from TTC 430 to B2BUA 424 and a second media stream MS2 is established between TTC 430 and B2BUA 424. In an embodiment, media transmitted from TTC 430 is processed by B2BUA 424 to form a second processed media stream PMS2, which is transmitted from B2BUA 424 to TOC 410. The second processed media stream PMS2 may be transmitted from B2BUA 424 to TOC 410 using the one or more channels previously established.

It should be appreciated that the specific steps illustrated in FIG. 17 provide a particular method of providing content delivery, for example, video ringback services, according to an embodiment of the present invention. Other sequences of steps may also be performed according to alternative embodiments. For example, alternative embodiments of the present invention may perform the steps outlined above in a different order. Moreover, the individual steps illustrated in FIG. 17 may include multiple sub-steps that may be performed in various sequences as appropriate to the individual step. Furthermore, additional steps may be added or removed depending on the particular applications. One of ordinary skill in the art would recognize many variations, modifications, and alternatives.

The temporal position of the session signaling messages is determined in embodiments of the present invention as appropriate to the particular applications. In a first example, SS2 could precede SS1 if B2BUA is initiating the call. Likewise, SS3 could precede SS1 or be sent concurrently with SS1 if B2BUA was initiating the connection with TTC prior to or concurrently with the connection to TOC. SS3 could also occur at times prior to or after SS1 in other embodiments. Thus, the temporal order illustrated in FIG. 17 is provided merely by way of example. Depending on the particular applications, the temporal order of the various session signaling messages will vary as appropriate. One of ordinary skill in the art would recognize many variations, modifications, and alternatives.

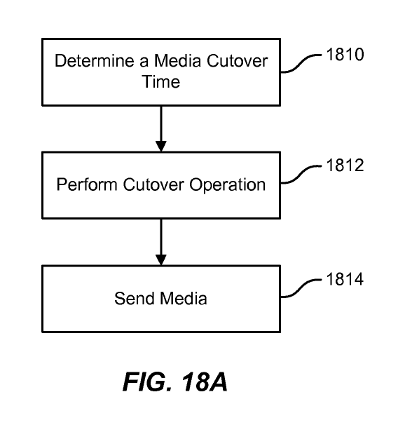

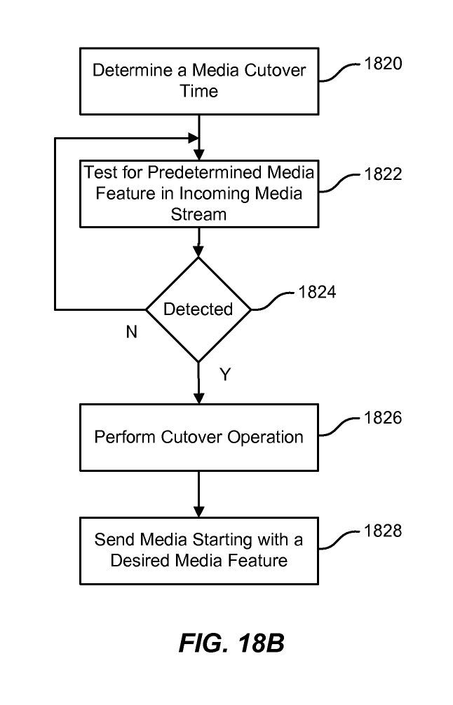

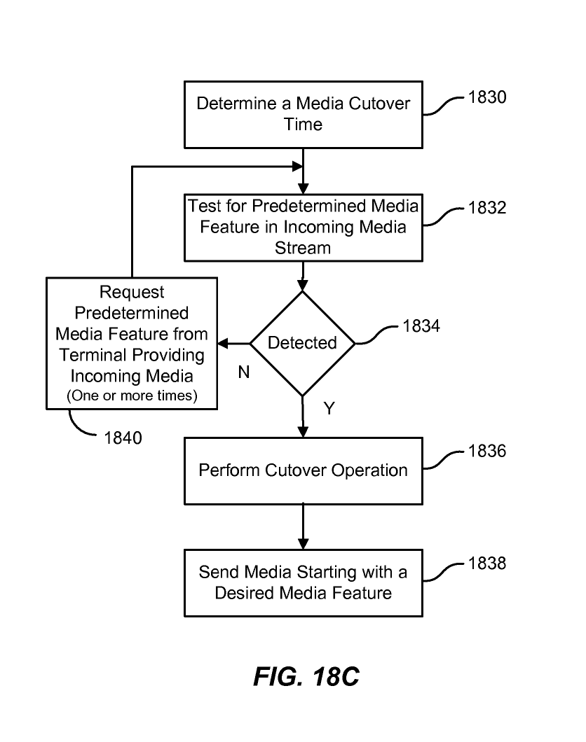

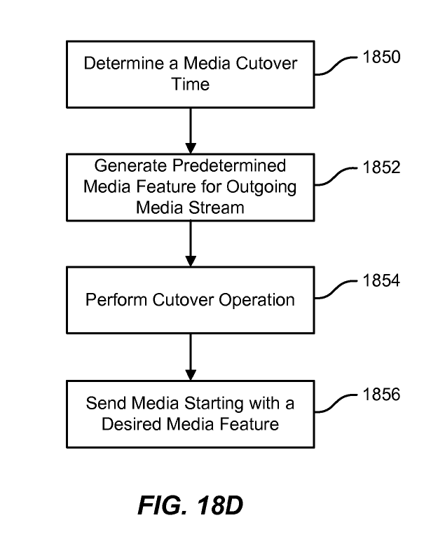

FIGS. 18A-D illustrate methods of performing media cutover according to embodiments of the present invention. At a certain time, the MPS will be operated to perform a cutover operation, delivering a second media stream to the TOC in place of a previously delivered media stream. For example, the content in a video ringback message could be replaced by session media received at the MPS from the TTC. Referring to FIG. 18A, a media cutover is determined (1810) and a cutover operation is performed (1812). Media is sent from the MPS to the TOC (1814). In the embodiment illustrated in FIG. 18A, the media is sent without certain desired features as described more fully throughout the present specification and more particularly below.

Referring to FIG. 18B, a media cutover time is determined (1820). A test is performed to determine if a predetermined media feature is present in an incoming media stream (1822). In an embodiment, the predetermined media feature includes a temporal media feature. As an example, temporal media features include an intra-coded frame (I-frame). If the predetermined media feature is present in the incoming media stream, media cutover is performed (1826). As shown in step 1828, the cutover is initiated starting with a desired media feature. According to embodiments of the present invention, the desired media may be an I-frame encoded for the outgoing media type. Thus, the desired media feature may be the originally detected incoming I-frame or a modified (e.g., transcoded) version of the incoming I-frame.

If, on the other hand, the predetermined media feature is not present in the incoming media stream, the process returns to step 1822 and testing for the predetermined media feature is continued.

In comparison with the process illustrated in FIG. 18A, the step of sending media (1828) illustrated in FIG. 18B is thus delayed in some embodiments to provide an output media stream with improved quality, among other benefits. As discussed more fully throughout the present specification, the cutover from ringback media to session media is performed after detection of the predetermined media feature (e.g., an I-frame) in order to provide temporal features utilized by the TOC to decode the media streams. One of ordinary skill in the art would recognize many variations, modifications, and alternatives.

Referring to FIG. 18C, similar processes (1830, 1832, 1836, and 1838) are performed as discussed in relation to FIG. 18B. If the predetermined media feature is not present in the incoming media stream, a request for the predetermined feature (1840) is made to the TTC. The request may be made a single time or repeated a number of times. In a particular embodiment, the request is repeated a number of times at a predetermined frequency. Subsequently, the process returns to step 1832, i.e., testing for the predetermined media feature.

Referring to FIG. 18D, a media cutover time is determined (1850). In the embodiment illustrated in FIG. 18D, the MPS contains an ability to locally generate a predetermined media feature (1850). Thus, the method illustrated in FIG. 18D does not need to wait to receive the predetermined media feature, either passively or based upon a request sent by the MPS. Rather, with a reduced or no delay, the predetermined media feature is generated for use in the cutover operation. Once a desired media feature has been generated, the cutover operation is performed (1854) and the media is sent to the TOC starting with the desired media feature. The desired media feature is an I-frame in some embodiments in which the predetermined media feature comprises a temporal media feature. In a particular embodiment, the predetermined media feature is the same as the desired media feature, for example both are I-frames.

It should be appreciated that the specific steps illustrated in FIGS. 18A-D provide particular methods of performing cutover operations (media replacement) according to embodiments of the present invention. Other sequences of steps may also be performed according to alternative embodiments. For example, alternative embodiments of the present invention may perform the steps outlined above in a different order. Moreover, the individual steps illustrated in FIGS. 18A-D may include multiple sub-steps that may be performed in various sequences as appropriate to the individual step. Furthermore, additional steps may be added or removed depending on the particular applications. One of ordinary skill in the art would recognize many variations, modifications, and alternatives.

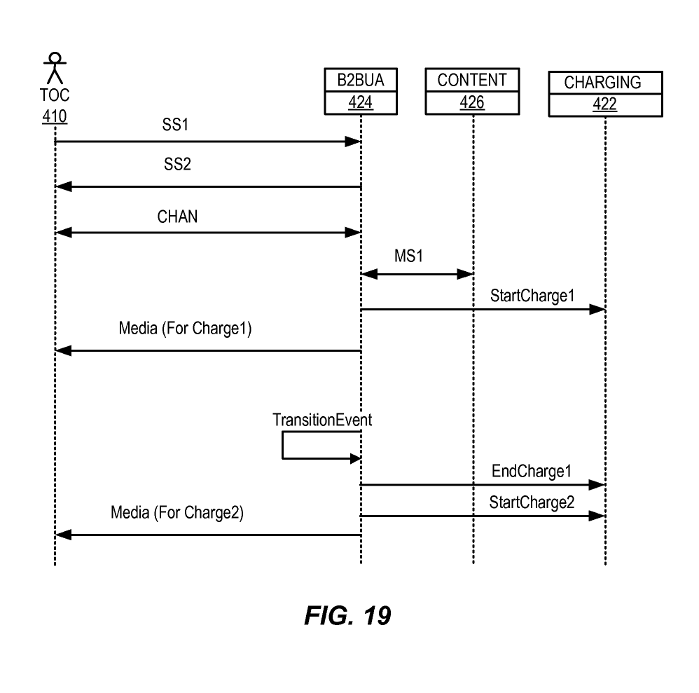

FIG. 19 illustrates session establishment, content delivery, and charging for a terminal originating call according to an embodiment of the present invention. TOC 410 transmits a first session signaling message SS1 to B2BUA 424. In an embodiment, the TOC 410 is an H.324-like terminal such as a 3G-324M handset. The B2BUA 424 provides the functionality of a media server in the embodiment illustrated in FIG. 17. A second session signaling message SS2 is transmitted from B2BUA 424 to TOC 410. Following the first signaling message and the second signaling message, one or more channels CHAN are established between TOC 410 and B2BUA 424.

A first media stream MS1 is established between a content device (CONTENT 426) and B2BUA 424. In an embodiment, CONTENT 426 is a media streaming server, such as an RTSP server, having one or more memories. A call charging message (StartCharge1) is transmitted from B2BUA 424 to CHARGING 422 associated with establishment of the first media stream. Media related to Charge1 is transmitted from B2BUA to TOC. Thus, the initiation of the charging process for the media associated with Charge1 accompanies the delivery of such media. As an example, for video ringback applications, a first predetermined charge will be associated with some media (for example, premium content) and a second predetermined charge (e.g., a reduced charge) will be associated with other content. Additionally, the charge for media associated with Charge1 may be based on the temporal length of the media (e.g., longer or shorter video clips). For subscribers with monthly service plans, the value charged for the StartCharge1 and EndCharge1 messages may be reduced or zero in comparison with other subscribers and in some embodiments, the StartCharge1 and EndCharge1 messages may not exist. Other variations, modifications, and alternatives to the charging structures will be evident to one of skill in the art.

The transition event (TransitionEvent) is generally associated with media cutover or user activity. As an example, answering of a call by the TTC may result in a transition event. Additionally, menu interactions in video mail or portals may trigger a transition event. EndCharge1 is typically associated with the transition event and results in the termination of charging associated with the Charge1 period. As illustrated in FIG. 19, StartCharge2 is also associated with the transition event. Media associated with Charge2 is transmitted from B2BUA 424 to the TOC as shown. Merely by way of example, during a video ringback application, the media associated with Charge2 could be media transmitted from the TTC or other entity.

As illustrated in FIG. 19, methods and systems provided according to embodiments of the present invention provide the ability to delay charging associated with session establishment and media or content delivery to a terminal. Thus, session establishment may be accomplished, along with appropriate charging, before the transition event, for example, the answering of the call by a called party. Content delivered prior to answering can thus have associated charging, while content delivered after answering can have a different charging process. Charging may coincide with other messages in this or other call flows present in the network. For example, charging may be related to the transition event associated with a Q.931 CONNECT from TTC or an ISUP ANM, which may be a single message.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein.

Minimizing B2BUA Involvement for Video Ringback

For video ringback delivered to H.324 devices, such as 3G-324M devices, embodiments of the present invention provide several ways to reduce interaction of the B2BUA (also referred to as VRBT or MSA) if desired. These methods include coping with SRP numbering disjoins as well as obviating the problem through new device and/or network capabilities and aligning session characteristics more closely, as described more fully throughout the present specification.

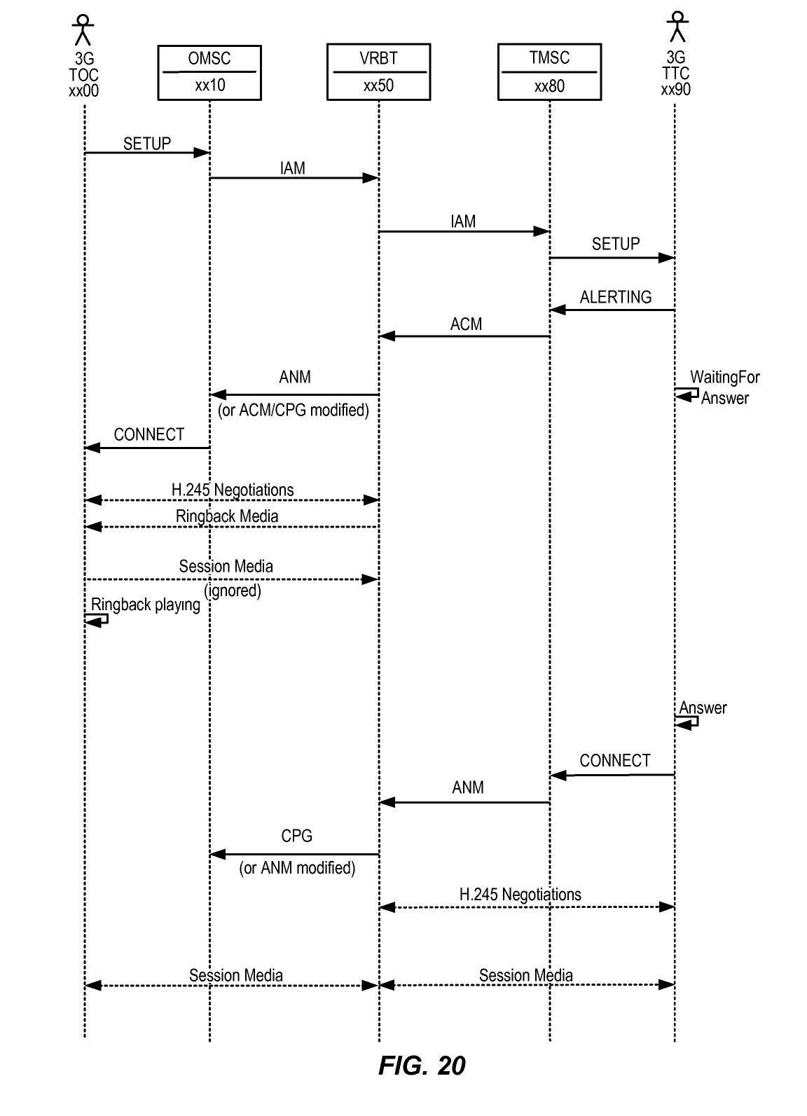

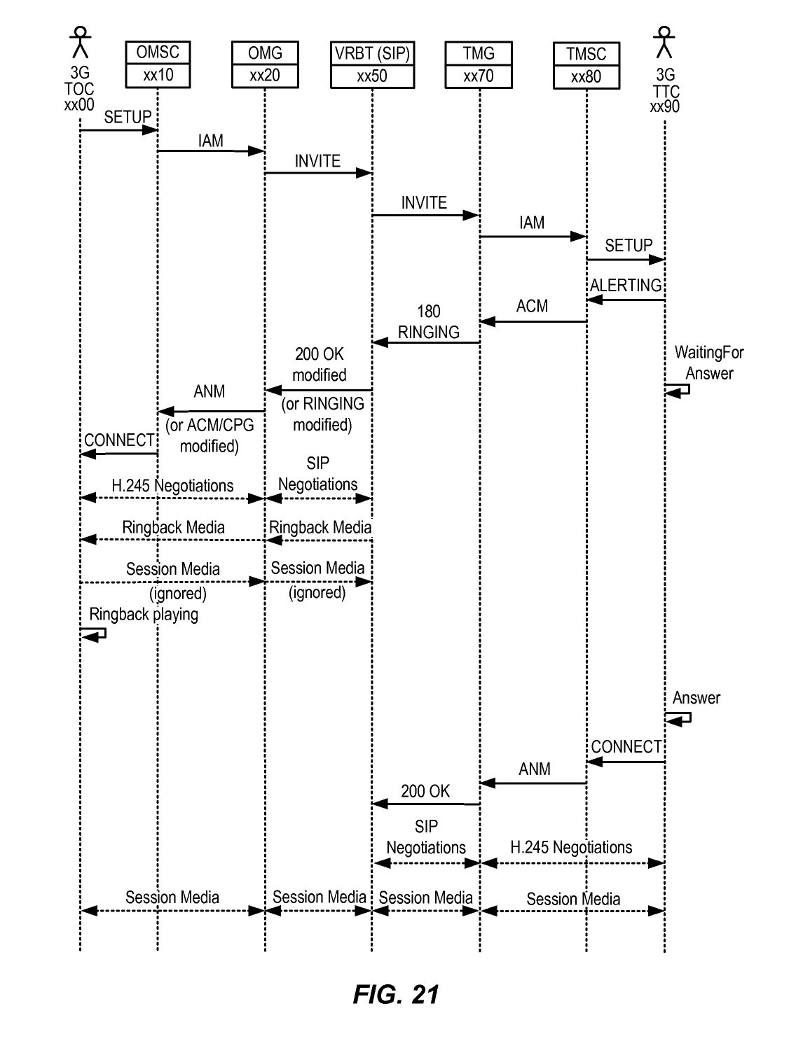

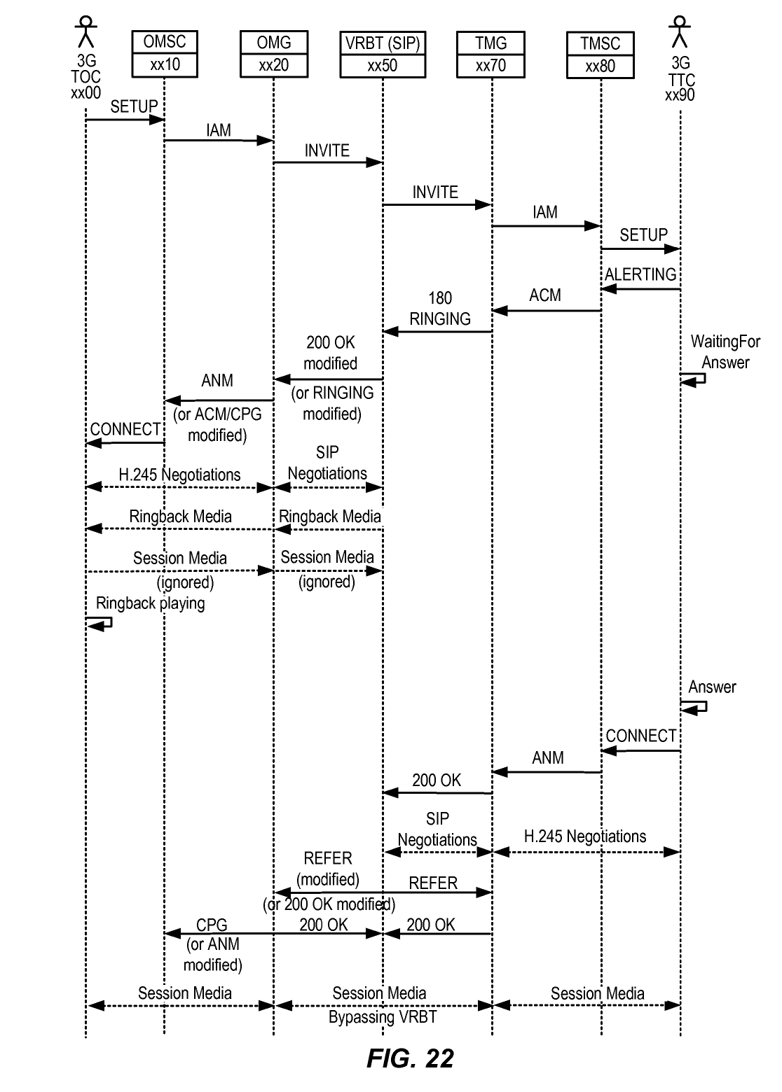

FIG. 20 illustrates a normal video ringback call with initial ringback media according to an embodiment of the present invention. These figures are used as a reference for FIG. 22 through FIG. 28 in describing certain methods for reducing the involvement of network equipment. As illustrated in FIG. 20, a two way session is established between H.324 devices on an ISUP network, such as a 3G network supporting 3G-324M video calling. FIG. 21 shows another video ringback call according to an embodiment of the present invention. In the network associated with FIG. 21, the B2BUA agent VRBT (SIP) is a SIP interfaced device, coupled to one or more H.324 to SIP gateways. Use of a SIP enabled device, coupled to a media gateway, may allow for a more simple application server and the reuse of many IP-based elements that may be less expensive to deploy, and also may be mutualized/shared with other networks such as SIP/IMS. FIGS. 20 and 21 show calling sequences where no reduction in the involvement of B2BUA has been attempted. Media and session data flow through the VRBT as well as the intervening gateways. They also display particular messages related to billing characteristics explained more fully throughout the present specification.

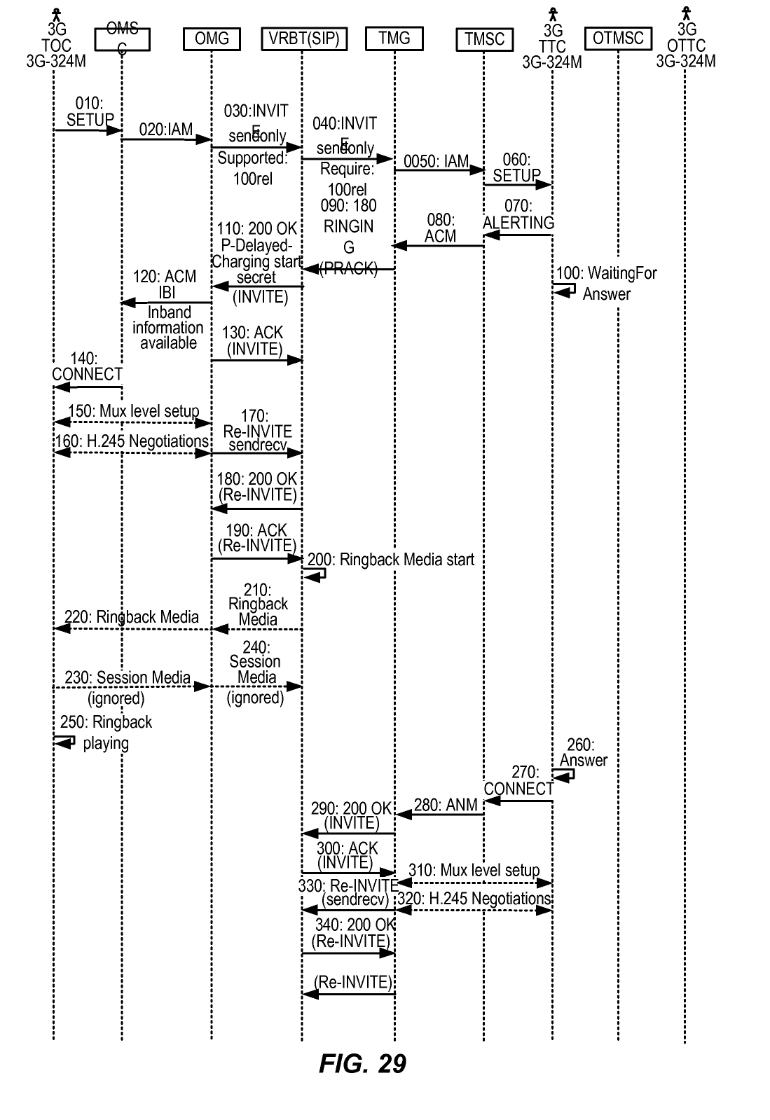

Of particular note in the billing process is the presence of a CONNECT message being emitted in response to messages not normally associated with a CONNECT. These messages are the ALERTING/RINGING messages as well as either ACM or CPG at the OMSC. Some of the variations that are included as examples include the VRBT server issuing a call connection message, either SIP 200 OK, or an ISUP ANM, or the MSC responding to a message not normally associated with a call connection (such as an ACM or CPG) and connecting the bearer. The latter option has advantages associated with the billing characteristics for the call and because it does not require any handset modifications. In some embodiments, a minor modification to the OMSC could be required. Therefore, in many deployments, this latter option will be the most appropriate. This delayed charging, or Pre-ANM bearer, is more fully explained in the description associated with FIGS. 29 and 42-45. Alternatives allowing the use of the bearer before the CONNECT is sent to the multimedia device are also possible, for example, in response to an ALERTING/ACM or CPG message, but this would typically require modifications to the handset as well as the modem chipset in some cases.

The H.245 and SIP negotiations may involve the creation of media channels as well as other session and terminal capabilities and characteristics. It should also be noted that the messages marked as with modifications may or may not be modified themselves, but may have modified interpretations in the service logic that may cause their modified effects on a typical/expected call flow to occur. For example, the use of a “normal” CPG message, in a system which does not otherwise employ them or if an HLR lookup determines a feature subscription, could cause modifications to the messages or their interpretations at various pieces of equipment involved in the call or session

FIG. 22 shows minimizing VRBT involvement by SIP REFERral (or ReINVITE) according to an embodiment of the present invention. As illustrated in FIG. 22, a SIP REFER is used to collapse the session away from the SIP server. As a result, the involvement of the SIP server is reduced along with the necessity of provisioning resources for an entire call when the SIP server may only be involved for a short period (e.g., an average of 15 seconds or less) at the start of a call. A REFER can also be used to collapse the involved party trombone, either part way or entirely, all the way back to the MSC linking the two parties bearers.

For some devices and situations, linking the bearer directly may cause problems, especially with SRP numbering. The SRP/NSRP/WNSRP numbering of the two sessions will likely be in different states, that is with differing sequence numbers for transmission and for expected reception. For example, assuming a sequence number starting at zero for both parties involved in a call, one side may only have transmitted 5 SRP message and the other side may have transmitted 10. The gateway would have to add 5 to one direction and subtract 5 from the other. This situation can be overcome by placing a monitoring device on the bitstream searching for certain features and modifying them on the fly, which uses an ability to detect the various flavors of SRP that may require demultiplexing of either MTE 0 or 15. Alternatives exist where it would be possible to not entirely demultiplex the SRP contents. If some device remains in the loop, this monitor may be some part of the B2BUA, or possibly a new entity contained in the MSC that does a simple modify on SRP frames to renumber them as required by the respective interfaces.

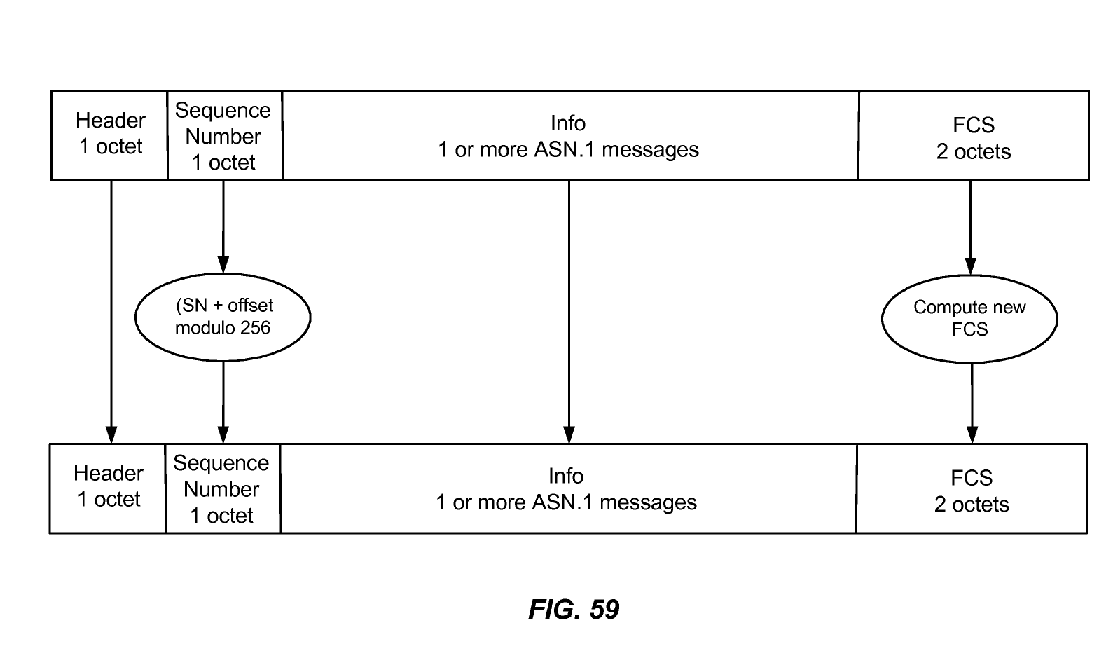

The numbering could be determined by a message from the releasing H.324 device (B2BUA in this case) indicating what the last used SRP number sent and expected were, for both directions. The device could also detect all SRP messages and when it detects a discontinuity associated with the linking, it could then perform the correction. It would be preferable if the mode were enabled by recognition of a state transfer in the call, as this would reduce the possibility of erroneous detection and modification of SRP numbering. The adaptation can be performed by analyzing at an offset into each SRP frame and updating a counter (e.g., a modulo256 counter) that maintains a correct value from the perspective of the receiving terminal. Each frame is then updated to map from what is sent to what is acceptable to receive (in both directions). In addition to modifying the SRP sequence number, the FCS value for the new frame information could also be modified. The CRC can be recalculated over the entire frame, or could be computed in a shortcut fashion given the change in the frame information to modify the CRC. The adaptation is shown in FIG. 59. The transmitting terminal should re-transmit any frames that are not acknowledged through the transition period and maintain the session with minimal disruption.

As SIP-I could be used for the MSC to gateway interface, embodiments of the present invention open up a number of possibilities of continuing the REFER in a SIP signaling domain all the way from the SIP server to the MSCs.

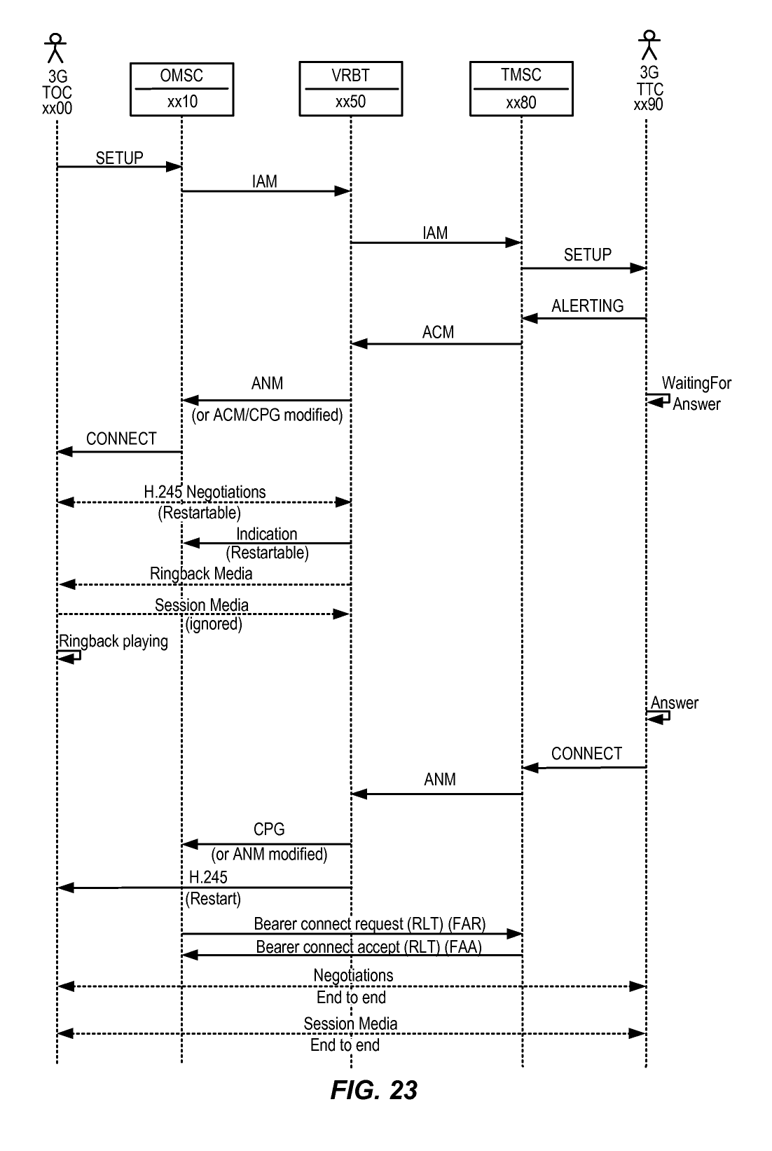

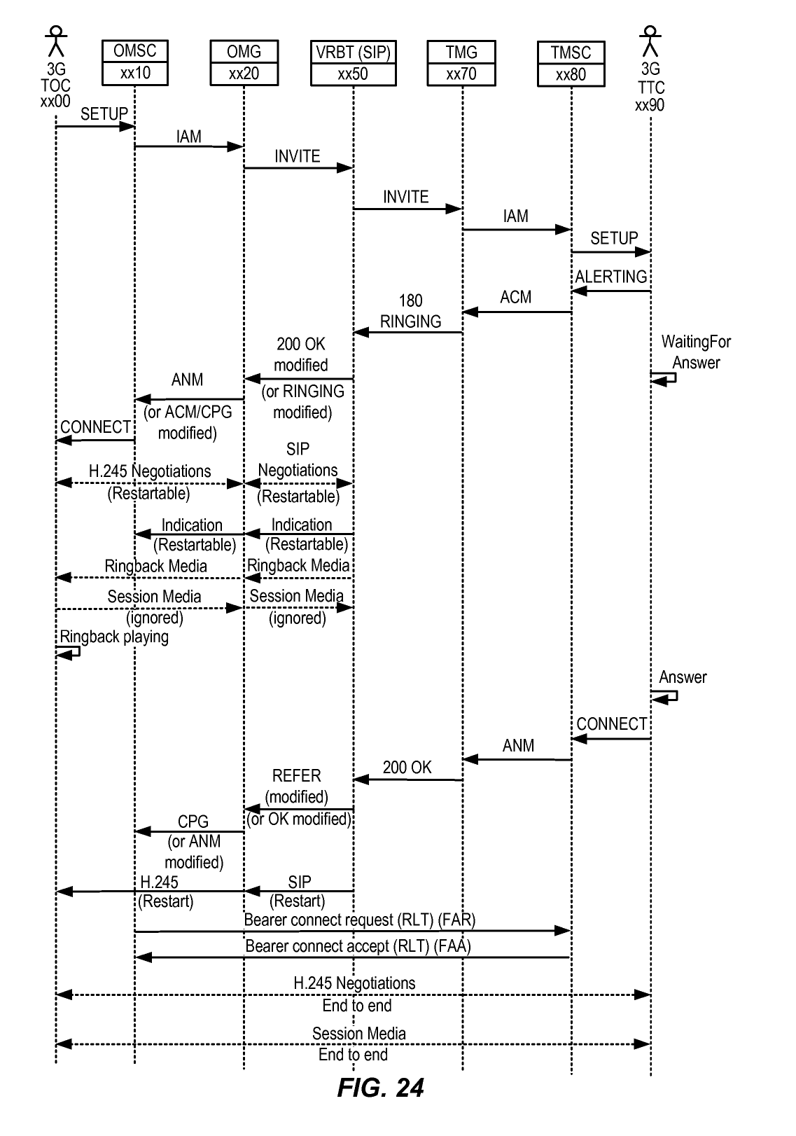

FIG. 23 and FIG. 24 show restart-able sessions according to an embodiment of the present invention. As illustrated in the figures, after the session is collapsed, the bearers are joined at the MSC via a Release Link Trunk (RLT) or similar method such as SIP-I REFER. It would be expected that the session be established between terminals. When this collapsing occurs, the devices, in particular TOC, as TTC, which may not have any session established, perform a partial restart, a full restart, or a seeded restart of the session. In this way, a new session between TOC and TTC can result without the involvement of B2BUA. In the case where either both sessions are up or the TTC negotiations are underway, TTC may be seeded with partial information from the TOC resulting session, then using only partial reset (possibly in conjunction with a session acceleration technique) will allow TTC and TOC to begin communicating extremely quickly and result in a substantially enhanced experience. The seeding may be performed using fast session setup techniques including AFIII techniques (setup parameters in the call signaling), or possibly an AFII/AFIV technique (AFII has setup parameters in an initial H.245 message and AFIV has setup parameters/messages/media transmitted on the bearer). This seeding may be sent from either the network or between the terminals.

It would be recognized that this restarting, and possibly seeding, need not be limited to use at a point where a second terminal is joined after a ringback media clip or announcement is sent to TOC. It could be used many times in a call to a portal where multiple outgoing sessions are established (so that each clip could have optimized codecs). It would also be recognized that this restarting, and possibly seeding, may be applied to only a portion or sub-part of the session, so, for example, if both sessions were up, then a logical channel may be replaced on one of the devices, for instance, the devices could decide that the master's channels will remain into the full session.

FIG. 24 shows one method of indicating the session restart capability and indication through a gateway from H.245, or 3G-324M-based indications to an IP-based indication. The indications may be transferred, for example, as a SIP header or an H.323 capability.

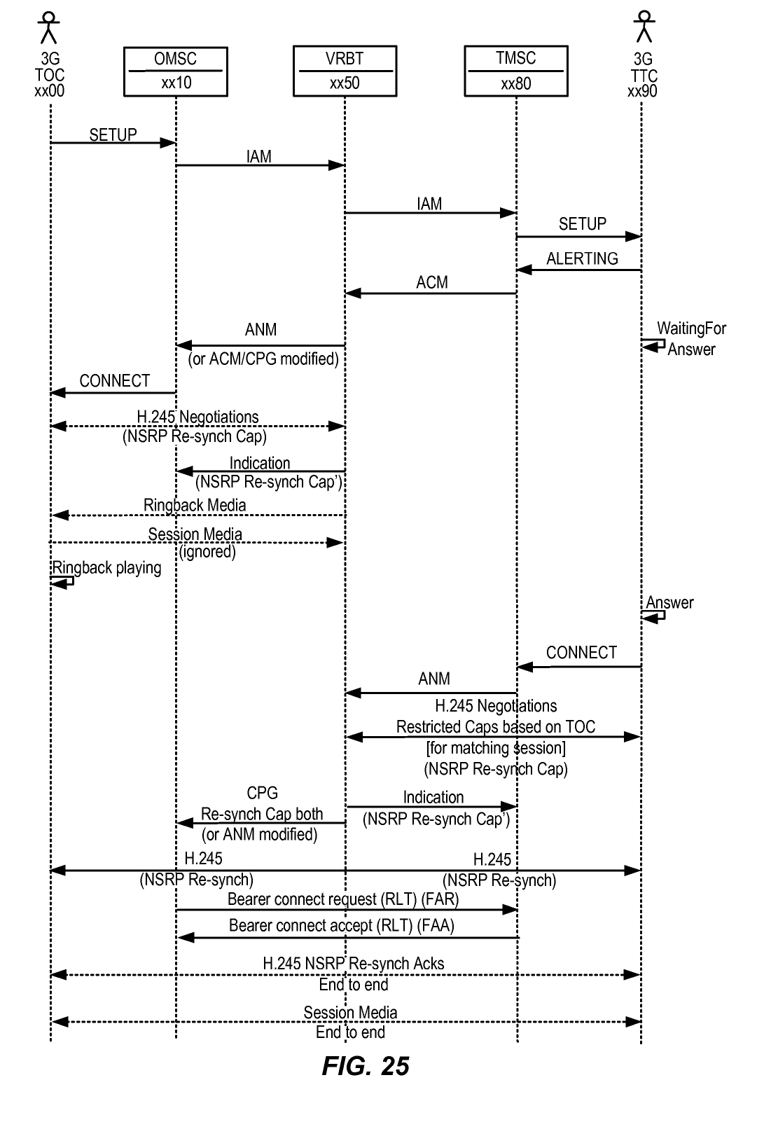

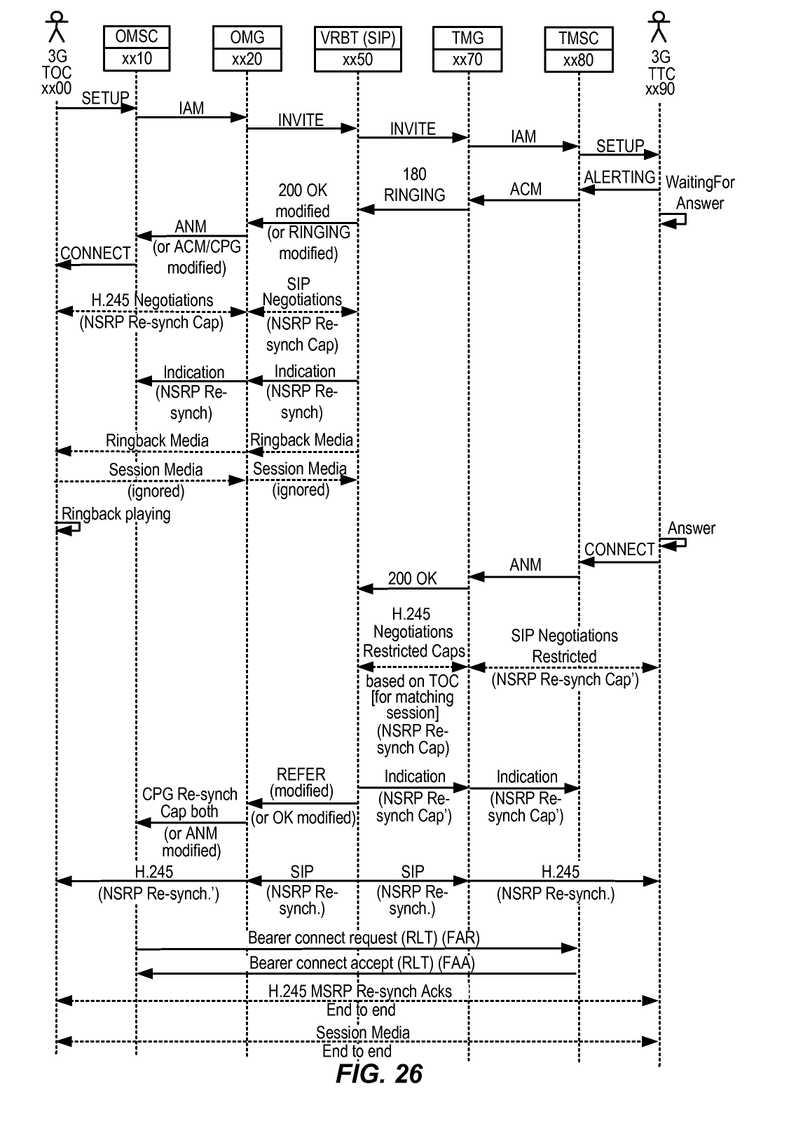

FIG. 25 and FIG. 26 show NSRP re-synchronizing with session capability and characteristic matching performed in VRBT. Here, the synchronization refers to an ability to handle a disjoin in reception of the NSRP messages being received. As many deployed devices do not support this feature, it is preferable to deploy devices that indicate the capability rather than having it assumed, although in homogenous environments this would be possible without indication. The capability in H.245 could be in a GenericCapability message. The MSC also receives an indication that the devices support the re-synch capability. In some applications, the indication would be likely to suggest that the devices support RLT, and the support for resynch of some sort inferred as part of the RLT support.

When the VRBT wishes to join the sessions together, it transmits an indication to the terminals to be ready to receive disjoint sequence numbers, cross connects, via RLT or similar means, and the two terminals re-synch as necessary. The indication may contain an offset to expect, or maybe just to detect the offset and cope. Variants exist in which the capabilities are matched prior to the re-synch, or actually in the re-synch through an update, or by seeding. It is possible to limit handset implementation complexity if the B2BUA agent matches as many characteristics as possible before the joining. This optimization is not necessary if further negotiations are expected, but would still be beneficial to reduce any reconfiguration of the devices that may be required.

FIG. 26 shows one method of indicating the NSRP re-synchronizing capability and indication through a gateway from the H.245 or 3G-324M-based indications to an IP-based indication. It may be transferred, for example, as a SIP header or an H.323 capability. These procedures may only be applied to a portion or sub-part of the session, so, for example, if both sessions were up, then a logical channel may be replaced on one of the devices, for instance, the devices could decide that the master's channels will remain into the full session. This might provide more flexibility to the VRBT/MPS in offering its original service and then allow it to remove itself from the call. The VRBT may also use replacementFor messages and the like to modify the characteristics before the session and alleviate the need for further behavior in the handsets. If only one terminal supports some form of NSRP modification, instead of being made ready for a resynch, the terminal may be primed to appear as identical to the server for its SRP numbering. In this way, a currently deployed/non-supporting device may cope with the joining seamlessly due to the session modifications at the supporting terminal.

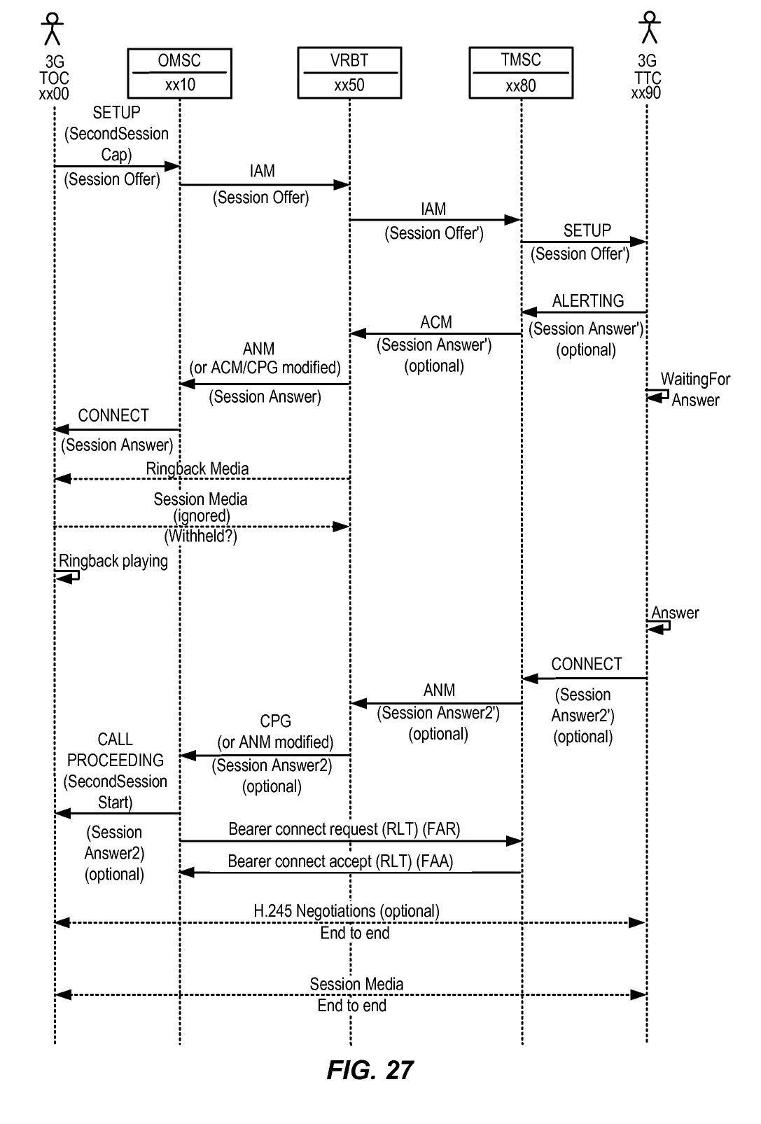

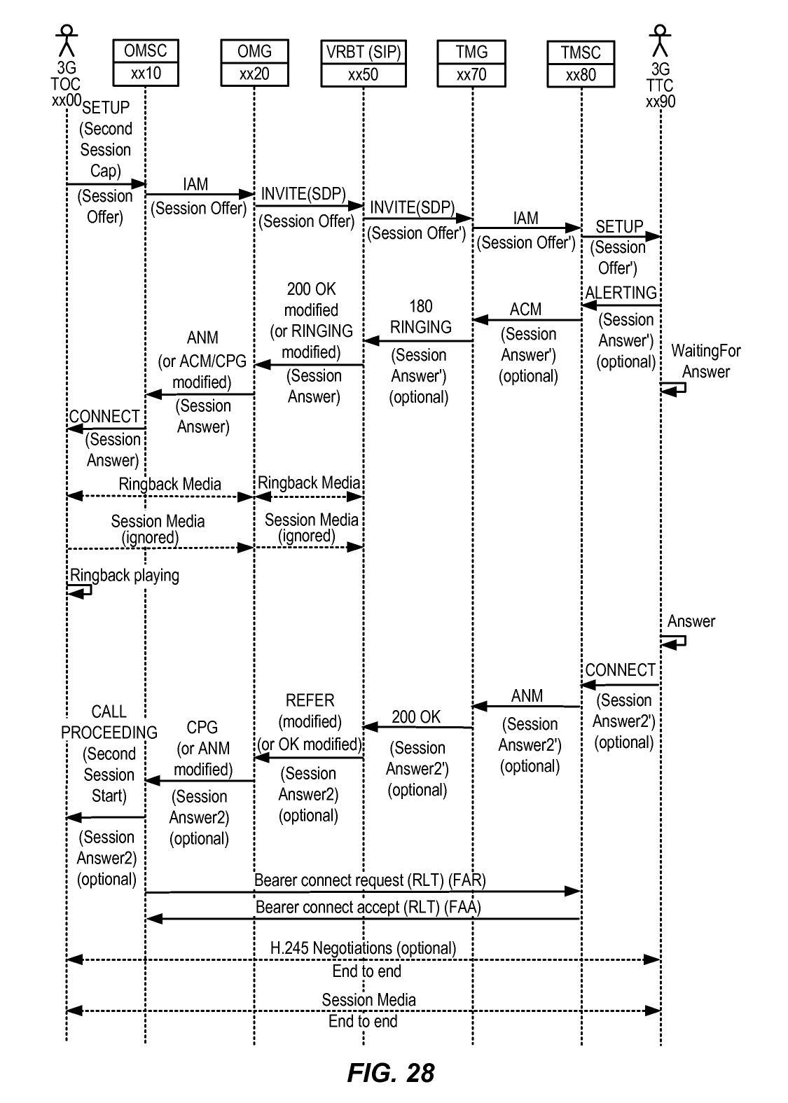

FIG. 27 and FIG. 28 illustrate a way of enhancing Q.931 devices, such as 3G-324M devices, to create an extremely quick negotiated setup of two or more sessions. As illustrated in FIG. 27, an early session includes ringback media and a later session includes session media transmitted between terminals. For example, the early session may be an announcement and the later session may be a premium content. Embodiments are adapted to utilize a session description method similar to that described in the session acceleration technique AnswerFast Type III, as described in co-pending and commonly assigned U.S. Pat. No. 7,139,279, previously referenced. Q.931 encapsulated AF III type messages can be used to negotiate both the session characteristics for early media for the ringback and the normal residual session (i.e., late session) characteristics after an optional session release takes place. Such messages could also be used in replacementFor style messages for the entire session, whereby the entire session is replaced with a session characterized by some AFIII or other negotiations. The second negotiation may only replace subsets of the session also, such as just a logical channel. One of ordinary skill in the art would recognize many variations, modifications, and alternatives.

An offer-answer model can be employed to negotiate preferences with messages transmitted in the Q.931 messages and propagated through any intermediary messaging needed such as ISUP or SIP/H.323. The messages may be included in user-user fields, in other customizable fields, new custom fields, or the like. TOC makes a session offer to both VRBT and TTC, or alternatively for the early session and the late session (as the service need not involve video ringback or a second device). The session offer may be made via media gateways and it is possible that a different offer may be made for each session. For the early session, a response is given that indicates the session characteristics indicated by the VRBT. The response may also contain the response from TTC if it is available at the time. As a result, prior to answering or establishment of the bearer, TOC may be aware of both sessions it will create. TTC may also answer the offer in its CONNECT related messages. The arrival of the CONNECT/ANM related messages allow for the two end points to have a session negotiated on a newly RLTd bearer that allows VRBT to remove itself from the loop after delivering the VRBT media.

Many variants are possible, including an indication that will limit both early and later sessions to having the same characteristics to alleviate terminal reconfiguration. It is also possible that VRBT modifies or removes one or more of the offers or responses for other purposes. This mechanism may also be used for announcements with no relation to a second, TTC, terminal. It should also be noted that TTC need not support receiving both an early and late session for negotiation and may simply receive a single AFIII style or other negotiation for the end-to-end session.

When TOC receives a CONNECT with a session answer from VRBT, the session is created (in a style similar to AnswerFast III) and the arbitrary media session is created, allowing, for example, media ringback or announcement streaming. It is also possible that a second answer comes through independently of the first, but dependent on a TTC related event such as the CONNECT message that indicated the second session answered (it may propagate via call progress or other messages). This will remove the need to couple an answer/CONNECT from TTC to the establishment of the original ringback for the TOC early media session, allowing for longer ringback media sessions. It is also possible when using the call signaling negotiation method (AFIII-like) for the characteristics of the media to TOC in the ringing period, or free charged period, to allow for only a unidirectional connection of the bearer as in-band negotiations are not necessary if the negotiations have been conducted over call-signaling. The bidirectional bearer could then be established only on indication that either the far end has answered, or that a different charging related event has occurred. This can help avoid fraudulent use of the reverse channel but would also limit the interactivity of the user of TOC (as user inputs are sent in-band, if the value of maintaining no reverse bearer were deemed necessary though then some form of inputs provided over the call signaling channel such user-user information elements or others would be possible). Some embodiments will entail additional modifications in the handset.

The end-to-end session that is to be established after TTC connects may come through as a second message, which is propagated through VRBT and OMSC to TOC. In the illustrated flow, a CALL PROCEEDING message is used to transfer the information back to TOC. Such a message is one possibility, but custom messages as well as a modification to use a CONNECT in this scenario are also possible. In embodiments in which the 3G-324M devices are modified, the idea of pre-CONNECT media is usually preferred. In such applications, different messages may be used at subsequent times, for example, using a CALL PROCEEDING message in order to allow inter-operability with older MSC systems.

The sessions are created extremely quickly allowing for a seamless connection from the arbitrary ringback media to the session media. It is also of note that it is not necessary to limit the link release to occurring at the time of TTC connection. Link release could also be triggered after an arbitrary period via a different indication, possibly to both TOC and TTC in a different message, for example in one or more CPG messages. It should be noted that the H.245 negotiations illustrated in FIG. 27 may not be needed if the capabilities expressed in the AF III messages are sufficient to establish the second session.

FIG. 28 shows one method of propagating the early and late session messages through a gateway from the H.245, or 3G-324M-based indications to an IP-based indication. It may be transferred, for example, as a SIP header, an SDP, or an H.323 capability. In one example, the early media session-disposition indicators would be used. Session Offer and Session Answer here could be an early media disposed session and Session Offer and Session Answer2 could be the (late) session.

In all these examples showing reduced involvement as well as other implementations, the SIP VRBT server could add or remove information to or from messages passing through the server indicate if the A-party should be ready to execute a new session with the B-party on its CONNECT (or other message) being propagated and received. In this way, the option to release the link for the call may be at the discretion of the VRBT server, as the server may wish to remain in the call to add other value added services by processing the media, such as avatars and the like as discussed earlier.

Video Announcement/Ringback 3G-324M and SIP Server Embodiment (MSC Modification):

An exemplary embodiment will now be described in which a modification in an MSC of a 3G-324M network is made to allow for charging to be conducted in one manner suitable for a video ringback or service/network announcement service. As will be evident to one of skill in the art, this example can be extended to other possible variations and is not intended to limit the scope of embodiments of the present invention.

The network in this example includes MSC(s), media gateway(s), and SIP application server(s). Although the equipment is indicated as separate entities, one or all may be co-located in the same logical or physical entity. For example, a single media gateway may be employed in the service with no IP-based server. Alternatively, other IP-based protocols (e.g., H.323) may be employed on the server.

In this exemplary billing scenario, the subscriber to the ringback service can be the called party (TTC or OTTC), which can be charged a periodic (e.g., monthly) fee. Other billing arrangements can be utilized for use of the service, for example, a per-content fee or a per-call fee, or on a time-used or a data-sent basis. Thus, ringback media can be provided to the caller at the alerting phase of a call. If the called party answers, the service is such that an end-to-end call will be setup in accordance with procedures used in 3G-324M videotelephony. The charging of the “normal” call will be provided in accordance with the billing model of the service provider (e.g., with the caller paying or both the caller and callee paying).

One or more modifications are made to the MSC to allow the MSC to connect the 3G-324M handset to an arbitrary media session in response to a particular message, such as the far ends alerting indication. As illustrated, the MSC will transmit a Q.931 CONNECT (instead of an ALERTING) upon receipt of an ACM (or CPG) with a particular message (or in a particular manner or configuration). The MSC will also make the bearer available for bidirectional session establishment via 3G-324M negotiations (or through accelerated setup negotiation procedures). The bidirectional availability of the bearer is used to establish the H.324 sessions using H.324's available in-band session setup negotiation procedures. The MSC will not send a billing message associated with this CONNECT, but instead will wait for an ANM to be received, indicating the called party has answered and the “normal” session has begun.

The modifications to the ANM or CPG in this example are in the in-band information (IBI) field, indicating that information/pattern is available (see Q.763 Clause 3.37). The IBI field is in the optional backward call indicator, optional BCI, not the “required” BCI although variants are possible. This particular implementation using Optional BCI IBI flag is non-limiting and a custom message, or another standard field used in a custom manner is also possible. One variant might be to use the Event Information (see Q.763 Clause 3.21) field's “in-band information or an appropriate pattern is now available” indications. A second variant might be to use the APM message.

A further variant might be to use an ISUP transported Q.931/24.008 message that has a progress indicator field (e.g., using the progress indicator field and then optionally using one of “in-band information or appropriate pattern is now available,” or “call is not end to-end ISDN; further call progress information may be available in-band.” This alternative would seem more appropriate in the end-to-end case where the pertinent aspects of the Q.931/24.008 message are transmitted to TOC, which would use an ability at TOC to interpret these aspects of the message. This Q.931 variant might also be directly employed, not tunneled in ISUP, if the connection to an MSC or intermediary was ISDN or similar (i.e., if the connection was direct, the gateway might send a CONNECT immediately and update its CDRs). Alternatively, there are options at the MSC that could also cause the early CONNECT at the point where an Alerting indicating ACM or CPG is being sent from the gateway. Variations would be available such as differing modifications of either the CPG or ACM message, the modification being in a previous message and the behavior being different even though the arriving message could be considered normal, or the combination of these techniques (e.g., sending CPG after an ACM in a setup expecting either no CPGs; CPGs only before the ACM; or the opposite of the illustrated example, with a CPG sent before the ACM). Other factors such as configuration settings, equipment identification, or service identification in an earlier message, number analysis, the presence of SIP early media, or authorized early media (http://tools.ietf.org/html/draft-ejzak-sipping-p-em-auth-03), also exist to possibly elicit the early CONNECT.

Modifications to SIP headers may be performed to allow a media gateway to create these ISUP messages with minimal impact on service levels. In this way, the media gateway may still be able to operate as a 3G-324M to SIP/H.323/RTSP video telephony gateway, as well as an arbitrary media server with no specific provisioning for this service.

It should be noted that many of the supported and requested optional modes of operation are not needed to implement embodiments of the present invention, but can be used in order to allow the devices involved, especially the SIP to ISUP/H.324 media gateway, to be capable of offering standard SIP to ISUP/H.324 services concurrently, for example, videotelephony and portal or streaming services. Many other variants and interfaces are possible, including differently identifying the capabilities, using proprietary codecs, or employing and/or modifying existing SIP RFC usages.

FIG. 29 shows a session with ringback media and a charging method according to an embodiment of the present invention. The SIP invites (030 and 040) are sendonly, which allows for better control over the media establishment at a later point in the flow (see 170 and 330). This use of sendonly SIP invites is optional but creates a better user experience by controlling media transmissions to begin at a point when a client can render the media, which avoids temporal clipping of the start of a transmission. Additionally, it is not necessary to use sendonly and sendrecv messages in particular, and instead proprietary messages could be introduced. Moreover, early media particular messages, such as early media disposition and the like, can be used to separately identify and negotiate the early and later sessions.

OMG invite supports PRACK (100rel) or provisional acknowledgment. This feature allows the OMG to continue to be used as a multipurpose media gateway without specific provisioning. It is likely that if the OMG required PRACK on all outgoing connections, then it would become less usable. As illustrated, the PVRBT accepts and uses PRACK on the invite and uses PRACK in its INVITE. The PVRBT, or the gateway, might behave differently if it recognized it were rendering a different service than this described service, through number analysis or the like. PRACK is used in this illustrated embodiment on account of several key provisional responses that arrive in the call flow and need to be delivered reliably (an example is the RINGING at 090). The service would still operate without PRACK, but with PRACK it has increased reliability and the potential for errors, and likelihood of a failure to deliver ringback media, is reduced.

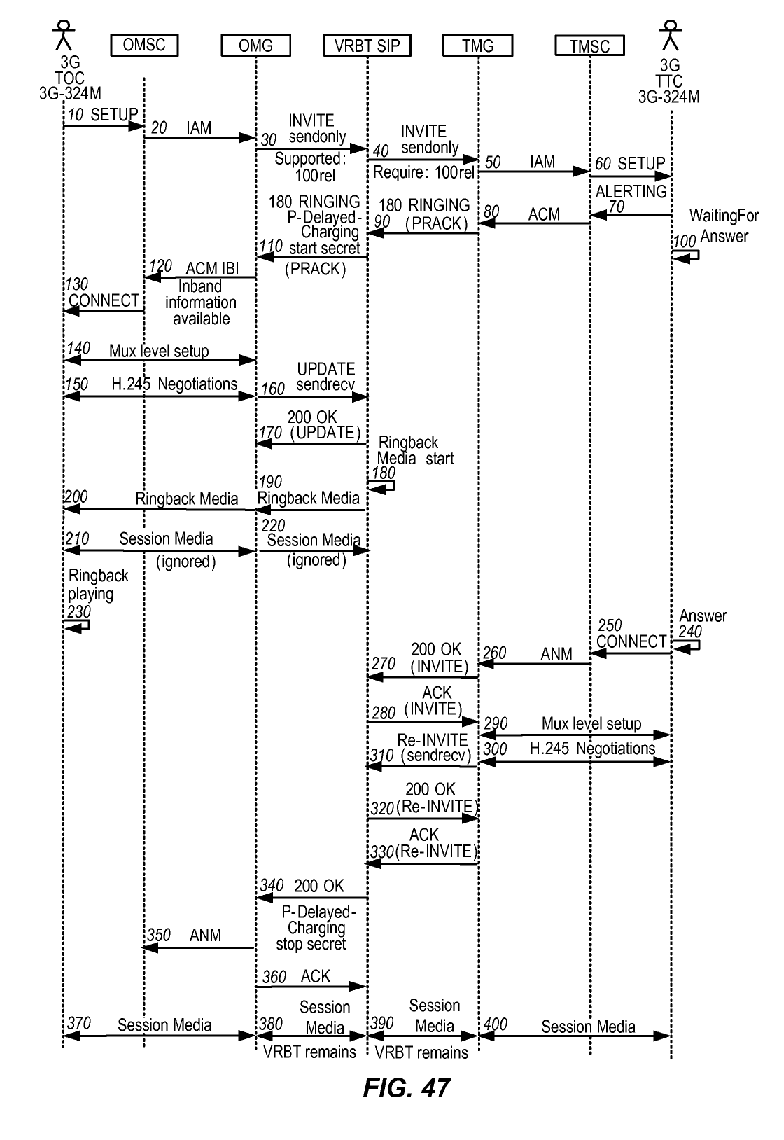

The signaling propagates to TTC and results in an ALERTING indication (and a late ACM indicating the alerting), which propagates back to VRBT as a RINGING (090). After receiving the RINGING, the VRBT server determines that it will play a media ringback to TOC. Since the VRBT server desires to connect a media session to TOC, it sends a 200 OK (110). In a normal flow, this message would be a RINGING that would result in an ALERTING being transmitted to TOC. The 200 OK is used for gateway simplicity as it avoids a necessity to employ SIP UPDATE messages in the initial INVITE negotiations. The 200 OK also helps with the service logic, as the 3G-324M device is only capable of a single session that is established following the 200 OK. If SIP early media was used, the early and late session would generally require slightly differing treatments. As a result, the 200 OK maps the single session of 3G-324M back into the SIP domain. Another approach is to use SIP early media as discussed in relation to FIG. 47.

The originating media gateway (OMG) accepts a SIP proprietary header in the 200 OK and recognizes that it should emit a delayed charging indication to the ISUP side (in an ACM 120 in this flow) and ready itself for session establishment. In the illustrated embodiment, a 200 OK is used to simplify the logic used in establishing the 3G-324M session, however RINGING with a custom message could also be used in conjunction with SIP UPDATEs and SIP early media to achieve the same effect. It is also possible to achieve the same logic by the simple presence of early media assuming it is from a trusted source. Authorization techniques for SIP early media are described in the literature, for example http://tools.ietf.org/html/draft-ejzak-sipping-p-em-auth-03. For a provisioned service, it is possible that the SIP messages are not required, but such behavior is beneficial for the media gateway to offer concurrent services.

The proprietary modification in this example is a SIP header with form P-Delayed-Charging <start/end><shared secret><start>, which is used to indicate the start of the delayed charging period and causes an ISUP ACM (or CPG) with ISUP delayed charging indicated. <end> is used to trigger the end of the free, or uncharged, period, and arrives at the OMG in either a SIP ReINVITE or a SIP REFER. The ReINVITE may be unchanged from a previous ReINVITE, except for the header, so as to have no impact on call state. <shared secret> offers basic control over access (possibly a hash of a configured value and/or the call-ID or IP addresses) and is intended to provide simple protection against a SIP client sending a delayed charging flag with no authentication.

The P-Delayed-Charging header in SIP message (e.g., 200 OK or 180 RINGING) indicates to the media gateway that special call handling is to be used for the call. The header is also included in a subsequent message (e.g., ReINVITE or UPDATE) to indicate the end of special handling. As an example, it may have one of the following formats:
P-Delayed-Charging: action=start
P-Delayed-Charging: action=start; nonce=<nonce_value>;auth-digest=<digest>
P-Delayed-Charging: action=stop

The action parameter is always required in some embodiments. The value “start” indicates to the MGW that video ring-back has been invoked for this call. It triggers an indication from the MGW to the MSC that an early connection with delayed billing is desired. The “stop” value indicates to the MGW that the call has been connected to the callee, and that VRBT service has terminated. The MGW will then notify the MSC that billing for the call may begin.

Since the header described above may delay billing for a call, there is a potential for fraud. An optional security digest may be supplied to provide some assurance that the request is initiated by an authorized VRBT server. To invoke this security, the optional “nonce” and “authdigest” parameters are supplied in the above example. The value of the “nonce” parameter is a quoted hexadecimal string of a random number generated by the VRBT server and is preferably unique over space and time. The value of the “auth-digest” parameter is a quoted hexadecimal string of an MD5 digest of the concatenation of a password, the nonce, and some constant strings. The exact format is: H(H(MGW:<mgw-uri>:<password>):<nonce>:H(200:<vrbt-uri>)).

In this definition, the H( ) function is the hexadecimal string result of an MD5 digest of the function parameter; <mgw-uri> is the MGW domain name, which will be configured at the VRBT server; <password> is a secret password shared between the VRBT server and the MGW, and is configured on both systems; <nonce> is the value of the “nonce” parameter generated by the server; and <vrbt-uri> is the entire URI supplied in the Contact header of the 200 OK message. In the illustrated example, the string must not contain any whitespace (other than any embedded in the password) or extra trailing characters such as line feeds.

The MD5 digest is pre-applied to the realm and password so that the server and the MGW can compute the digest at configuration time. As a result, the password is not stored in cleartext.

For example, an exemplary message string is:

P-Delayed-Charging:
action=start;nonce=“dcd98b7102dd2f0e8b11d0f600bfb0c093”; auth-digest=“2720b12a2961cec5c2b73a1976663cee”

In this example, the MGW URI is “dilithiumnetworks.com,” the configured password is “DTG2000password,” and the contact-uri is “sip:vrbtserver.com.” The computed MD5 checksum for the realm password is based upon the string:
MGW:dilithiumnetworks.com:DTG2000password

This yields an MD5 string like 5a1145e3cf90a75bedb8125d2c3f3f98. The computed contact digest is based upon the string:
200:sip:vrbtserver.com

This yields the MD5 string fdf44fe6b64a63db3452100c0cf61087. Finally, the “authdigest” is computed based upon the following string, which is the concatenation of the two MD5 checksums and the nonce, with no embedded white space or line-feeds:
5a1145e3cf90a75bedb8125d2c3f3f98:dcd98b7102dd2f0e8b11d0f600bfb0c093:fdf44fe6b64a63db3452100c0cf61087

This results in the final value 2720b12a2961cec5c2b73a1976663cee supplied in the “auth-digest” parameter. Where possible, the process described above follows the conventions of the HTTP digest authorization (RFC2617, sec. 3.2). However, since the context is different, and since the authorization is unidirectional, rather than challenge/response, the following changes have been made in this embodiment:
The username is hardcoded to “MGW” but may be configurable.
The realm is configured as the MGW domain name.
The method name is replaced by the response code (200).
The request-uri is replaced with the contact-uri.
All the remaining parameters for the mechanism (qop, algorithm, stale, opaque) are not relevant and so are not used.

Fraud protection may be delivered by enforcement of the ANM timeout on the OMSC. In this way, if a SIP client attempts to establish a free session with this mechanism and never sends the charge start, some action can be taken. Possible actions include either beginning a charging process or call termination.

Upon receiving the ACM with delayed charging message, IBI (120) in FIG. 29 (setting the optional backward call indicator's In-Band-Indicator), the modified originating MSC (OMSC) sends a CONNECT (140) instead of RINGING and also connects the bearer to the OMG and enables the session from TOC to VRBT.

Normal (or accelerated) 3G-324M negotiation is used to establish a session from TOC to OMG (150 and 160). After the logical channels and hence the media path are available, a message indicating the availability is sent to the VRBT. As illustrated in FIG. 29, a ReINVITE modifying the session to sendrecv (170) is sent. This message may also be used to indicate a capabilities preference based on the media codecs employed on the 3G-324M side of the connection. An UPDATE could be used for the same purpose in an alternative SIP flow. This sendrecv/update mechanism could also be indicated in various other ways including proprietary messages and or using SIP preconditions. It is not necessary that the message indicating the path is available is always used, but it helps to ensure that media transmitted to TOC is transmitted without clipping (e.g., not missing the first 5 seconds of a purchased clip). For example, a gateway employing the media cutover features attributed to the B2BUA/VRBT could ensure media quality by starting with an intra coded frame. Generally, it could not avoid the premature starting of a clip unless it had more direct control of the clip (e.g., RTSP PLAY).

VRBT can now transmit media to TOC for a media clip. This media is shown to be coming via a SIP (210) session, but it may also come from other sources. Such sources include IP sources using RTSP, which may be directly connected to OMG, for example, with a control interface between OMG and VRBT, or from another controller controlling both OMG and VRBT.

The uplink media (230,240) is ignored at VRBT, as a session in 3G-324M is typically created bidirectionally. It should be noted that the server may decide to create channels unidirectionally and open reverse channels when the end-to-end connection is being established. However many deployed devices will not work in this scenario, so in general, a bidirectional session is created and the media is ignored. It is also possible to implement an interface feature that prevents any uplink session media from passing from OMG to VRBT until another message, probably the ReINVITE with delayed charging, is received. This is advantageous with respect to bandwidth and reduces the possibility of fraudulent bidirectional use. This process may not always be preferable, especially if the session is interactive and the uplink information has value to VRBT (for example DTMF/UII indications for menu navigations or speaker identification/verification). Some portion or sub-part of the session may be allowed through but not a full session media, for example, only H.245/SIP UII messages with no media.

At this point, TTC is alerting and awaiting answer (100). Eventually TTC answers (260) and the TTC side session connects, the session setup may be modified in some part, such as expressed capabilities, or order of capabilities, based on the capabilities that have been expressed on the TOC interface into the VRBT. This may allow the VRBT to operate in a non-transcoding fashion and also allow an easier release of the element from the call if desired. In the case where transcoding would turn out to be unavoidable, then quality can be maintained through the capability preference order. Additional description related to these techniques is provided in relation to the discussion of FIGS. 18A-18D. The terminating media gateway (TMG) also sends a ReINVITE sendrecv (330) when logical channels are available to TTC. This message may be used to indicate a preference of capabilities based on the media codecs employed on the 3G-324M side of the connection. The receipt of the ReINVITE sendrecv is the indication that the delayed charging message can be sent toward TOC. It should be noted that the receipt of the ReINVITE is not dependent on TOC. While the ReINVITE is applicable to the illustrated example, other mechanisms could be used such as SIP preconditions.

Both TOC and TTC are now joined to VRBT and it is free to re-transmit the media and session messages between them. As illustrated, before doing so, or at the same time, the billing of the call connection should be indicated to the OMSC in accordance with the enabling of a conventional end-to-end call. Media processed variants are possible and could be charged appropriately.

The use of SIP ReINVITES with sendrecv provide an opportunity to modify capabilities in several parts of the session in order to allow the system to operate with the same codecs, or as similar codecs as possible, throughout the entire system. This is beneficial if it is desired to use a non-transcoding media gateway and/or a non-transcoding VRBT application server.

This hinting may be proprietary (especially in the SIP domain), but a simple method to create the same effect is to order preferences in the ReINVITE with the order being indicative of some ease of transcoding according to the element. As an example, a media transcoding gateway might offer a selected codec from one side as its first preference to the other side. This may have the effect of increasing the likelihood that a single codec is used through the entire system and less media processing may be required.

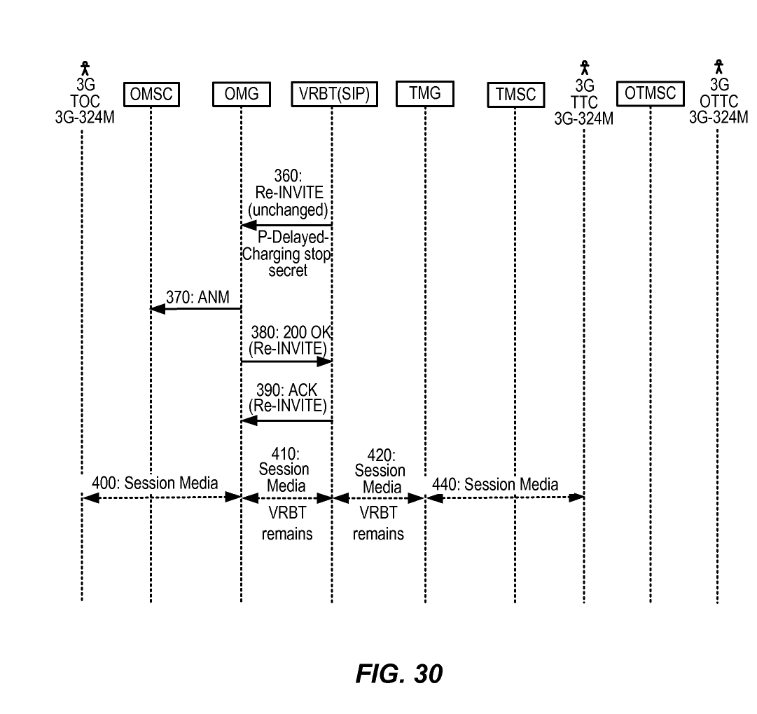

FIG. 30 illustrates a charge indication as an unchanged (or empty) ReINVITE with the P-Delayed-Charging stop indicator according to an embodiment of the present invention. This is converted to an ISUP ANM by the OMG and used by the MSC to recognize the start of a chargeable period.

In an alternative embodiment, the decision to end the free billing period may be associated with the same P-Delayed-Charging header but in a 200 OK message (e.g., using SIP early media). The decision to send the ANM might also be made merely on the presence of a message (without any particular modifications), for example either the 200 OK or the ReINVITE.

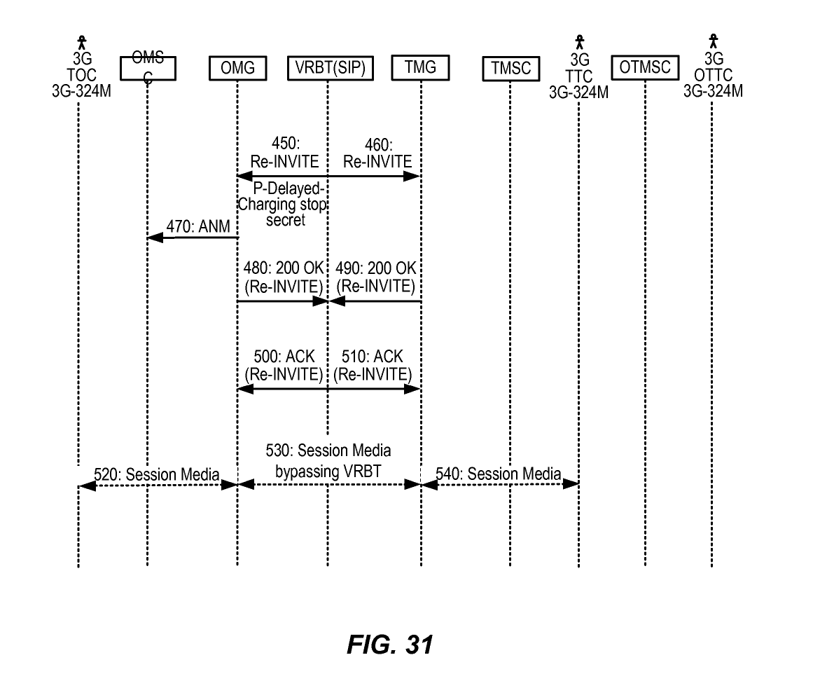

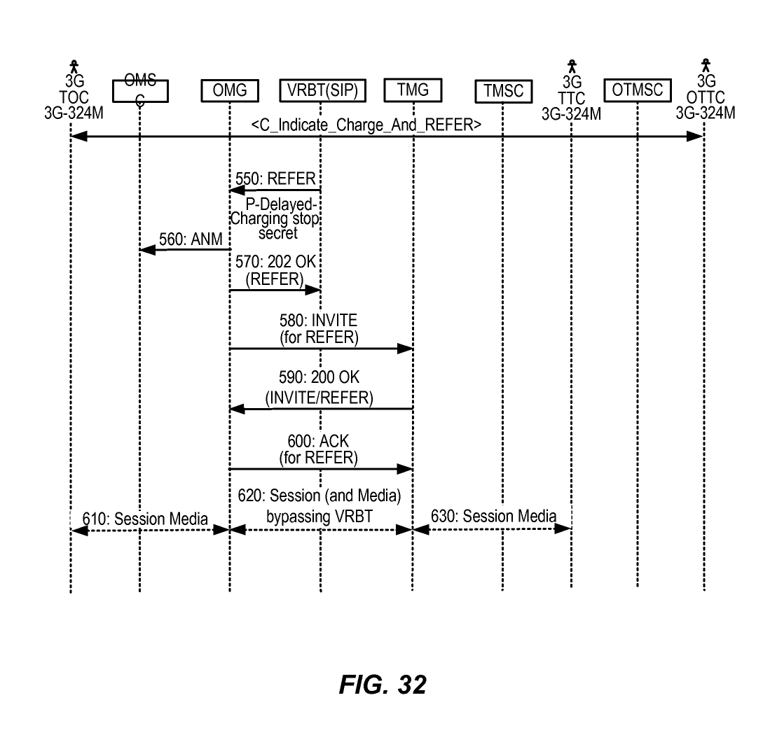

FIG. 31 and FIG. 32 show variations of this charging process in which session characteristics are changed via SIP messages to reduce the involvement of the VRBT element. A ReINVITE message can remove the VRBT from the media plane by redirecting the RTP ports from the VRBT server to the gateways. Accordingly, the gateways then transmit traffic directly between them. The VRBT retains a position in the signaling path and may offer subsequent services. A REFER message can remove the VRBT from the media and signaling plane by referring the entire session to the gateways.

The behavior of causing an early CONNECT, or delayed charging, from the SIP interface could use a mechanism other than that shown with a P-Delayed-Charging. Instead various other SIP, or other protocol, methods could be used. For example, P-Early-Media, which can also server to manage the UPDATES, could be used. In an authorized network, the presence of any authorized early media at the gateway could be sufficient to cause the early CONNECT to be emitted from the MSC.

The session can now be connected end-to-end and the charging applied can charge as if this is a normal call (or as a processed call if additional processing is to occur and differing billing is appropriate). Of special consideration in some embodiments are issues related to media quality and ensuring the first end-to-end session media coincides with a video I-frame. A videoFastUpdate request may be sent in both directions to result in session media coinciding with a video I-frame. If the media gateways involved in the session are capable of local generation of I-frames in response to events (described more fully in co-pending and commonly assigned U.S. patent application Ser. No. 10/762,829, filed Jan. 21, 2004, which is hereby incorporated by reference for all purposes), the session cutover and user experience may be enhanced.

The media gateway and VRBT client are also provided with some mutual capabilities to ensure the end-to-end session is not limited. One example is the use of RFC2833 to convert H.245/UII messages to SIP based signals, and back again to allow end-to-end communication. Other end-to-end signals such as videoTemporalSpatialTradeoff and possibly videoFastUpdate can also be mapped via SIP to ensure end-to-end quality. In some cases, it may be necessary to have a proprietary tunneling of the messages through the SIP domain.

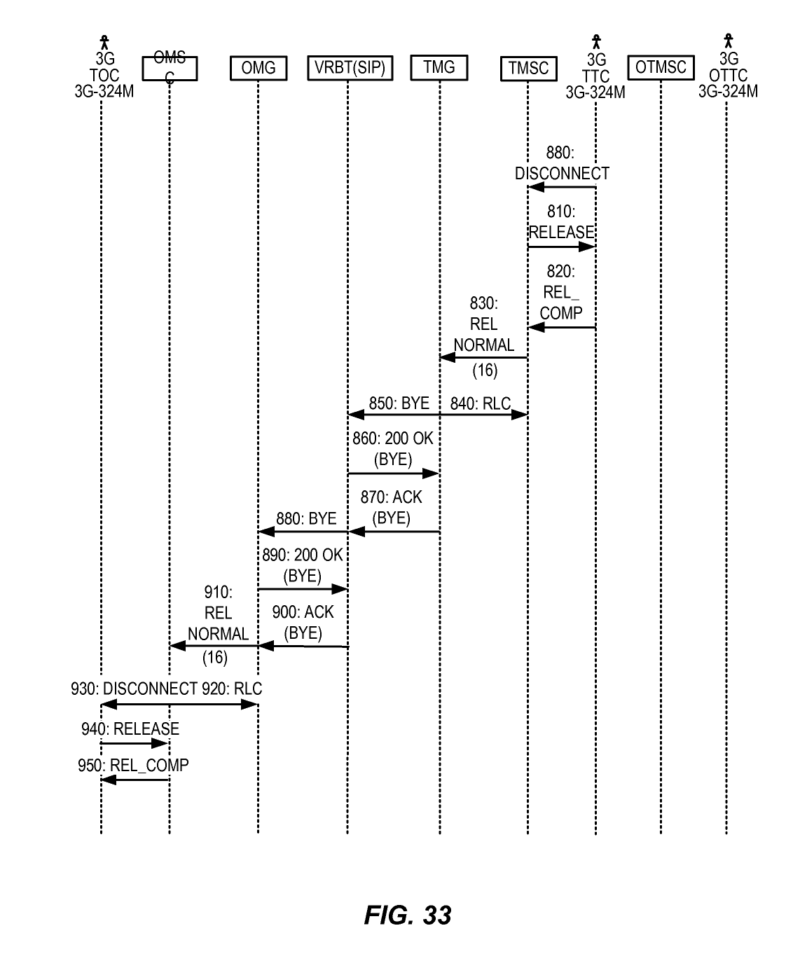

Teardown of the call can happen in either direction and is shown in FIG. 33 for an exemplary direction. The call clearance code can optionally be transmitted through the SIP network from one end to the other as desired for a service. ISUP messages may also be encapsulated for propagation through SIP messages and the VRBT system.

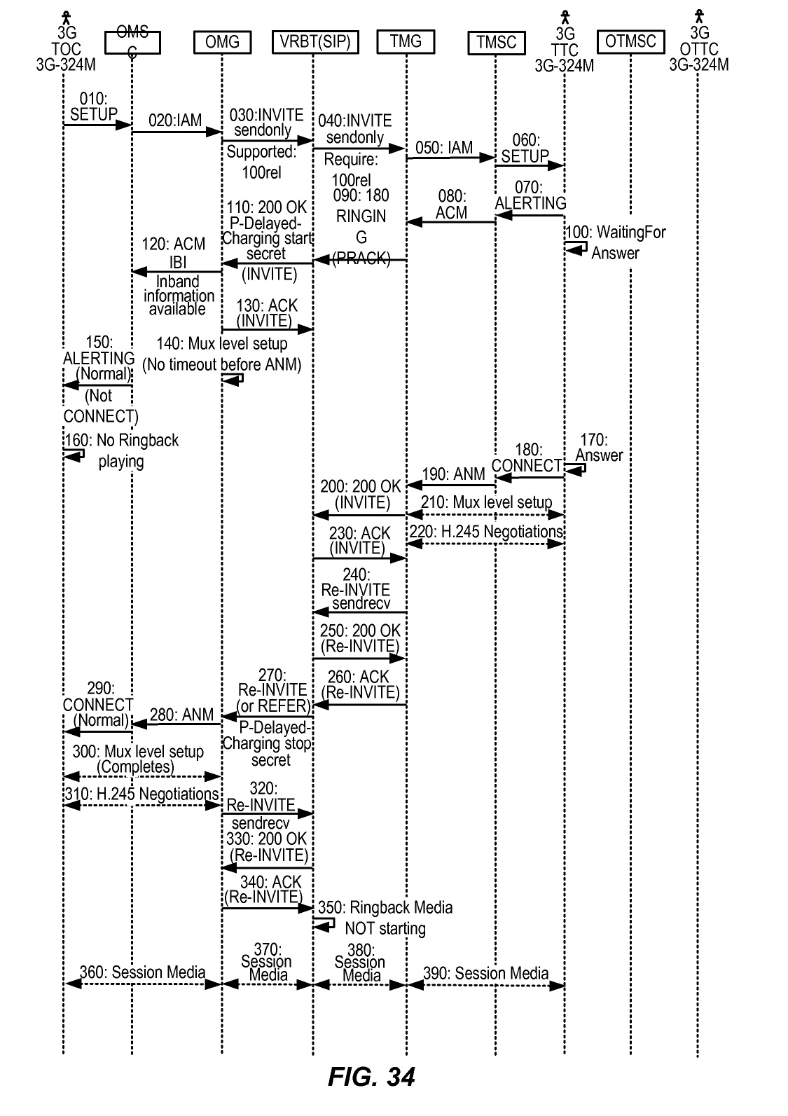

FIG. 34 shows the call flow if the originating MSC does not support the delayed charging feature. As illustrated, FIG. 34 demonstrates that embodiments of the present invention are able to interoperate with networks not supporting the features described herein or amongst differing MSCs in a single network. Embodiments of the present invention result in no display of ringback media to TOC, but charging is still conducted routinely, as though for a normal call. The ACM with special IBI (120) is not interpreted specially by a non-modified OMSC, and is mapped to an ALERTING (150) instead of a CONNECT (as used for connecting a session for ringback media). This results in the normal, non-ringback, media session setup, with end-to-end call setup coming after TTC answers (170 through to 200 and finally 350).

The TTC side ReINVITE with sendrecv causes the transmission of the delayed charging SIP message towards OMG. It should be noted that the VRBT does not need to behave differently in this situation in comparison to the normal situation. The lack of a TOC CONNECT in response to the 200 OK (110) enables the conventional non-ringback behavior.

The OMG is prepared in embodiments to set up a session as soon as it transmits an ISUP message in response to receiving a message, such as a SIP message, for example, 200 OK, with delayed charging (110). Accordingly, the OMG is prepared to attempt to establish a session that may not occur at the earliest time possible. The OMG is therefore ready to accept a session immediately, at the point in time shown as mux level setup (140). This is not limited to mobile level setup, but is recognized as session setup as decided by other acceleration techniques. If at mux level setup (140) no bearer connection occurs, then the VRBT operates in a way that allows it to handle this situation. One such way is to not begin its session setup timeout timers until the eventual CONNECT (290), in which case, the session would be established without timeouts prior to receiving or transmitting a session answer indication (the removal of timers is appropriate as it is possible that the terminal terminating the call does not answer for a period of say 30 seconds, which would cause a failure by timeout of a session establishment process). As an example, the sending of an ANM to the MSC might start more “normal” behavior. If the presence of the bearer and data upon the bearer indicate beyond doubt that the TOC is involved, then some session timeouts could be used/re-instated to enhance failure detection. For example, all normal timers could simply not be started until a message is received from the terminal originating the call, making it clear that the bearer has connected. Alternatively, timers may be started, but their timing out not used to teardown a call. Furthermore, if a timer is associated with a timeout count, then the counter may be artificially high to avoid call abandonment. The call flow illustrated in FIG. 34 eventually results in a ML setup (300), or accelerated session setup, for the TOC session, when TOC and TMG can communicate.

If TTC is connected before TOC, the VRBT can make a decision to not play ringback media (360), since it may be more important to establish the end-to-end session. On the other hand, if the streaming media is not just for entertainment, but is an informational message, a cautionary message, a network announcement, or an advertisement as agreed to in a subscription agreement, then the media could still be played to the TOC.

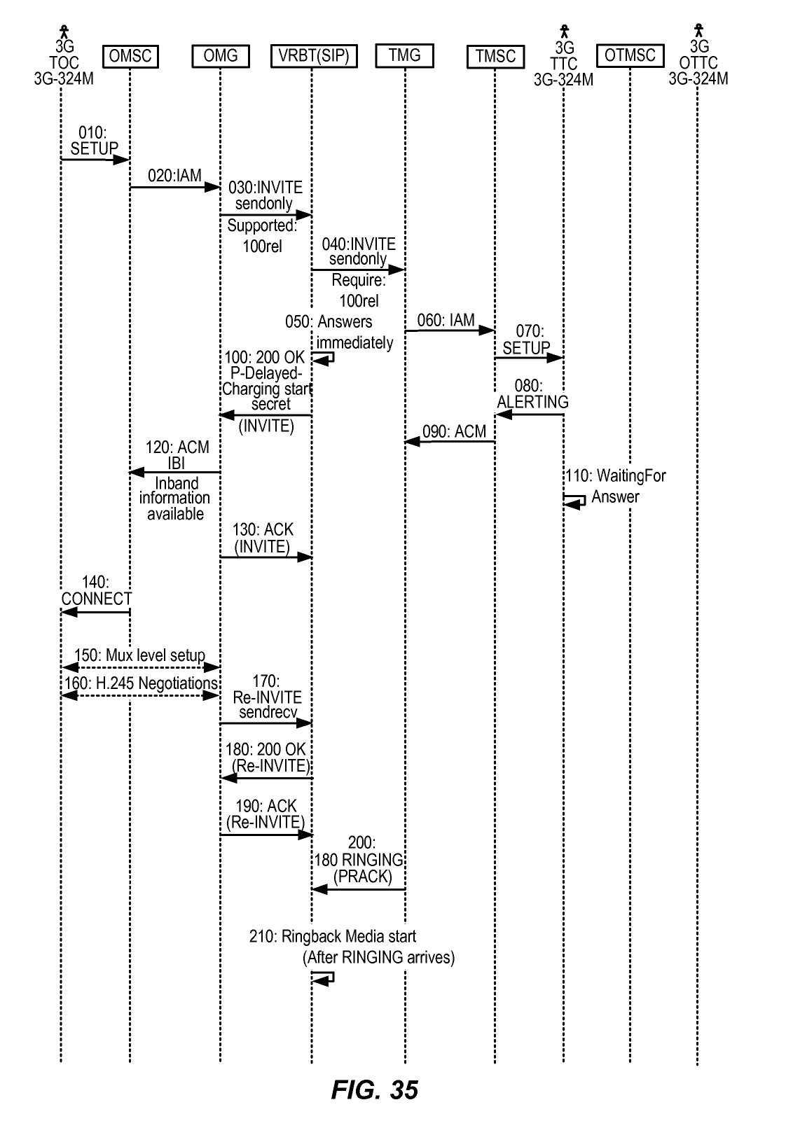

Conventional session setup in 3G-324M is slow, and paging of TTC is also slow, so waiting for an ALERTING to propagate back before allowing a CONNECT to be sent to TOC can substantially reduce the period of time available for a media ringback (or other media) to be sent. Accordingly, embodiments of the present invention provide for a modification, illustrated in FIG. 35, in which the VRBT server answers the call from TOC immediately upon receiving it (50 and 100) with no dependence on the IAM (060) going out to TTC. Alternatively, the VRBT could establish early media instead of answering to produce the same result. This establishes the session to TOC substantially sooner than otherwise would have occurred (if an alerting status indication was waited upon). It also allows the playback of any media to TOC, including ringback media, or an announcement, even before an indication that TTC is ALERTING has been received (media can be sent after 170-190, but before 200). It is also possible to use the early ACM to trigger the answer. From a service perspective, it makes sense to only send non-ringback media, e.g. advertising or other media, before the RINGING indication arrives (200) as the status of TTC is not determined. However, this is at the discretion of the VRBT service provisioning.

In the call flow illustrated in FIG. 35, ringback media is delayed (210) until after receipt of an indication arrives from TMG/TTC of the state of that section of the call. In the illustrated embodiment, the indication is RINGING (200), which allows the decision of the media to be sent to be made upon reception of the message, which is indicative of TTCs status, thereby allowing for appropriate media to be sent. This enables the decision to be made between ringback media and network messages (such as for a bad number), forwarding, or the like, to be sent without needing to stop a ringback media partway through the process. This early answering mechanism is also applicable to announcements not involving a second terminal.

An ISUP device, and in particular, an MSC may send what is termed an “early ACM” if the Called Party's Status Indicator is set to 00 (no indication) in an ACM message. This is typically sent to stop a timeout occurring at the originator side in the case of long paging time.

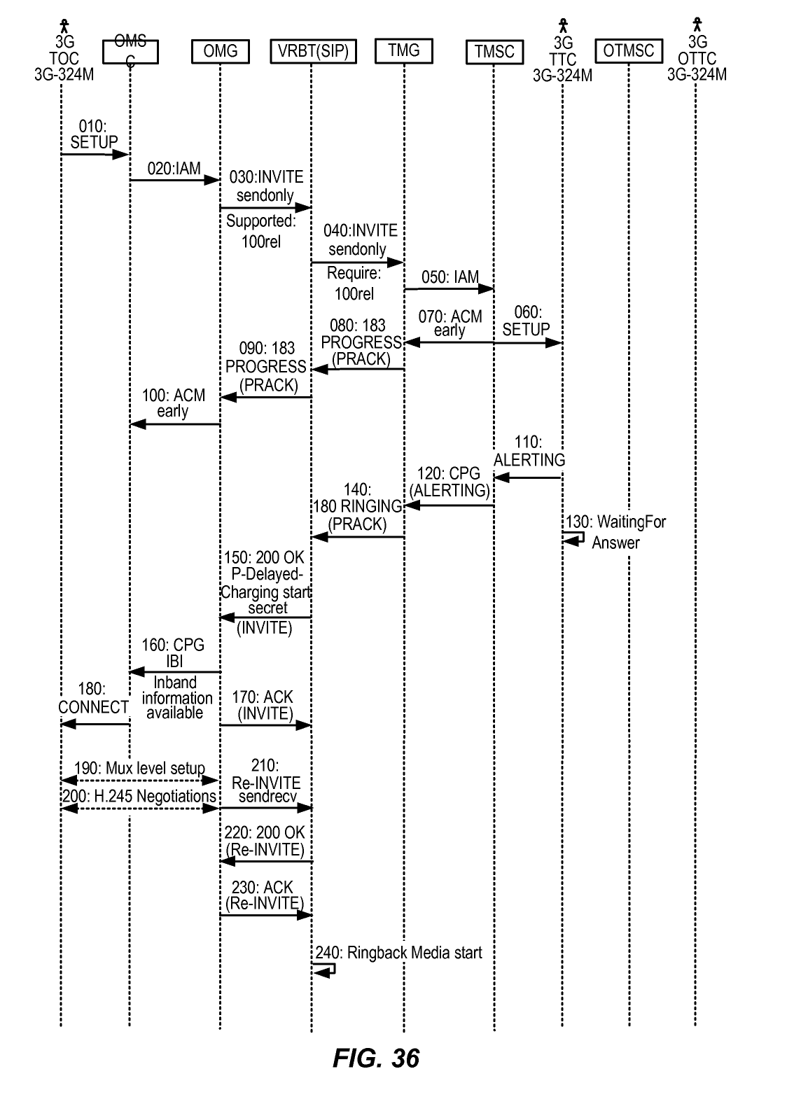

FIG. 36 illustrates a call flow with accommodation for networks using an early ACM sent from TMSC (070). The SIP translation of an early ACM can be a 183 SESSION PROGRESS (080) message, as it has no alerting indication. Upon receipt of a 183 SESSION PROGRESS (090) message, the OMG may transmit its own early ACM (100).

This has implications for how the delayed charging 200 OK (150), which is received at the OMG in response to the TTC ALERTING/RINGING indications (110,120,140) that propagate through the VRBT, is sent out to ISUP. As an early ACM has already been sent, it is necessary to transmit a CPG. The CPG is transmitted with the IBI indication of delayed charging (160) to OMG (instead of an ACM with the indicator). The OMSC interprets this and establishes a billing free/delayed connection in the same way as described for the ACM and IBI case. The remainder of this flow is unchanged from the first case.

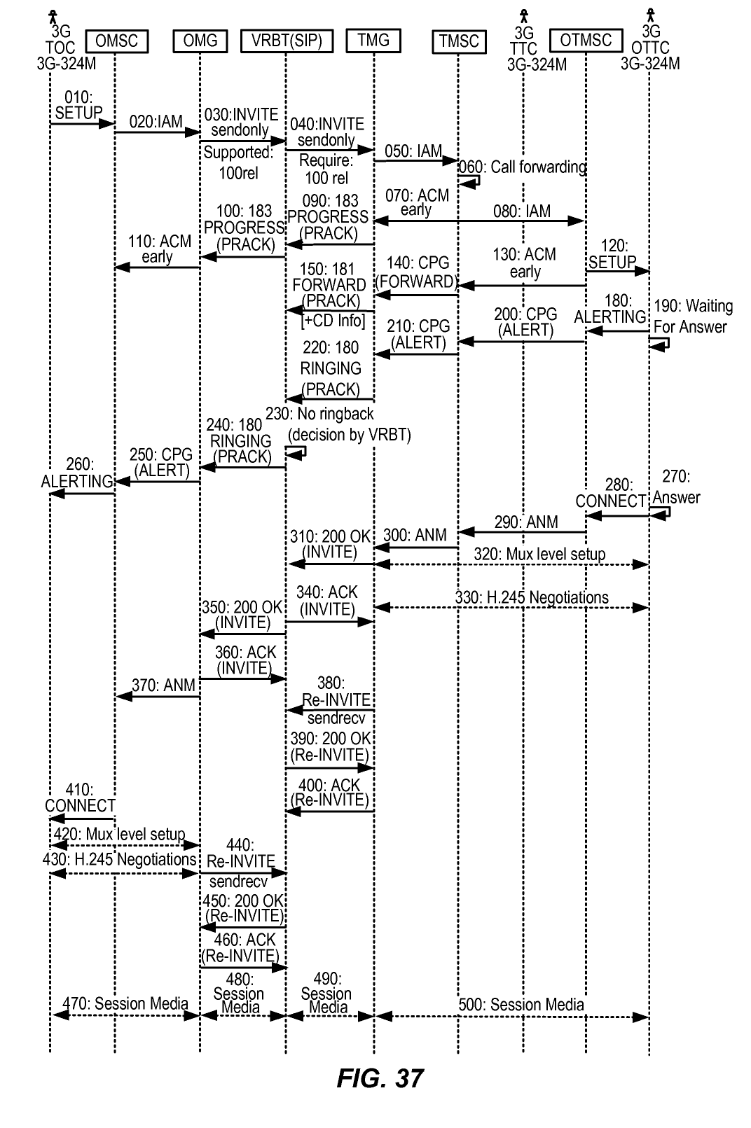

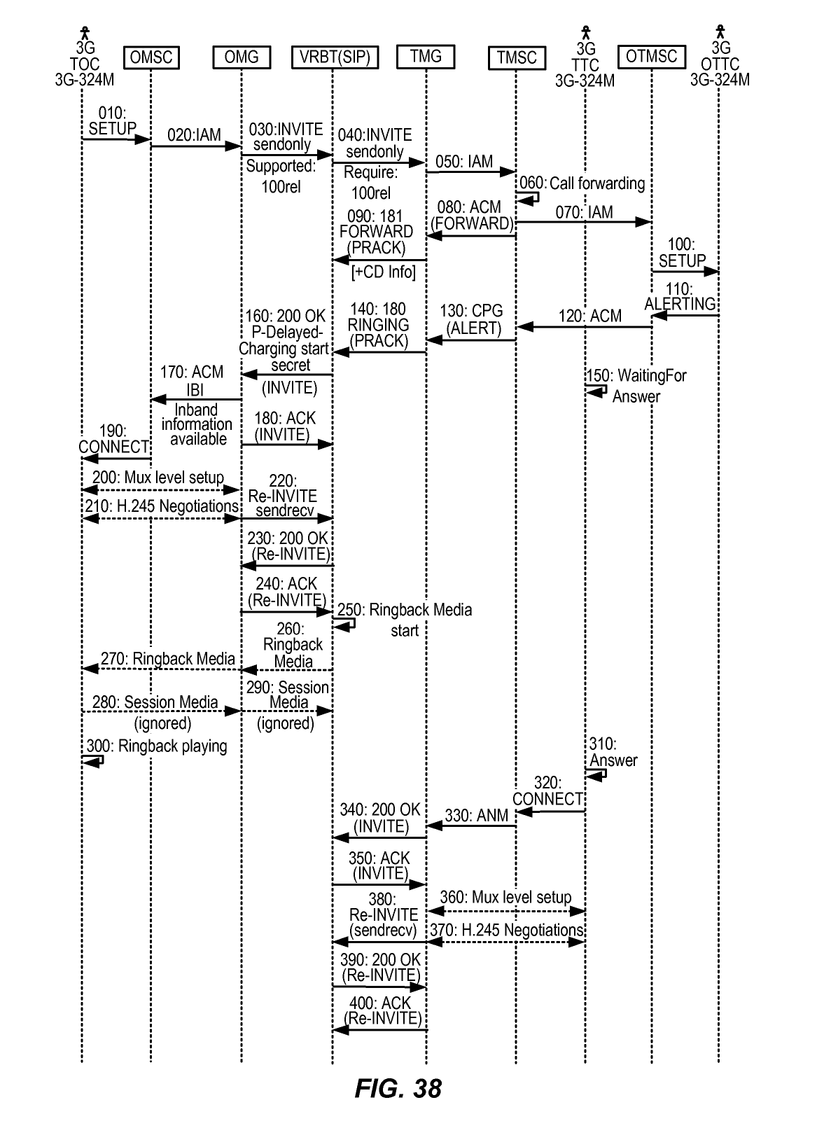

FIG. 37 and FIG. 38 show options for unconditional forwarding or diversion. FIG. 37 illustrates an embodiment in which the information indicating forwarding has occurred is received by VRBT and is used to determine that no ringback media will be played back. Here, forwarding occurs (060) and is indicated in a CPG (140). The CPG's forwarding (or call diversion) information is transmitted as an ISUP encapsulation in SIP, or as a selection of relevant pieces of information (e.g. call diversion information, redirection number, redirection number restriction, and the like) in a proprietary fashion (e.g. proprietary headers or proprietary codec) in a SIP 181 FORWARD (150), noted as [+CD Info]. This information is then used at VRBT to determine an action. In FIG. 37, this results in no media being played, possibly due to a lack of ringback service subscription for the other/forwarded terminal terminating the call (OTTC). In this case, VRBT simply sends a RINGING (240) instead of an OK, and OMG and OMSC act on this information to have a normal call setup without ringback.

FIG. 38 illustrates VRBT deciding, based on the CD Info in a 181 FORWARD (090), to continue to play media by sending a 200 OK (160) with delayed charging after recognizing forwarding has occurred. As an example, the media could be based on the forwarded party number (OTTC). Ringback plays normally (300) and the normal session is established when OTTC answers (310).

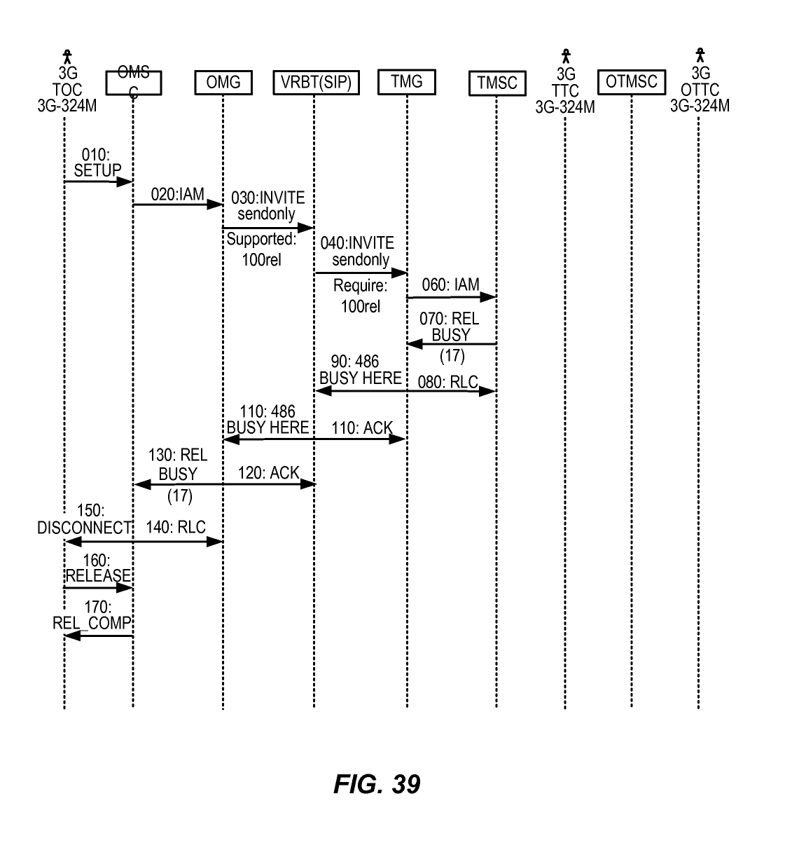

FIG. 39 shows a flow with release of call based on determined non-availability of TTC. In this case, it is a network determined non-availability of user busy, but it could also be similarly user determined. TOC initiates a call as normal and it propagates through the system until the TMSC determines that the TTC device is busy. TMS indicates an ISUP release with busy indication (070). This propagates back through the system as a SIP 486 BUSY HERE (other codes may be used also, for example a 600 BUSY EVERWHERE) and eventually is signaled to OMS as an ISUP release with busy indication (130). The OMSC in turn disconnects the TOC (150).

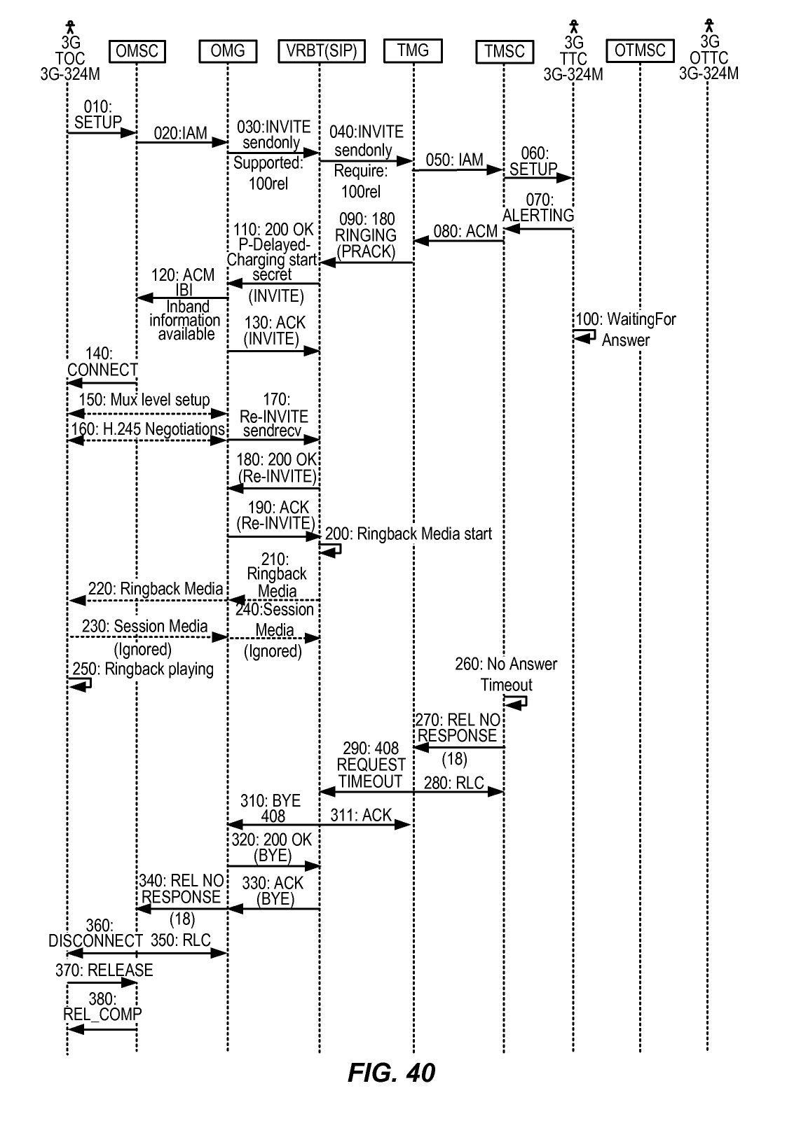

FIG. 40 shows a TTC time out on alerting due to not being answered. In this scenario, VRBT has established a session and already started transmitting media ringback to TOC (210) based on TTC information. When the timeout occurs (260), which can be user or network determined, an ISUP release with a cause of no response is sent (270). This is mapped into a SIP message via TMG to a SIP 408 REQUEST TIMEOUT (290).

As the session from VRBT to TOC is already established, it is torn down via a SIP BYE message (310), which may have a reason code in it. Before sending BYE (310), VRBT might send an announcement style message. The BYE is mapped to an ISUP release message with possibly the same release code (340) that leads to the disconnection of TOC (360).

FIG. 41 shows the case of a forward on no response at TTC. This capability is indicated in ISUP when the setup propagates to the TMSC and it returns an ACM (080) indicating that “diversion may occur.” This can be mapped to a RINGING (180) at TMG, the “diversion may occur” information can be sent via SIP either as encapsulation or as a standard or proprietary header or method/extension.

VRBT decides to proceed with media ringback upon receiving the RINGING (090) with “call diversion may occur” by sending a 200 OK (110) with delayed charging indicated. The ACM produced may contain the “CD may occur” indicator. Ringback proceeds as normal until a timeout occurs (260), indicating that TTC has not answered. Call forwarding occurs (270) and the call is diverted to OTTC (280,310). An ISUP indication is sent indicating the call is diverting (290). TMG may map this as a forward and include the call diversion information, encapsulated or as a proprietary header/extension (300). VRBT may take some action here, such as a diversion announcement, or may continue to play the original media ringback. It may choose to propagate the “call is diverting” message into a CPG in some cases (not shown). When OTTC is known to be ALERTING/RINGING (320,330,340,350) by VRBT, VRBT can modify the media to play back a ringback for OTTC subscriber.

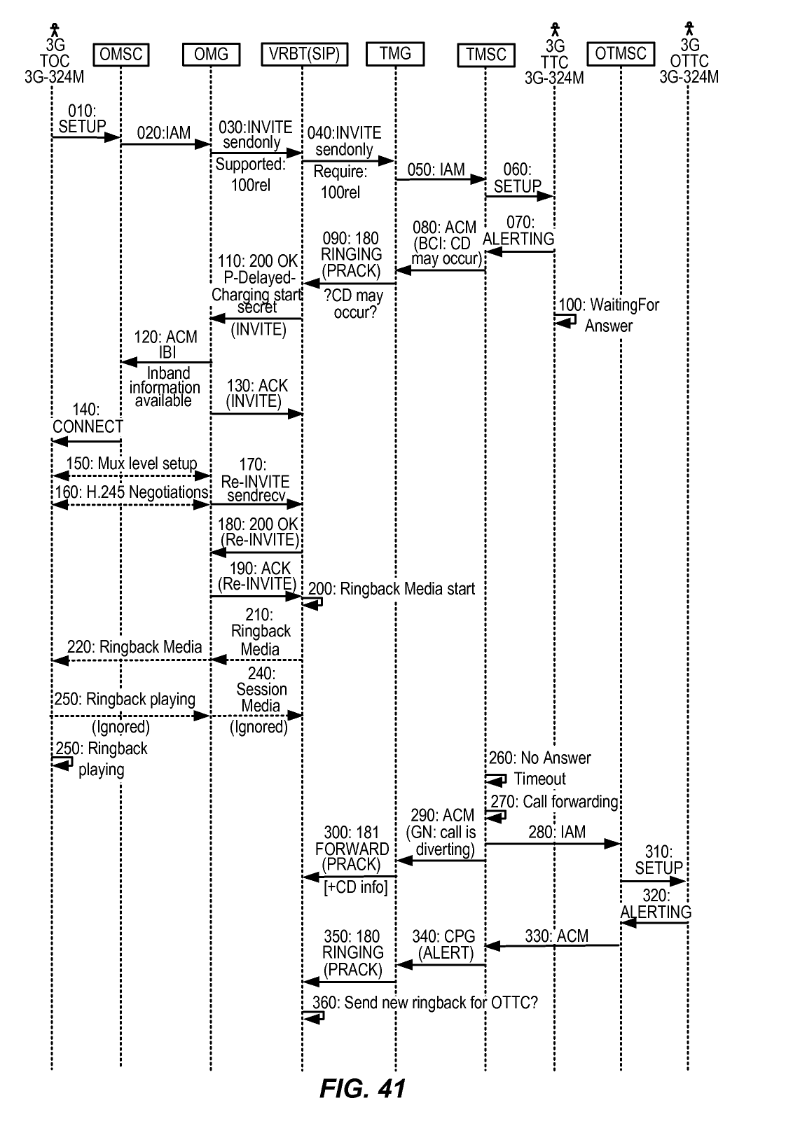

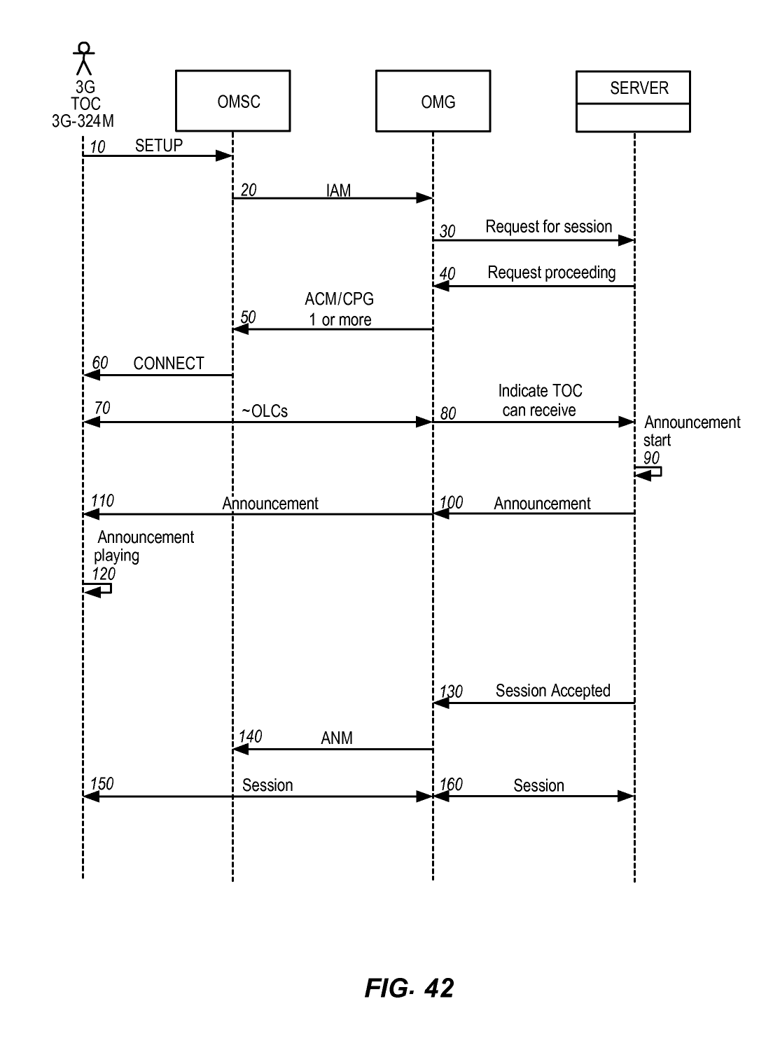

FIG. 42 illustrates a call flow for delivering an announcement to a 3G-324M device in a manner that would deliver the content in line with a billing mechanism expected in a conventional system without the announcement and is thus readily applicable to present day networks with deployed handsets. In particular, the flow shows a CONNECT being transmitted to a 3G-324M device and the bearer being bidirectionally connected in order that TOC may establish a session prior to when it normally would be possible. The mechanism is enabled by a minor modification in OMSC, yet this modification is made in such a way that the modified OMSC can still communicate with unmodified MSCs with no knowledge of their support or non-support of this feature with no billing consequences. The ability to communicate with unmodified MSCs is useful in working across networks where agreements are not in place for establishing early media, for example, in a network in which early ANMs to elicit the connect would not be acceptable in the case where no billing arrangement was in place. The 3G-324M device is not required to be changed in any fashion, as would be the case if it was awaiting an ALERTING message and detecting/attempting bearer connection, and importantly the service is capable of being delivered to the many millions of already deployed 3G-324M devices with no need for any modification.

TOC transmits a SETUP message to OMSC, which is converted to an ISUP IAM in the MSC. The IAM message is received at a gateway that issues a request for a session from SERVER. SERVER may be an ISUP, H.323, SIP, ISDN, or H.324 device, or the like. SERVER responds with an indication that the session request, or session establishment is proceeding. This request proceeding message may be independent of the cause of the early transmission of the CONNECT to TOC device (e.g., it may indicate a special message to create the ACM/CPG message).

Embodiments of the present invention provide a modification to the MSC to emit a CONNECT to a handset. This could have several mechanisms for being caused. In this embodiment, the CONNECT is emitted in response to either an ACM or a CPG or some combinations of the two with or without a special message or behavior being signified in the message.

After the CONNECT is received in TOC, it will establish a bidirectional bearer and begin establishing a session. The session establishment can occur in a variety of ways and typically will occur in band on the bearer using either conventional H.245 or one of the accelerated session setup techniques as detailed in commonly assigned U.S. patent application Ser. Nos. 10/732,917, 10/934,077, 11/373,413, 11/303,858, 11/408,810, 11/482,515, 11/548,670, and 11/604,177, all of which are incorporated herein by reference in their entirety. Many terminals will likely employ one or more of the procedures in H.324 Annex K, also known as Media Oriented Negotiation Acceleration (MONA). For the purposes of clarity, these negotiations are shown simply as OLCs indicating the opening of logical channels, but the mechanism is not restricted to their opening through conventional H.245 OpenLogicalChannel Request and Response (Ack) messages.

In some applications it is important for quality that the SERVER delivering some announcement is aware of a time when TOC is capable of receiving and decoding media. This information is used in some cases in order to ensure that the beginning of a clip is not lost by beginning of playback at a time before TOC is ready to receive. In this flow, shown this optional indication is shown as “Indicate TOC can receive.”

After receiving the indication that TOC can receive media, the announcements starts. In some cases, this would not strictly be necessary, such as for content that is being joined mid stream anyway, such as TV, or perhaps if the announcement is a short looping message. If a non-wait behavior is employed at SERVER, then it is preferable that OMG is capable of detecting features such as intra coded frames to ensure the quality of media in the announcement as re-transmitted to TOC. OMG may also perform some transcoding, including transrating and/or trans-sizing, operation on the announcement. It is also possible that a different source, content, or type of media is used for the media before the indication that TOC can receive media is received. In this way, if TOC can receive media before the indication is received (for example as part of the negotiation when H.324/Annex K MPC are being used), then the media may be transmitted earlier and used by TOC. Examples of the kinds of media expected to be used here would be either a blank screen, still image or a company logo/advertisement.

In general, TOC will utilize the announcement. For example, when TOC is a piece of user equipment, this would involve rendering to screen, but infrastructure equipment may transcode or otherwise process the media. Finally the session is accepted by the server and an indication of such is sent to the media gateway. In this embodiment, the media gateway transmits an ANM message to the MSC which uses the message for billing purposes. It is also possible that OMSC and/or OMG and/or SERVER are collocated and some of the messages, while logically present in the service logic, are not actually presented on an interface as shown here. It should be noted that the ISUP messages may actually be tunneled in another signaling form. For example, the IAM may be transported via SIGTRAN or SIP-I messaging.

The use of this delayed charging mechanism for VRBT is already made clear throughout the present specification. It is also applicable to network announcements, pre-charge menu access for services such as video mail or video augmented voice mail, video call continuity to voice or regulatory, or self imposed, access checks such as an age check for mature content.

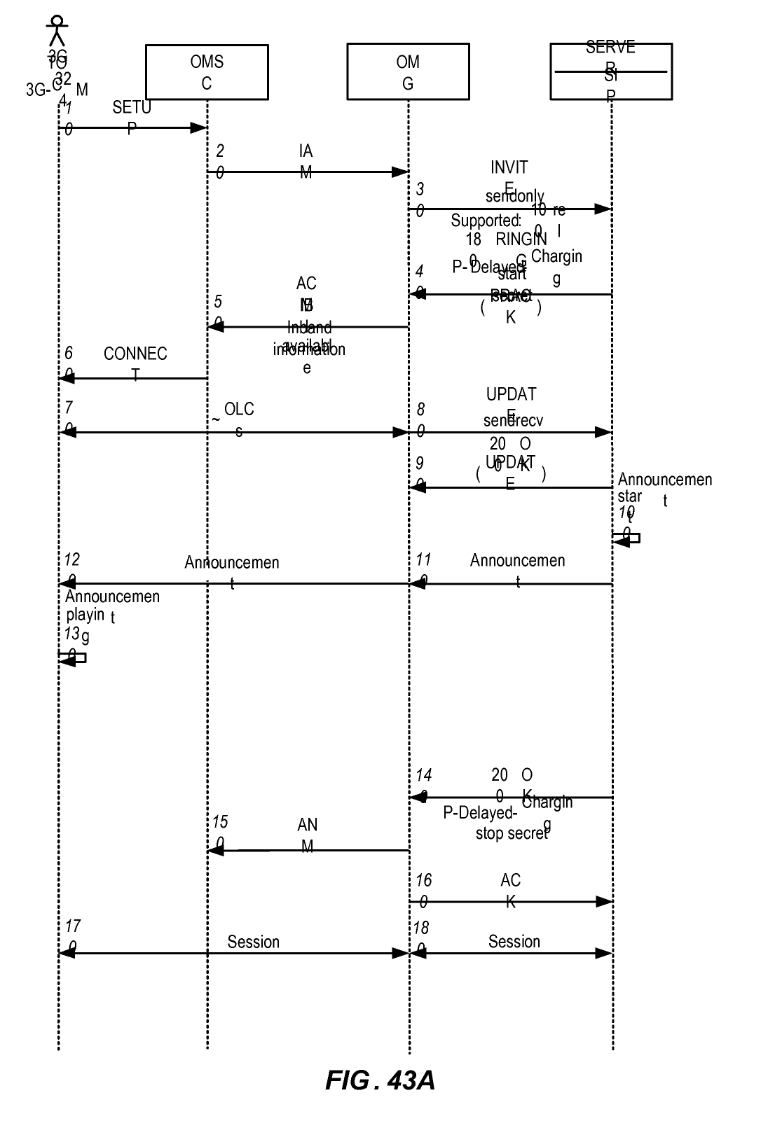

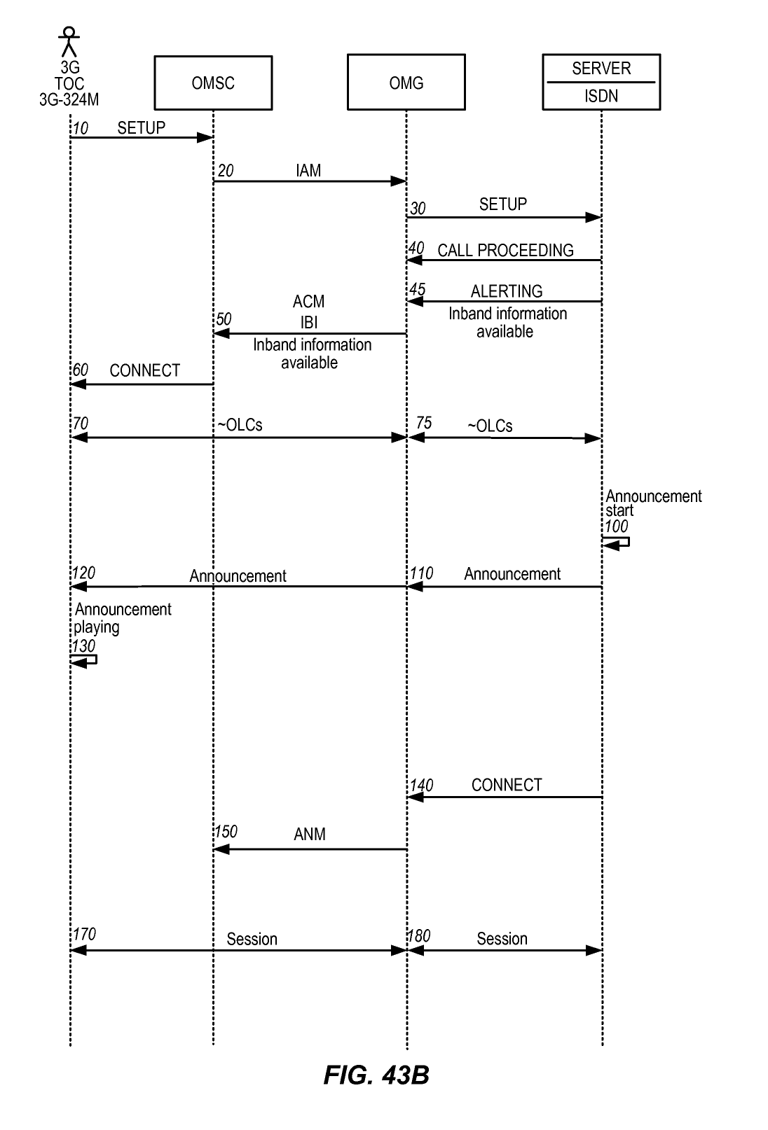

FIG. 43A illustrates delayed charging for an announcement delivered to a 3G-324M device from a SIP server according to an embodiment of the present invention. The session establishment mechanism to the server is via SIP. The request for media is made in an INVITE message, which optionally has sendonly media in order to allow an indication that TOC is allowed to be received to be transmitted subsequent in the call flow.

The INVITE also offers PRACK or Reliable 1xx messages (e.g., 100rel), as it is expected that the 180 RINGING message will be transmitted as an indication of the intent to proceed with the session, and thus the progress messages are intrinsic to the flow and will be better able to offer the best service if reliable provisional messages are employed. It should be noted that this RINGING may not actually be associated with an alerting device, but may in fact be only session logic to allow the “free” delayed charging media to be sent. Thus, in some cases, a 183 SESSION PROGRESS message may be more appropriate, however for consistency with the video ringback case RINGING is used.

The RINGING message contains the P-Delayed-Charging header that may be used at the gateway to propagate a message that will trigger a CONNECT. In this particular embodiment, a mechanism for triggering the CONNECT from either the ACM or CPG is the presence of the IBI flag, for “in-band information,” in the Optional Back Call Indicators. In a trusted (i.e., authorized) network, or in some configurations, the mere presence of a certain feature in the RINGING or a SESSION PROGRESS may be sufficient to cause the emission of an eventual CONNECT. For example, the use of the early-media session disposition or an authorized early session.

After TOC has CONNECTed and becomes capable of receiving media, an indication of such is optionally transmitted back to the server using the UPDATE method. The UPDATE method updates session characteristics of the ongoing INVITE. The UPDATE here indicates sendrecv media is now allowed for bidirectional media in a session. In an alternative embodiment, SIP preconditions may be used to determine that media is allowed to be transmitted. The announcement is now sent using SIP early media.

The server accepts the final session using a 200 OK in response to the INVITE. The normal session is now conducted, either with the same session characteristics as the early session or different ones (for example, the session disposition may differ from the early session). In this embodiment, the presence of the 200 OK and the P-Delayed-charging message causes the ANM to be transmitted.

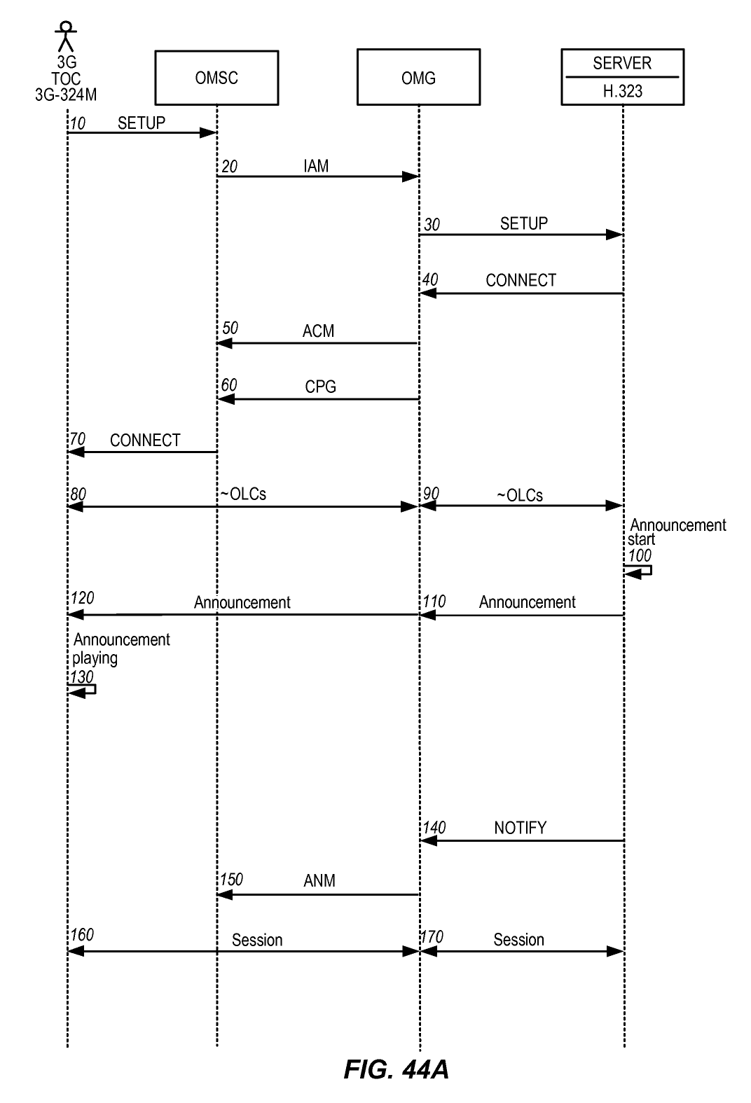

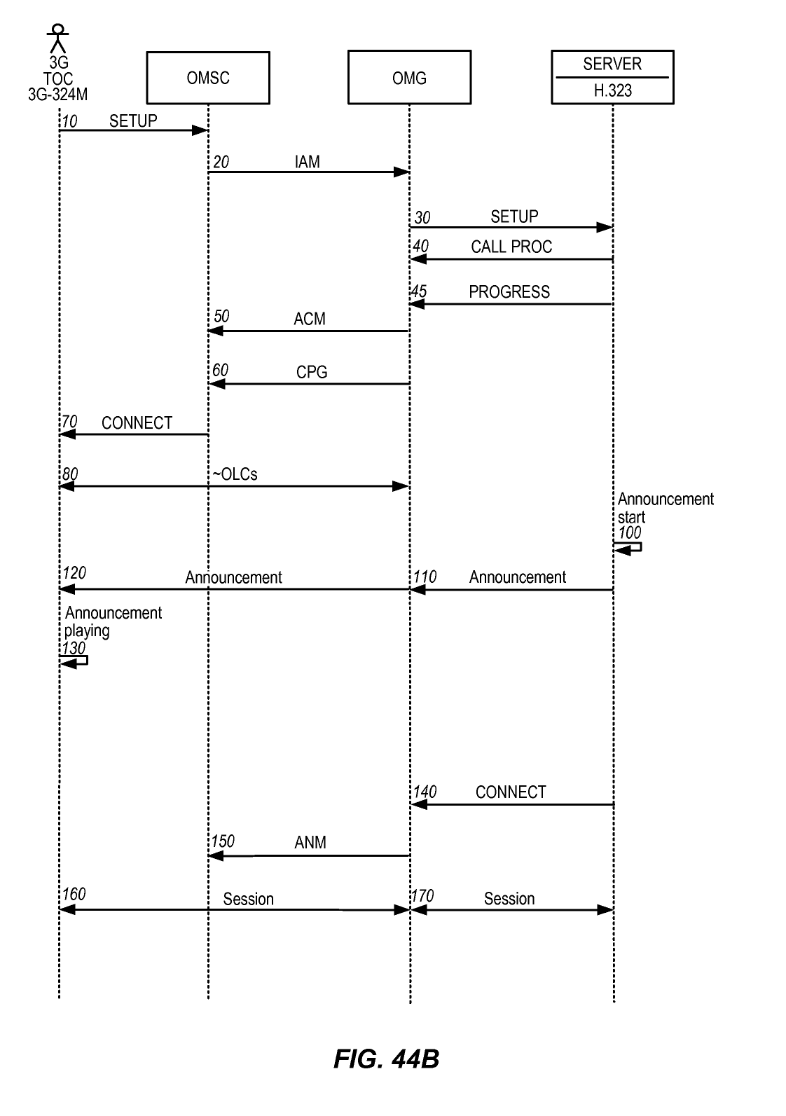

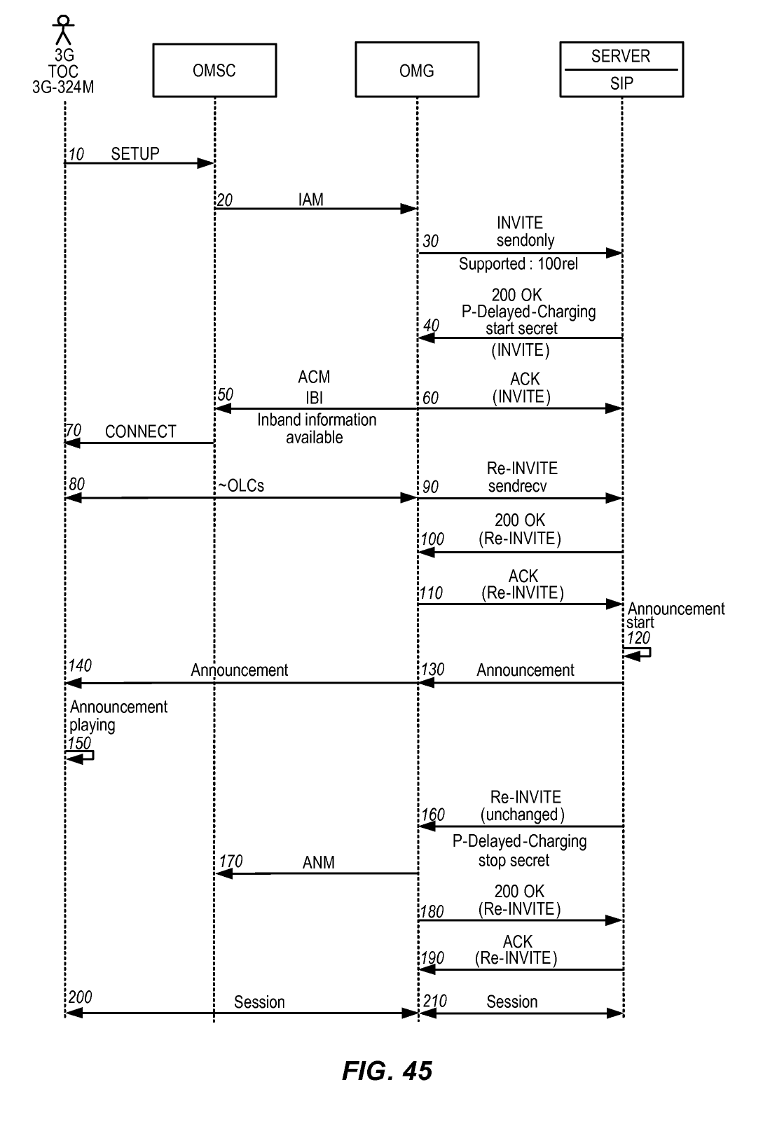

FIGS. 44A and 44B illustrate delayed charging for an announcement delivered to a 3G-324M device from an H.323 server according to embodiments of the present invention. In the flow shown in FIG. 44A, a mechanism of answering the session at the gateway, similar to that used in FIG. 45, which illustrates delayed charging with 200 OK. Here, in response to the CONNECT coming into the H.323 server, as opposed to a 200 OK, an immediate CONNECT (which may or may not contain an indication to cause the CONNECT on the 3G-324M side) is sent back, which eventually propagates back to the 3G-324M side as a CONNECT, again by an ACM or CPG or the like, and not an ANM, thus enabling non-charged connection to the 3G-324M device. Next, both the 3G-324M side and the H.323 sides negotiate to open logical channels, either through conventional or accelerated negotiations. The finalization of the H.323 side logical channels might be delayed until after the H.324 side is ready with its logical channels to receive media. Alternatively, a different message may be used to trigger the start of the media, such as an H.245 message, an OLC, or a proprietary message. The media then flows from the server to the device. When the device is ready to establish the charged session, it transmits a message to trigger this event. In this case, a NOTIFY is used, but alternatives exist. This message in turn triggers the ANM to the MSC.

FIG. 43B illustrates delayed charging for an announcement delivered to a 3G-324M device from an ISDN server according to an embodiment of the present invention. The session establishment mechanism to the server is via Q.931/Q.931-like messages. In the flow shown an ALERTING message is used to indicate that bearer may be used to establish a session. One modification that could be used here would be an indication of having “in-band information available.” This can then be mapped to the previously discussed options for delayed charging messaging/early connect/pre-connect media for to TOC. Here again, optionally, the media from the server may be held back until indication of ability of TOC to receive media is received. The mechanism for this delaying might be holding off on completing an OLC messaging procedure between the gateway and the server, e.g. an OLC Ack, until the logical channels to TOC are finalized. Further, it may also be possible for various reduction in involvements to occur, in particular removing the media gateway from the flow.

FIG. 44B illustrates a variant for delayed charging still utilizing an H.323 server. In this flow, the signaling on the H.323 side more closely resembles the signaling through the ISUP interface. Here, a CALL PROCeeding message or a PROGRESS message may contain a special indication to cause a CONNECT to be emitted from the MSC. The H.323 side might use fast start/fast connect to establish logical channels in these messages. The CALL PROC or PROGRESS then be mapped into proprietary/modified/customized ACMs or CPGs or a particular combination. The logical channels are negotiated on the 3G-324M side. An indication is optionally sent to the H.323 server indicating media is allowable to TOC. The announcement begins to be transmitted from the H.323 server through to the 3G-324M device. When the device is ready to establish the charged session it transmits a message to trigger this event. In this case, a CONNECT is used, but alternatives exist. This in turn triggers the ANM to the MSC.

FIG. 45 illustrates delayed charging for an announcement delivered to a 3G-324M device from a SIP server according to an embodiment of the present invention. This flow shares many features of FIG. 43A, with one difference being that the server chooses to accept the SIP session immediately (200 OK) and use the establishing session message with P-Delayed-Charging to cause the CONNECT to be emitted. This particular method has some advantages in design simplicity over other SIP methods and if the SIP interface exhibiting this behavior is only exposed a MGW to H.324/3G-324M devices may be preferable. This solution would not be preferable if the SIP interface were being exposed to other SIP devices and in particular across SIP network boundaries where a 200 OK may have particular charging implications.

After TOC can receive media, the media gateway transmits a ReINVITE message changing media to sendrecv to allow media to be sent from the server. When the server wants to accept the session, it transmits another ReINVITE with P-Delayed-Charging set to stop which causes the transmission of an ANM from the media gateway and the start of regular billing.

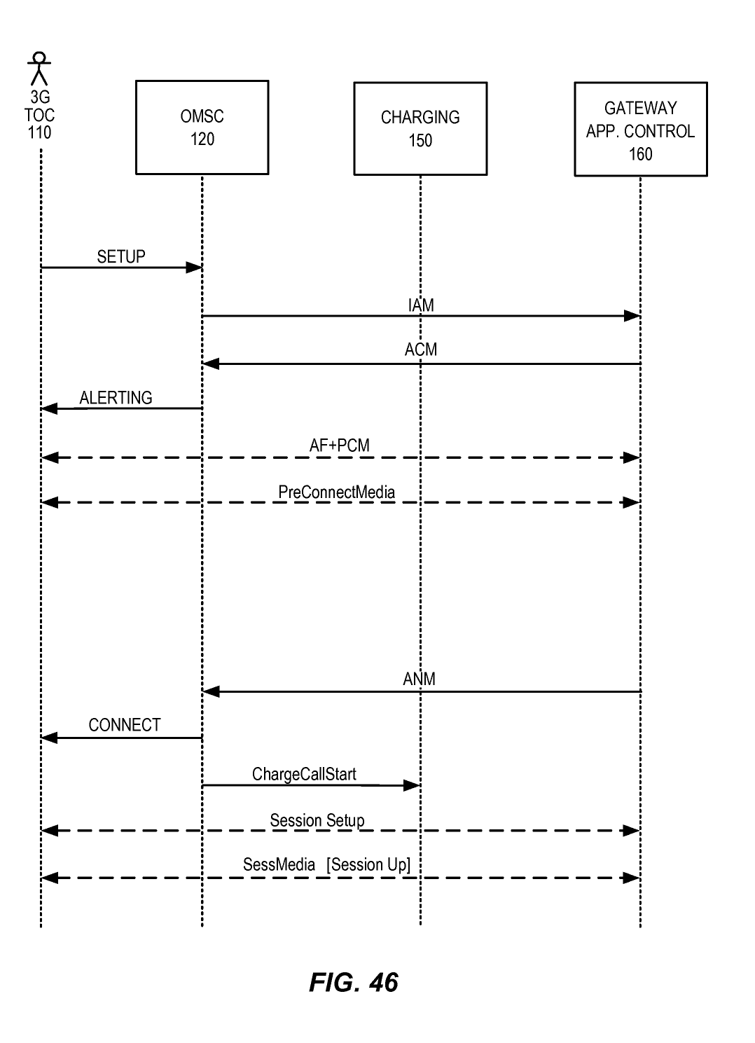

FIG. 46 illustrates pre-CONNECT media delivered to an appropriately modified 3G-324M device according to an embodiment of the present invention. In this case, the ALERTING message may or may not contain an indication for the terminal that the bearer is now available (e.g. using the progress indicator field and then optionally using one of “in-band information or appropriate pattern is now available,” or “call is not end to-end ISDN; further call progress information may be available in-band”). After the ALERTING message is transmitted, the bearer may be available all the way to TOC in some cases. If it is, then the gateway can be sending Pre-CONNECT media to TOC for use as an announcement/ringback tone. An optional negotiation phase could also be used to decide media formats. This negotiation phase should be as quick as possible, employing the previously mentioned acceleration methods, in order to provide a longer duration of media. The media may be sent in some pre-determined fashion, i.e. send H.263 media directly, and the negotiation could use some conventional setup techniques, but this might cause issues with some deployed terminals that connect their modems prior to receiving a CONNECT, especially with regard to their reception of mux level setup flags and eventually having some kind of session timeout. Instead, it is possible to transmit the media and/or negotiations using a variant of the AnswerFast Type IV messaging scheme, which will be invisible (i.e. appear as noise) to non-supporting terminals, but be usable for supporting terminal. Alternatively, the gateway may not transmit to begin with and require a reception of a negotiation from the handset. However, it is possible this would be slower than other methods. After the gateway answers the call, in order to establish the late session, a second period of negotiation may start (alternatively the early session characteristics could be used, which may enhance speed, but may limit flexibility). This second period can resolve the characteristics for the late session. Also, the call connection may be associated with the start of the session charging period.

FIG. 47 illustrates 3G-324M Ringback via a SIP server and call setup according to an embodiment of the present invention. This flow is similar to FIG. 29, but in order to provide the announcement/VRBT to a SIP TOC, certain changes to the flow have been made. These changes are primarily on the OMG/SIP VRBT interface and are similar to the SIP interface described in relation to FIG. 43A. The VRBT server now uses SIP early media and the SIP UPDATE method to control the transmission of media. The changes here are also applicable to the use of SIP preconditions.

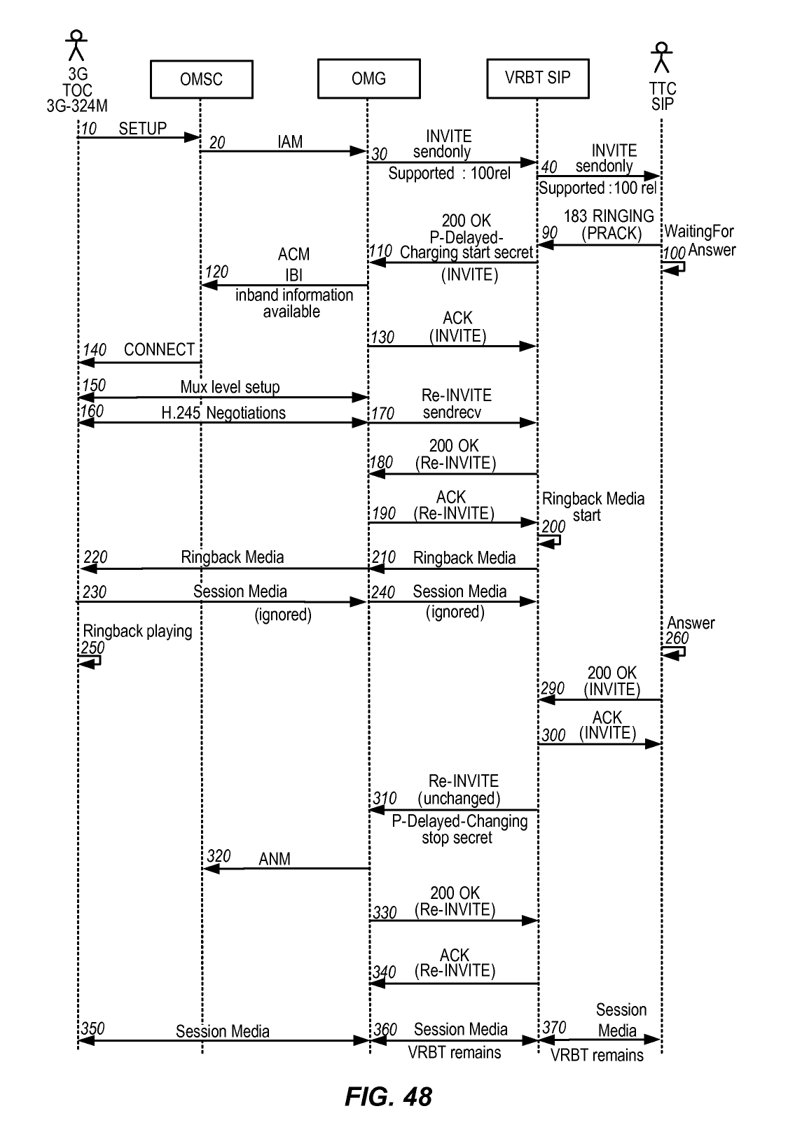

FIG. 48 illustrates video ringback delivered to a 3G-324M device when calling a packet switched device according to an embodiment of the present invention. This flow is similar to the flow of FIG. 29, but with TTC now a packet switched device. Here, a SIP device is communicated to with the ringback coming from the VRBT.

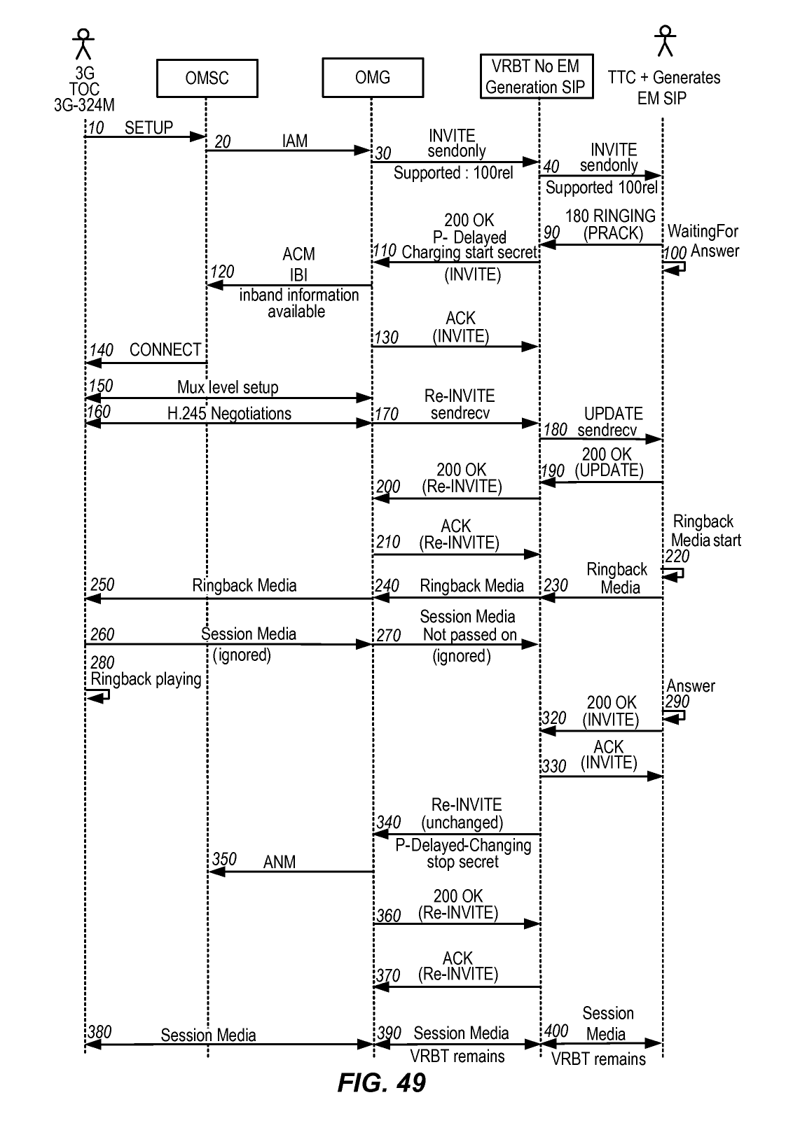

FIG. 49 illustrates video ringback delivered to a 3G-324M device when calling a packet switched device capable of SIP early media according to an embodiment of the present invention. This is similar to the flow of FIG. 48 with respect to the TOC side of the VRBT server, but now instead of transmitting a VRBT media stream from the VRBT application server towards TOC instead the TTC device, which may be a proxy or breakout gateway to another network, delivers SIP early media back to VRBT that is then used in the VRBT as delivered to TOC. This is shown as being generated at TTC, but this may just be in the network of TTC. For some operators, certain trust or authorization agreements will need to be in place before this would be allowed, particularly with regard to cross operator SIP boundaries. However, into the future these cross operator boundary ring back streams may become valuable differentiators to operators.

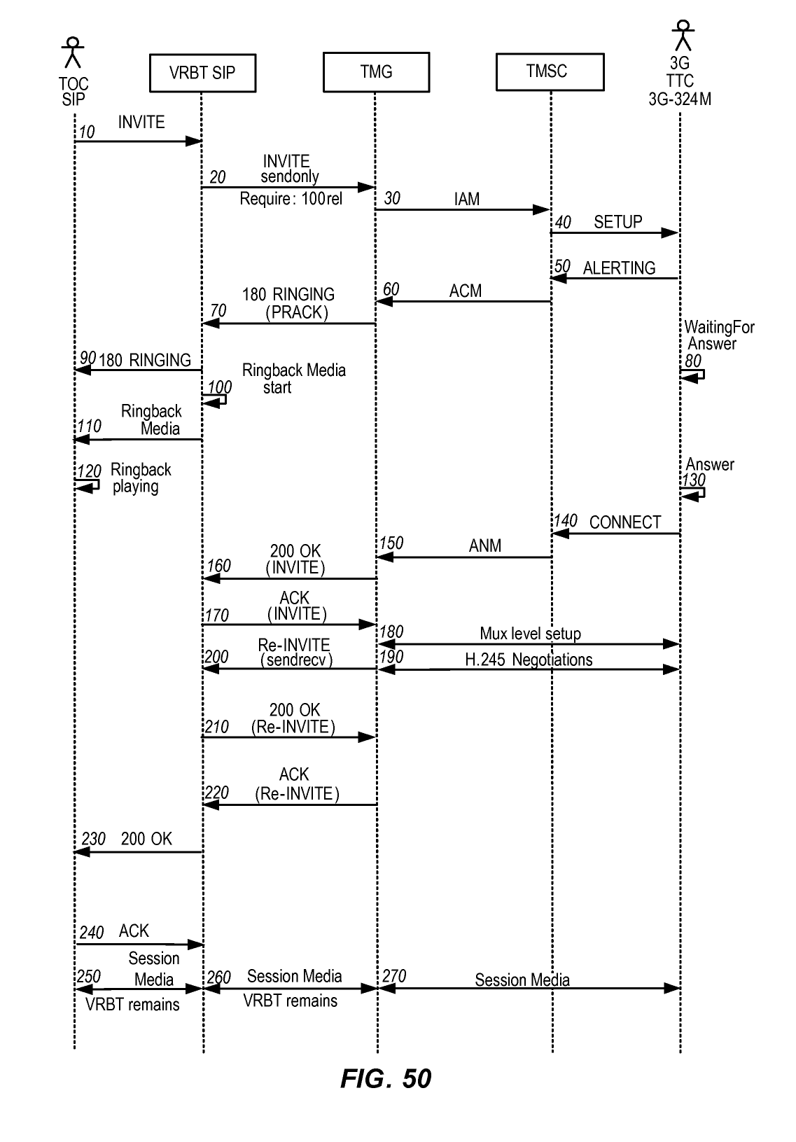

FIG. 50 illustrates SIP Ringback when calling a 3G-324M device via a SIP server and call setup according to an embodiment of the present invention. As illustrated in FIG. 50, the 200 OK (210) is delayed until the logical channels are established on the 3G-324M side as indicated by the ReINVITE with sendrecv. The VRBT server serves to hide the complexities of ensuring media quality across the SIP/3G-324M interface. Again, variations such as using SIP session disposition or pre-conditions are possible. Depending on support in TOC, the VRBT server may even be reduced to a simple proxy, in such a case of reduced VRBT server involvement the TMG may actually delay sending its 200 OK message until after OLCs step has occurred to ensure media quality.

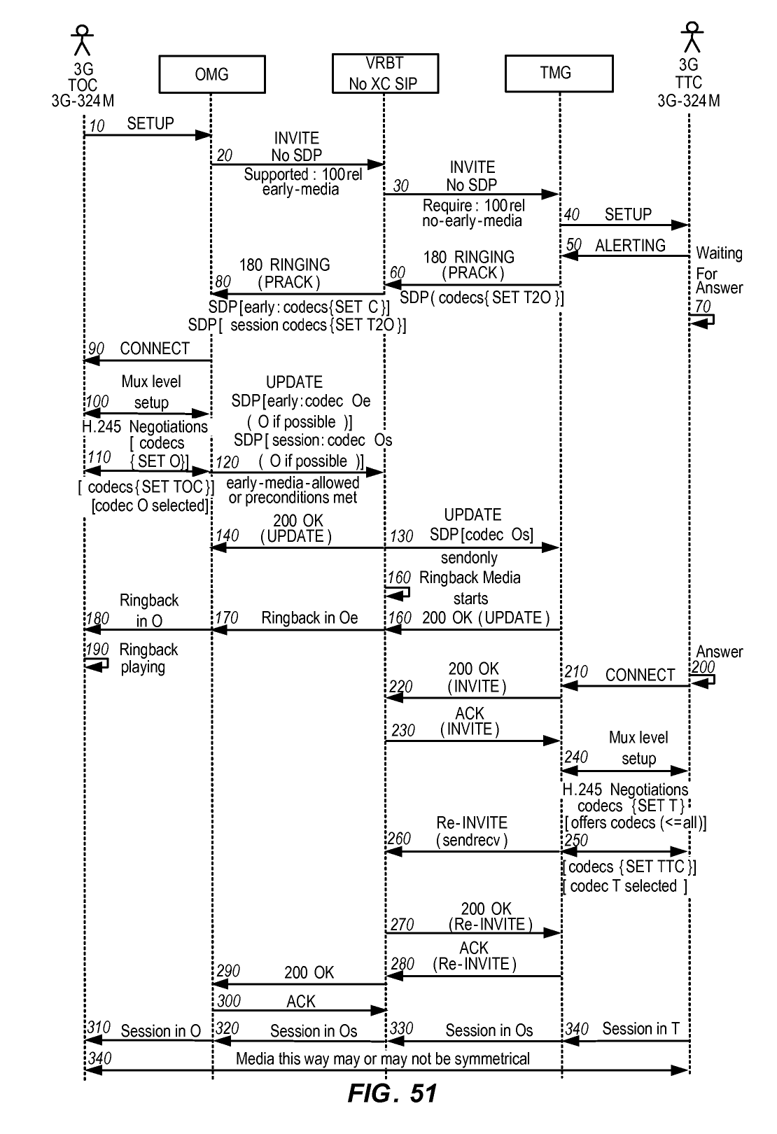

FIG. 51 illustrates 3G-324M Ringback via a SIP server with minimized transcoding according to an embodiment of the present invention. Although FIG. 51 illustrates TOC as a 3G-324M device, this is not required by embodiments of the present invention. In other embodiments, TOC and TTC may operate under different protocols such as SIP, as could the gateways. There are two transcoding media gateways, a simple SIP application server that does not perform any transcoding, as well as a content source (not shown). In variants transcoding may also be provided in the application server or in the content server. TOC starts a call by emitting a SETUP message that is received at OMG. This will in general be via an originating MSC, OMS, but this has been omitted to simplify the diagram. OMG then transmits an INVITE. In this case, it has no SDP attached in order to not lock in a codec selection until after the TOC OLCs provide a codec/format for the media. In this example, 100rel is supported to allow for the RINGING to be provided in an acknowledged fashion to ensure that the service logic happens in a reliable way and that ringback media is delivered even in the presence of errors (as the RINGING could easily be lost and not trigger the service at the earlier time). It also indicates that it supports early-media of some fashion. This may be implicit in some cases, but in others it might indicate that it supports a separate early session from the “normal” session by use of the session disposition extensions or the like.

An INVITE is then transmitted out of the VRBT application server, in this case requiring 100rel for the reasons previously disclosed in the present specification. It also does not need to advertise any support for early-media in this simple CS to CS case, but may do so, particularly in the case where the early media might be coming from a different SIP device, possibly in a different network. This propagates to TTC as a SETUP. Again, a terminating MSC is generally interposed here and may actually transmit back early ACMs or similar that may cause SESSION PROGRESS messages to be in the call flow. These might then be used to convey the SDP that is transmitted in the RINGING messages following in some cases prior to the ALERTING, and other cases may employ other provisional messages.

After receiving the ALERTING indication, TMG transmits a RINGING message to VRBT, which importantly contains an SDP indicating the codecs supported by TMG on its SIP side, set T2O. Preferably, this is an ordered preference list of the codecs that TMG can support when a 3G-324M session is established on its far side. In some cases, this list may only be those codecs for which a guaranteed transcoder is available, i.e. with H.263 as mandatory on 3G-324M, this would mean any transcoder that can convert to 3G-324M H.263 would be in the list. The codecs are not distinguished into audio and video, but the negotiations of the separate codecs for the sessions would follow similar independent logic. However, it is possible that the content session has an interdependency of audio and video codecs if the content is stored in different 3GPP files that don't cover all combinations of codecs (e.g. H.263+AMR in one file and H.264+AAC in a second file).

VRBT after receiving the RINGING and the set T2O, then transmits another RINGING indication to OMG. This ringing can contain two sets of codecs in order to negotiate both a first and a second session. The early codecs are associated with an early session, for example for ringback media; and the session codecs are associated with the normal or late session (sometimes referred to as the session, which is the eventual end-to-end session or the session associated with normal call charging), which will be used for end to end communication. In this example, the two sets of codecs are shown, early and late sessions, which are shown as Set C and Set T2O respectively. Set C would be all the codecs in which the content for the ringback can be delivered by VRBT. Set C may be a single codec or may be multiple codecs depending on the provisioning of the system and the transcoding facilities in the system. Set T2O is the same as the Set T2O transmitted from TMG, as VRBT offers no transcoding in this example however Set T2O may be reduced in some cases into a set T2O′.

It should be noted that the RINGING response does not necessarily need to have two separate sets of codecs for negotiation of the early session and late session and may only use a single set for both “sessions” (they would technically then be the same session in both the SIP and H.324 domains). This need not be limiting, as if a content adaptation unit capable of transcoding the content to the desired codec is employed then all session codecs can then be advertised for use for the early part of the one session.

The OMG, upon receiving the RINGING message, then causes a CONNECT to be transmitted to TOC. The causes of such an emission have been shown more fully throughout the present specification with one example being that the RINGING has a P-Delayed-Charging header or the like and that it causes an ACM with IBI flag set or CPG with IBI flag set to a modified MSC which in turn sends the CONNECT. Following the CONNECT, TOC and OMG negotiate logical channels. The media capabilities offered by TOC are shown as Set TOC. The media capabilities offered by OMG are shown as Set O. Set TOC may be structured based on the incoming Set T2O, or even Set C. Some inherent capabilities in the gateway may not be advertised, or the order may be changed.

After the negotiations are played out, either by conventional or accelerated means, an eventual codec is selected. In this example we call it codec O, and there would be an audio and video codec selected, but distinguishing them does not add to the discussion so we discuss only a single media type codec, and as video is the more likely to have different options, presently it seems the logical choice.

Now that codec O is selected for communications from TOC to OMG, OMG tries to use that same codec in both its early and late session. To do this it transmits an UPDATE selecting an early session codec, codec Oe, and a late session codec, codec Os. If possible, codec O is selected as both Oe and Os (i.e., if Set C and/or Set T2O contained O). This minimizes the transcoding in OMG for both the ringback/early session media as well as the late session media.

The reception of the UPDATE may also serve to indicate to VRBT that media may now be sent to TOC for the early session. It thus retrieves the content and delivers it in codec Oe, Ringback in Oe, which OMG converts to codec O, as necessary, for delivery, Ringback in O. Preferably Oe and O are the same codec and thus the gateway may employ a less computationally intensive pass-through transcoder that also has the benefit of not risking degrading the data. It should be noted that features such as described in U.S. patent application Ser. No. 10/762,829, entitled Method and Apparatus for Handling Video Communication Errors,” filed on Jan. 21, 2004, commonly assigned and herein incorporated by reference in its entirety, could also be employed in this transcoder for efficiency in maintaining quality in the case of errors.

Also, after the reception of the UPDATE, the VRBT makes an effort to try and seed the negotiations that the TMGW will conduct towards TTC in order to minimize transcoding. It does this by transmitting an UPDATE message containing the codec selection for the session Os although variations are possible. Again this is preferably codec O if possible from the Set T2O. After this point, TTC answers. This causes a CONNECT which propagates through TMG as a 200 OK.

Following the CONNECT, TTC and TMG negotiate logical channels. The media capabilities offered by TTC are shown as Set TTC. The media capabilities offered by OMG are shown as Set T. Set T is preferably structured based on the incoming codec Os. If possible, the Set T would use codec Os as its most preferred codec. If this is not possible, then a selection of the most preferred codec to employ in transcoding would be made based on criteria such as the codec to best maintain transcoded media quality or that which is least intensive. Set T in some cases may also have some codecs removed depending on knowledge of the system. For example, if a mandatory codec was selected as codec Os, then we might delete all other codecs from the Set T to guarantee that only the mandatory codec, that will also minimize our transcoding, is selected. After the negotiations are played out, either by conventional or accelerated means, an eventual codec is selected. In this example we call it codec T.

After the codec T is selected, and TTC becomes ready to transmit media, TMG sends a ReINVITE indicating sendrecv ability for the media. Again preferably codec T is the same as codec Os, which in turn is preferably the same as codec O, which can help to minimize computation and quality degradation through the system. As VRBT is now in a position to cross connect the sessions, it sends a 200 OK to OMG. This may have been sent slightly earlier, but it is preferable to delay this until this point to ensure media quality at cutover. In fact, it may be preferable to delay the 200 OK until the first intra coded frame is received from TTC/TMG at VRBT.

Now the session media path may be completed so session media propagates from TTC, in codec T, which may transcode to codec Os and sent to VRBT, which retransmits the media to OMG, which may transcode to codec O and send to TOC. The media in the other direction can be negotiated in a similar way, but need not be symmetrical with respect to the codecs.

Table 4 shows examples of video codec outcomes based on the capabilities of the content source and the two involved terminals according to embodiments of the present invention.

TABLE 4

| Capabilities of terminating devices | Outcomes |
|---|---|
| set_C = H.263 | TOC:H.263 |
| set_TOC = H.263 | Oe:H.263\|Os:H.263 |
| set_TTC = MP4-Visual, H.263 | TTC:H.263 |
| set_C = H.264 | TOC:MP4-Visual |
| set_TOC = MP4-Visual, H.263 | Oe:H.264\|Os:MP4-Visual |
| set_TTC = MP4-Visual, H.263 | TTC:MP4-Visual |
| set_C = H.264, MP4-Visual | TOC:MP4-Visual |
| set_TOC = MP4-Visual, H.263 | Oe:MP4-Visual\|Os:MP4-Visual |
| set_TTC = MP4-Visual, H.263 | TTC:MP4-Visual |
| set_C = H.264, MP4-Visual | TOC:MP4-Visual |
| set_TOC = MP4-Visual, H.263 | Oe:MP4-Visual\|Os:MP4-Visual |
| set_TTC = H.264, MP4-Visual, H.263 | TTC:MP4-Visual |
| set_C = H.264, MP4-Visual | TOC:H.264 |
| set_TOC = H.264, MP4-Visual, H.263 | Oe:H.264\|Os:H.264 |
| set_TTC = MP4-Visual, H.263 | TTC:MP4-Visual |
| set_C = MP4-Visual | TOC:H.264 |
| set_TOC = H.264, MP4-Visual, H.263 | Oe:MP4-Visual\|Os:H.264 |
| set_TTC = MP4-Visual, H.263 | TTC:MP4-Visual |

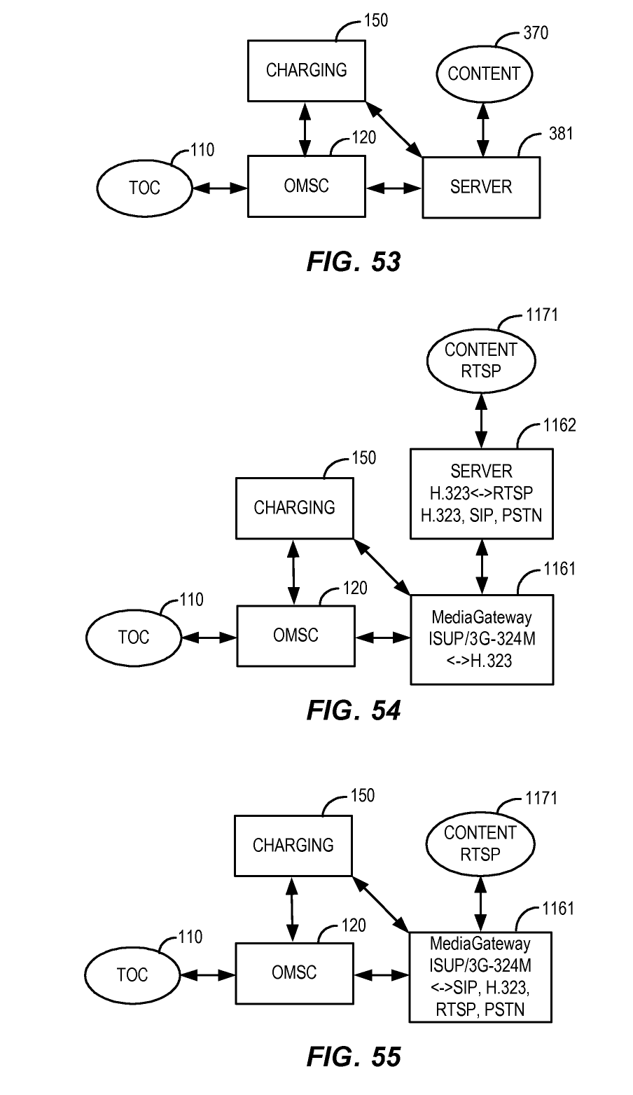

FIG. 53 illustrates a connection architecture for H.324 MS-to-server calls according to an embodiment of the present invention. FIG. 54 illustrates a connection architecture for H.324 MS-to-IP based server calls according to an embodiment of the present invention. FIG. 55 illustrates a connection architecture for H.324 MS-to-gateway with an RTSP interface calls according to an embodiment of the present invention. FIGS. 53-55 show connection architectures that could be used to deliver announcements from a service node, or for interactive sessions, such as streaming. The figures are also applicable to the flows for delayed charging for announcements shown, for example, in FIGS. 42-45.

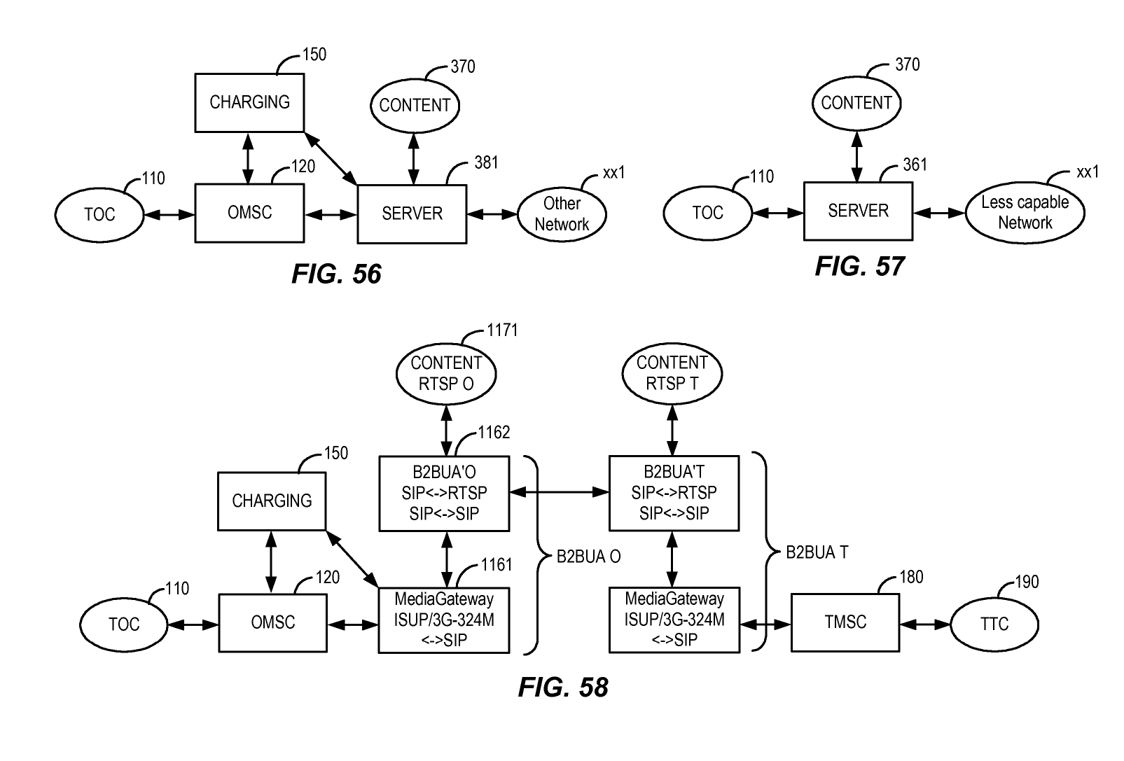

FIG. 56 illustrates a connection architecture for H.324 MS-to-a different network calls according to an embodiment of the present invention. FIG. 57 illustrates a connection architecture for H.324 MS-to-a different less able network calls according to an embodiment of the present invention. FIG. 56 and FIG. 57 show networks able to deliver announcements and/or video ringback tone or themed media when a device is connecting to a different network with different and possibly reduced abilities. For example, in the case of a video call connecting to a voice only device via a gateway, in which the gateway provides an augmented, possibly stimulated media. Such operation may be performed in association, for example, with FIG. 52.

Different networks with different capabilities, or devices with different capabilities, might also introduce the possibility of providing stimulated/augmented media to both ends even though some kind of end-to-end connection may be possible. For example, if the video capabilities of the devices were far apart, then it might not be best to send between the two. For further example, if a mobile phone with QCIF video was talking to a user using a large HDTV, then the size of the QCIF image might be detrimental. In this case, themed sessions, avatars, picture in picture, or the like might be used to ensure a good experience for each user. A video production from the video might also be used in order to cope with bandwidth limitations in the networks (e.g., joining a video call over voice connection in the network only), or alternatively if no transcoding function is available, then the generation could be used. The system could be optimized to employ this interconnection mode after the transcoding function is determined to be missing.

FIG. 58 illustrates a connection architecture for H.324 MS-to-H.324 MS calls in differing networks connected via a SIP interconnect according to an embodiment of the present invention. This layout shows that it is possible to interconnect services in different networks, possibly of the same type, by installing a B2BUA in each network that can talk together. This can be used for inexpensive call interconnect, allowing for cheap calling options, such as a calling card service, and also for the voice only interconnect case.

The previous description of the preferred embodiment is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein. For example, the functionality above may be combined or further separated, depending upon the embodiment. Certain features may also be added or removed. Additionally, the particular order of the features recited is not specifically required in certain embodiments, although may be important in others. The sequence of processes can be carried out in computer code and/or hardware depending upon the embodiment. Of course, one of ordinary skill in the art would recognize many other variations, modifications, and alternatives.

Additionally, it is also understood that the examples and embodiments described herein are for illustrative purposes only and that various modifications or changes in light thereof will be suggested to persons skilled in the art and are to be included within the spirit and purview of this application and scope of the appended claims.

1. A method of providing a video ringback service, the method comprising:
receiving, at a VRBT system, a setup message from a terminal originating a call;
providing a first message from the VRBT system to a service node, wherein the first message is a message interpreted at the service node as an indication to establish a bidirectional bearer;
establishing a communication session between the terminal originating the call and the VRBT system through the bidirectional bearer;
thereafter, providing a video ringback stream from the VRBT system to the terminal originating the call;
receiving a first message from a terminal terminating the call indicating that the terminal terminating the call has answered;
providing a second message from the VRBT system to the service node, wherein the second message is interpreted at the service node as an indication to begin charging for a session; and
providing a communication path between the terminal originating the call and the terminal terminating the call.

2. The method of claim 1 wherein the first message comprises a modified ISUP message not normally associated with connecting a bidirectional bearer.

3. The method of claim 1 wherein the first message comprises at least one of an ACM or a CPG.

4. The method of claim 3 wherein the first message contains an in-band information bit that is set.

5.-7. (canceled)

8. The method of claim 1 wherein the first message is provided to the service node in response to receiving an SIP message.

9. The method of claim 8 wherein the SIP message includes an indication.

10. (canceled)

11. The method of claim 8 wherein the indication is a SIP header comprising P-Delayed-Charging.

12. The method of claim 11 wherein the P-Delayed-Charging is included in a 200 OK message, a 183 SESSION PROGRESS message, or a 180 RINGING message.

13. (canceled)

14. The method of claim 1 wherein the second message comprises an ANM.

15.-28. (canceled)

29. A method for processing a video call from a 3G-324M-like device at a mobile switching center and allowing for a 3G-324M-like video session establishment prior to receiving an ISUP ANM message, the method comprising:
receiving an ISUP IAM at the mobile switching center;
receiving an ISUP ACM or an ISUP CPG at the mobile switching center;
interpreting the ISUP ACM or the ISUP CPG as an indication to connect a bidirectional bearer;
providing the bidirectional bearer between the 3G-324M-like device and a second 3G-324M-like device;
providing a CONNECT message to the 3G-324M-like device; and
thereafter, receiving the ISUP ANM at the mobile switching center.

30. The method of claim 29 wherein the ISUP ANM or the ISUP CPG contain an in-band information field that is set.

31. (canceled)

32. The method of claim 29 wherein interpreting comprises determining that a field is set in the ISUP ACM or the ISUP CPG.

33. The method of claim 32 wherein the field is the in-band information field of the optional backwards call indicators.

34. The method of claim 29 wherein the 3G-324M-like device comprises a handset and the second 3G-324M-like device comprises a media gateway.

35. (canceled)

36. The method of claim 35 wherein the media gateway is connected to a SIP application server.

37.-54. (canceled)
